(19) United States
(12) Patent Application Publication
(10) Pub. No.: US 2025/0201800 A1
(43) Pub. Date: Jun. 19, 2025

(54) METHOD FOR MANUFACTURING SECONDARY BATTERY

(71) Applicant: Semiconductor Energy Laboratory Co., Ltd., Atsugi-shi (JP)

(72) Inventors: Kazutaka KURIKI, Ebina (JP); Teruaki OCHIAI, Atsugi (JP); Shunpei YAMAZAKI, Setagaya (JP)

(21) Appl. No.: 18/969,526

(22) Filed: Dec. 5, 2024

(30) Foreign Application Priority Data
Dec. 15, 2023 (JP) 2023-211857

(51) Int. Cl. H01M 4/04; H01M 4/02; H01M 4/62; H01M 10/0525

(52) U.S. Cl. CPC H01M 4/043; H01M 4/622; H01M 10/0525; H01M 2004/027

(57) ABSTRACT

To provide a method for manufacturing a secondary battery in which an internal short circuit due to a dendrite is inhibited. In a method for manufacturing a secondary battery, a separator is coated with slurry including carbon, a solvent, and a binder, a carbon layer including the binder is formed by drying the slurry to remove the solvent; and pressing is performed on the carbon layer and a negative electrode that face each other. Heating is preferably performed in the pressing.

### BACKGROUND OF THE INVENTION

### 1. Field of the Invention

The present invention relates to a method for manufacturing a storage battery. Note that the present invention is not limited to the above field and relates to a semiconductor device, a display device, a light-emitting device, a power storage device, a lighting device, an electronic device, a vehicle, and manufacturing methods thereof in some cases. For example, a secondary battery formed in accordance with the present invention can be used as a power supply necessary for a semiconductor device, a display device, a light-emitting device, a lighting device, an electronic device, and a vehicle. In addition, examples of the electronic device include an information terminal device incorporating a secondary battery. Furthermore, examples of the power storage device include a stationary power storage device.

### 2. Description of the Related Art

In recent years, demand for lithium-ion secondary batteries with high output and high capacity has rapidly grown with the development of the semiconductor industry. The lithium-ion secondary batteries are essential as rechargeable energy supply sources for today's information society.

A lithium-ion secondary battery has a problem in that a lithium dendrite is deposited on a negative electrode due to repeated charging and discharging. The lithium dendrite is a dendritic crystal of lithium metal that grows in a charging and discharging process and is deposited, for example, by current concentrated on an uneven portion of a surface of a negative electrode. When a lithium dendrite reaches a positive electrode, the lithium-ion secondary battery may have an internal short circuit, which decreases the reliability of the lithium-ion secondary battery.

Graphite is often used as a negative electrode active material, and the use of lithium metal instead of graphite is expected to increase the capacity of a lithium-ion secondary battery. When charging and discharging are performed at low temperatures, a lithium dendrite is likely to be deposited on graphite. Even when charging and discharging are performed at room temperature, lithium dendrite is deposited on lithium metal.

To inhibit the lithium dendrite, a lithium-ion secondary battery using an electrolyte solution containing a fluorine-containing inorganic salt has been proposed (see Patent Document 1). Separators for lithium-ion secondary batteries have been actively developed. For example, Patent Document 2 proposes a separator including a porous substrate and an adhesive porous layer that is provided on one side or both sides of the porous substrate and includes a polyvinylidene fluoride-based resin.

### Reference

### Patent Document

[Patent Document 1] Domestic re-publication of PCT international application WO2015/145288
[Patent Document 2] Japanese Published Patent Application No. 2017-135111

### SUMMARY OF THE INVENTION

However, in the structure of Patent Document 1, an inorganic salt containing fluorine needs to be used in an electrolyte solution, which narrows the range of choices of the electrolyte solution. For example, it is difficult to select an electrolyte solution suitable for operation in a low-temperature environment. In view of the above, it is an object of one embodiment of the present invention to provide a secondary battery having a novel structure that reduces the influence of a dendrite and a method for manufacturing the secondary battery.

Note that the description of these objects does not preclude the presence of other objects. In one embodiment of the present invention, there is no need to achieve all the objects. Other objects can be derived from the descriptions of the specification, the drawings, the claims, and the like.

In view of the above object, the present inventors have found a novel structure and a manufacturing method thereof to control the growth direction of a dendrite deposited on a negative electrode. The novel structure includes a carbon layer on one surface of a separator, whereby an internal short circuit in the secondary battery can be inhibited and the reliability of the secondary battery is improved. Note that in order to control the growth direction of the dendrite deposited on the negative electrode, one surface of the separator preferably faces the negative electrode.

One embodiment of the present invention is a method for manufacturing a secondary battery, in which a separator is coated with slurry including carbon and a solvent; a carbon layer is formed by drying the slurry to remove the solvent; and pressing is performed on the carbon layer and a negative electrode that face each other.

Another embodiment of the present invention is a method for manufacturing a secondary battery, in which a separator is coated with slurry including carbon, a solvent, and a binder; a carbon layer including the binder is formed by drying the slurry to remove the solvent; and pressing is performed on the carbon layer and a negative electrode that face each other.

Another embodiment of the present invention is a method for manufacturing a secondary battery, in which a separator is coated with slurry including carbon, a solvent, and polyglutamic acid; a carbon layer including the polyglutamic acid is formed by drying the slurry to remove the solvent; and pressing is performed on the carbon layer and a negative electrode that face each other, and the solvent contains water.

In another embodiment of the present invention, heating is preferably performed in the pressing.

In another embodiment of the present invention, linear pressure application is preferably performed in the pressing.

Another embodiment of the present invention is a method for manufacturing a secondary battery, in which a separator is coated with slurry including carbon and a solvent; a carbon layer is formed by drying the slurry to remove the solvent and; first pressing is performed on the carbon layer and a negative electrode that face each other; and second pressing is performed on the separator and a positive electrode that face each other.

Another embodiment of the present invention is a method for manufacturing a secondary battery, in which a separator is coated with slurry including carbon, a solvent, and a binder; a carbon layer including the binder is formed by drying the slurry to remove the solvent; first pressing is performed on the carbon layer and a negative electrode that face each other; and second pressing is performed on the separator and a positive electrode that face each other.

Another embodiment of the present invention is a method for manufacturing a secondary battery, in which a separator is coated with slurry including carbon, a solvent, and polyglutamic acid; a carbon layer including the polyglutamic acid is formed by drying the slurry to remove the solvent; first pressing is performed on the carbon layer and a negative electrode that face each other; and second pressing is performed on the separator and a positive electrode that face each other, and the solvent contains water.

In another embodiment of the present invention, heating is preferably performed in the first pressing or the second pressing.

In another embodiment of the present invention, preferably, linear pressure application is performed in the first pressing and area pressure application is performed in the second pressing.

In another embodiment of the present invention, the second pressing is preferably performed after the positive electrode is cut.

According to one embodiment of the present invention, a method for manufacturing a highly reliable secondary battery in which an internal short circuit is inhibited can be provided. According to one embodiment of the present invention, the range of choices of materials of the secondary battery can be widened.

### BRIEF DESCRIPTION OF THE DRAWINGS

In the accompanying drawings:

FIGS. 1A and 1B are diagrams illustrating a secondary battery of one embodiment of the present invention;

FIGS. 2A and 2B are diagrams illustrating a secondary battery of one embodiment of the present invention;

FIGS. 3A to 3C are diagrams each illustrating a roll press apparatus of one embodiment of the present invention;

FIG. 4 is a diagram illustrating a flow of electrons and a flow of lithium ions in charging a secondary battery;

FIG. 5A is a diagram illustrating a separator stack and a negative electrode of one embodiment of the present invention, and FIGS. 5B and 5C are each an enlarged view of the separator stack illustrating the growth direction of dendrites;

FIGS. 6A to 6C are each an enlarged view of a negative electrode structure of one embodiment of the present invention, illustrating the growth direction of dendrites;

FIGS. 7A to 7C are diagrams illustrating a method for manufacturing a negative electrode structure body of one embodiment of the present invention;

FIGS. 8A and 8B are diagrams each illustrating a coating apparatus for a negative electrode;

FIGS. 9A to 9D are diagrams each illustrating a positive electrode of one embodiment of the present invention;

FIG. 10A is a cross-sectional view of a positive electrode active material particle, and FIGS. 10B to 10E are diagrams illustrating distribution of additive elements;

FIG. 11 is an example of a TEM image showing crystal orientations substantially aligned with each other;

FIG. 12A is an example of a STEM image showing crystal orientations substantially aligned with each other; FIG. 12B is an FFT pattern of a region of a rock-salt crystal RS; and FIG. 12C is an FFT pattern of a region of a layered rock-salt crystal LRS;

FIGS. 13A to 13C are diagrams illustrating a secondary battery of one embodiment of the present invention;

FIGS. 14A to 14D are diagrams illustrating a secondary battery and a power storage system of embodiments of the present invention;

FIGS. 15A to 15C are diagrams illustrating a secondary battery of one embodiment of the present invention;

FIGS. 16A to 16C are diagrams illustrating a secondary battery of one embodiment of the present invention;

FIGS. 17A to 17C are diagrams illustrating an electric vehicle of one embodiment of the present invention;

FIGS. 18A to 18D are diagrams illustrating transport vehicles of embodiments of the present invention;

FIGS. 19A to 19C are diagrams illustrating a motorcycle and the like of embodiments of the present invention;

FIGS. 20A to 20D are diagrams illustrating electronic devices and the like of embodiments of the present invention; and

FIGS. 21A to 21D are diagrams each illustrating an example of space equipment.

### DETAILED DESCRIPTION OF THE INVENTION

Embodiments of the present invention will be described in detail with reference to the drawings as appropriate. However, the present invention is not limited to the description below, and it is easily understood by those skilled in the art that modes and details can be modified in various ways without departing from the spirit and scope of the present invention. Therefore, in the embodiments of the present invention described below, reference numerals denoting the same portions are used in common in different drawings.

In this specification and the like, slurry for a carbon layer (hereinafter referred to as carbon layer slurry) is a material solution containing a material needed to form a carbon layer over a separator and refers to a material solution containing at least carbon and a solvent. The carbon layer slurry is preferably a material solution containing a binder in addition to carbon and a solvent. The carbon layer slurry is preferably a material solution containing a dispersant in addition to carbon and a solvent. The carbon layer slurry is preferably a material solution containing a dispersant in addition to carbon, a solvent, and a binder. Note that in this specification and the like, there are no limitations on the viscosity of the material solution.

In this specification and the like, slurry for an electrode (also referred to as electrode slurry) is a material solution that contains a material necessary for formation of an active material layer over the current collector and refers to a material solution containing an active material, a binder, and a solvent, preferably also containing a conductive material mixed therein. Slurry for forming a positive electrode active material layer is referred to as positive electrode slurry, and slurry for forming a negative electrode active material layer is referred to as negative electrode slurry.

In this specification and the like, a loading level means an active material weight per unit area of a surface of a current collector. The loading level of a negative electrode active material can be adjusted in accordance with the capacity of a positive electrode. The above loading level is regarded as a loading level per surface of a current collector in the case where slurry containing an active material is applied onto both surfaces of the current collector.

In this specification and the like, a full cell means a battery cell assembled using different electrodes, as in a unit cell of a positive electrode/a negative electrode. In this specification and the like, a half cell means a battery cell assembled using a lithium metal for a negative electrode (a counter electrode).

In this specification and the like, a median diameter (D50) is one of powder characteristics and a particle diameter when accumulation of particles accounts for 50% of a cumulative curve in a measurement result of the particle size distribution. Note that there is a method for measuring a median diameter (D50) by image analysis with a SEM, a TEM, or the like. For example, the median diameter (D50) can be obtained by measuring 20 or more particles to make a particle size distribution curve, and setting a particle diameter when the accumulation of particles accounts for 50% as the median diameter (D50).

In this specification and the like, a lithium-ion secondary battery is referred to as a lithium ion battery and refers to a battery in which lithium ions are used as carrier ions; however, carrier ions in the present invention are not limited to lithium ions. For example, as the carrier ion, alkali metal ions or alkaline earth metal ions can be used, and specifically, sodium ions or the like can be used. In that case, the present invention can be understood by replacing lithium ions with sodium ions or the like. In the description of the case where there is no limitation on carrier ions, a simple term “secondary battery” is sometimes used.

In this specification and the like, a “carbonate” refers to a compound containing at least one carbonic ester in its molecular structure and includes a cyclic carbonate and a linear carbonate in its category unless otherwise specified. The term “linear” carbonate includes both “straight-chain” and “branched-chain” carbonate.

In this specification and the like, a low-temperature environment refers to an environment at a temperature lower than or equal to 0° C., and a temperature lower than or equal to 0° C. is sometimes referred to as a temperature below the freezing point.

In this specification and the like, an internal short circuit of a secondary battery includes a contact between a positive electrode and a negative electrode inside a secondary battery or electrical conduction between a positive electrode and a negative electrode inside a secondary battery. An internal short circuit of a secondary battery is liable to cause not only a malfunction in charging operation and/or discharging operation of the secondary battery but also heat generation and ignition. In order to obtain a safe secondary battery, an internal short circuit is preferably inhibited even at a high charge voltage. With the positive electrode active material of one embodiment of the present invention, an internal short circuit can be inhibited even at a high charge voltage.

In this specification and the like, ignition in a nail penetration test refers to a state where fire is observed outside an exterior body within one minute of nail penetration or a state where thermal runaway of a secondary battery has occurred within one minute of nail penetration. For example, a state where a pyrolysate(s) of a positive electrode and/or a negative electrode is observed at a position more than or equal to 2 cm away from a penetration point after a nail penetration test is finished is referred to as a state where thermal runaway has occurred. The pyrolysate(s) of the positive electrode and/or the negative electrode contains, for example, aluminum oxide formed by oxidation of aluminum of a positive electrode current collector or copper oxide formed by oxidation of copper of a negative electrode current collector.

In this specification and the like, unless otherwise specified, a charge voltage is shown with reference to the potential of a lithium metal. In this specification and the like, high charge voltage is a charge voltage higher than or equal to 4.6 V, preferably higher than or equal to 4.65 V, further preferably higher than or equal to 4.7 V, still further preferably higher than or equal to 4.75 V, most preferably higher than or equal to 4.8 V with respect to a lithium potential, for example. Charging at the above voltage is referred to as high-voltage charging.

In this specification and the like, the expression “including A and/or B” means “including A,” “including B,” and “including A and B.”

In this specification and the like, a space group is represented using the short symbol of the international notation (or the Hermann-Mauguin notation). In addition, the Miller indices are used for the expression of crystal planes and crystal orientations. In the crystallography, a bar is placed over a number in the expression of space groups, crystal planes, and crystal orientations; in this specification and the like, because of format limitations, crystal planes, crystal orientations, and space groups are sometimes expressed by placing a minus sign (−) in front of a number instead of placing a bar over the number. Furthermore, an individual direction that shows an orientation in crystal is denoted by “[ ]”, a set direction that shows all of the equivalent orientations is denoted by “< >”, an individual plane that shows a crystal plane is denoted by “( )”, and a set plane having equivalent symmetry is denoted by “{ }”.

### Embodiment 1

The secondary battery and the like of one embodiment of the present invention are described.

### <Secondary Battery>

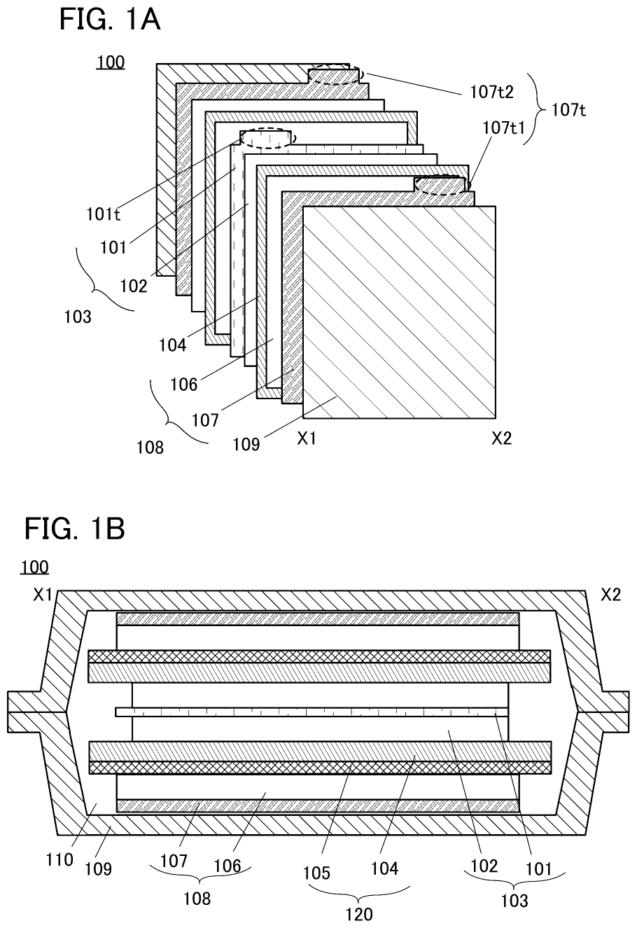

First, a secondary battery that is one embodiment of the present invention is described with reference to FIGS. 1A and 1B. FIG. 1A illustrates an example of a conceptual diagram of a secondary battery 100, and components of the secondary battery 100 are illustrated to be separated from each other for easy viewing in FIG. 1A. In this specification and the like, a component refers to a constituent component of a secondary battery and refers to a positive electrode, a negative electrode, a separator, an electrolyte solution, an exterior body, or the like. FIG. 1B illustrates an example of a cross-sectional structure of the secondary battery 100. FIG. 1B illustrates an example of a cross-sectional structure along the X1-X2 direction of the secondary battery 100 illustrated in FIG. 1A and a state where the components are in contact with each other.

### <Positive Electrode>

The secondary battery 100 includes a plurality of positive electrodes 103. In the secondary battery 100, the number of positive electrodes 103 is not limited and may be one. The positive electrode 103 may form a wound body. The positive electrode 103 includes a positive electrode current collector 101, and the positive electrode current collector 101 includes a protruding portion 101t. The protruding portions 101t of the positive electrode current collectors overlap with each other to form a group. The group of the protruding portions 101t is referred to as a positive electrode tab. The protruding portion 101t in the positive electrode is not illustrated as a group, but the group of the protruding portions 101t, that is, a positive electrode tab, can be understood with reference to the later description of a negative electrode tab.

The positive electrode 103 further includes a positive electrode active material layer 102. The positive electrode active material layer 102 is a layer including positive electrode active material particles, and can be obtained by application of positive electrode slurry to the positive electrode current collector 101. The positive electrode active material layer 102 includes a region in contact with the positive electrode current collector 101. A manufacturing process of the positive electrode 103 includes pressing by a roller press machine; in the positive electrode 103 that has been pressed by a roller press machine, a depressed portion formed by a positive electrode active material particle pressed into the positive electrode current collector 101 is formed in part of the positive electrode current collector 101 in some cases. In other words, in a region where the positive electrode active material layer 102 is in contact with the positive electrode current collector 101, the positive electrode active material particle is in contact with the positive electrode current collector 101. Any material having a current collecting function can be used as the positive electrode current collector 101 without particular limitations. In a region where positive electrode active material particles are in contact with the positive electrode current collector 101, a conductive material may be placed between the positive electrode active material particles and the positive electrode current collector 101. Examples of the conductive material include a coating material of a positive electrode active material particle, a coating material of a positive electrode current collector, and a conductive material included in the positive electrode 103. The conductive material is described later. Note that the coating material of the positive electrode active material particle refers to a material that has a lower resistance than the positive electrode active material particle, typically a carbon material, a metal material, or the like, and is obtained by coating the whole or part of the positive electrode active material particle. The state in which the conductive material is placed between positive electrode active material particles and the positive electrode current collector 101 described above is referred to as a state in which the positive electrode active material layer 102 is electrically in contact with the positive electrode current collector 101 in some cases.

The positive electrode active material layer 102 may include a binder in addition to the positive electrode active material particles. The binder is preferably included, in which case the positions of the positive electrode active material particles in the positive electrode active material layer 102 can be fixed by the binder. The positive electrode active material layer 102 may contain a conductive material in addition to the positive electrode active material particles. The conductive material is preferably used, in which case the resistance of the positive electrode active material layer 102 can be reduced. The decrease in resistance reduces a voltage drop in the positive electrode active material layer 102, so that a potential equal to that of the positive electrode current collector 101 can be obtained. The positive electrode active material layer 102 may include a binder and a conductive material in addition to the positive electrode active material particles. Needless to say, it is acceptable that the positive electrode active material layer 102 does not include a binder or a conductive material. The binder will be described later.

The positive electrode active material layer 102 is preferably formed on both sides of the positive electrode current collector 101. Such a structure is referred to as a double-side coating structure. The positive electrode active material layer 102 may be formed only on one side of the positive electrode current collector 101. Such a structure is referred to as a single-side coating structure.

### <Negative Electrode>

The secondary battery 100 includes a plurality of negative electrodes 108. In the secondary battery 100, the number of negative electrodes is not limited and may be one. The negative electrode 108 may form a wound body. The negative electrode 108 includes a negative electrode current collector 107, and the negative electrode current collector 107 includes protruding portions 107t1 and 107t2. The protruding portions 10711 and 10712 of the negative electrode current collectors overlap with each other to form a group. The group of the protruding portions 107t is referred to as a negative electrode tab. Note that in the secondary battery 100, the area of the negative electrode is preferably larger than the area of the positive electrode.

The negative electrode 108 further includes a negative electrode active material layer 106. The negative electrode active material layer 106 is a layer including negative electrode active material particles, and can be obtained by application of negative electrode slurry to the negative electrode current collector 107. The negative electrode active material layer 106 includes a region in contact with the negative electrode current collector 107. A manufacturing process of the negative electrode 108 includes pressing by a roller press machine; in the negative electrode 108 that has been pressed by a roller press machine, a depressed portion formed by a negative electrode active material particle pressed into the negative electrode current collector 107 is formed in part of the negative electrode current collector 107 in some cases. In other words, in a region where the negative electrode active material layer 106 is in contact with the negative electrode current collector 107, the negative electrode active material particle is in contact with the negative electrode current collector 107. Any material having a current collecting function can be used as the negative electrode current collector 107 without particular limitations. In a region where a negative electrode active material particle in contact with the negative electrode current collector 107, a conductive material may be placed between the negative electrode active material particle and the negative electrode current collector 107. Examples of the conductive material include a coating material of a negative electrode active material particle, a coating material of a negative electrode current collector, and a conductive material included in the negative electrode 108. Note that the coating material of the negative electrode active material particle refers to a material that has a lower resistance than the negative electrode active material particle, typically a carbon material, a metal material, or the like, and is obtained by coating all or part of the negative electrode active material particle. The state in which the conductive material is placed between a negative electrode active material particle and the negative electrode current collector 107 described above is referred to as a state in which the negative electrode active material layer 106 is electrically in contact with the negative electrode current collector 107 in some cases.

The negative electrode active material layer 106 may include a binder in addition to the negative electrode active material particles. The binder is preferably included, in which case the positions of the negative electrode active material particles in the negative electrode active material layer 106 can be fixed by the binder. The negative electrode active material layer 106 may contain a conductive material in addition to the negative electrode active material particles. The conductive material is preferably used, in which case the resistance of the negative electrode active material layer 106 can be reduced. The decrease in resistance reduces the voltage drop in the negative electrode active material layer 106, so that a potential equal to that of the negative electrode current collector 107 can be obtained. The negative electrode active material layer 106 may include a binder and a conductive material in addition to the negative electrode active material particles. Needless to say, it is acceptable that the negative electrode active material layer 106 does not include a binder or a conductive material.

A double-side coating structure in which the negative electrode active material layer 106 is formed on both sides of the negative electrode current collector 107 can be employed. Note that for the negative electrode 108 placed closest to the exterior body 109 (the negative electrode 108 placed in the outermost layer), a single-side coating structure in which the negative electrode active material layer 106 is formed on only one side of the negative electrode current collector 107 is preferably used. In the negative electrode 108 placed in the outermost layer, carrier ions are not inserted or extracted or are unlikely to be inserted or extracted from the negative electrode active material layer that does not face the positive electrode 103. Thus, this negative electrode active material layer is not necessarily formed. In the case where all the negative electrodes 108 have a double-side coating structure, the productivity is high; thus, the negative electrode with a double-side coating structure may be placed in the outermost layer.

In the case where the secondary battery 100 is used while being bent, the negative electrode 108 with single-side coating is preferably prepared. A structure in which a plurality of negative electrodes with single-side coating are stacked such that negative electrode current collectors 107 are in contact with each other is referred to as a back-to-back structure. With the back-to-back structure, the secondary battery 100 is easily bent because the negative electrode current collectors 107 with low contact resistance are in contact with each other. The secondary battery 100 used while being bent includes the secondary battery 100 incorporated in a flexible electronic device and bent along with the electronic device. The secondary battery 100 used while being bent includes the secondary battery 100 that is incorporated in a curved electronic device and is also curved.

### <Separator>

The secondary battery 100 includes a separator 104 between the positive electrode 103 and the negative electrode 108. Note that in the secondary battery 100, the number of separators is not limited and may be one. Although the separator may be in an independent state as illustrated, a continuous separator can be bent or folded to be used. The separator 104 may form a wound body.

The secondary battery 100 preferably includes the carbon layer 105 on a surface or one side of the separator 104, or a surface thereof facing the negative electrode. The separator 104 and the carbon layer 105 are collectively referred to as a separator stack. With use of the carbon layer 105, an internal short circuit in the secondary battery 100 can be inhibited, and the reliability of the secondary battery 100 can be improved accordingly.

The separator 104 has a function of separating at least the positive electrode 103 and the negative electrode 108 from each other and preferably includes an insulating region in order to electrically isolate at least the positive electrode 103 and the negative electrode 108 from each other. As the separator 104, for example, a fiber containing cellulose such as paper; nonwoven fabric; a glass fiber; ceramics; a synthetic fiber using nylon (polyamide), vinylon (polyvinyl alcohol-based fiber), polypropylene (referred to as PP), polyimide (referred to as PI), polyester, acrylic, polyolefin, or polyurethane; or the like can be used. These materials have insulating properties.

The porosity of the separator 104 can be higher than or equal to 35% and lower than or equal to 90%, preferably higher than or equal to 60% and lower than or equal to 85%. A separator using polypropylene can have a porosity higher than or equal to 35% and lower than or equal to 55%. A separator using polyimide can have a porosity higher than or equal to 75% and lower than or equal to 85%. In this specification and the like, the porosity of the separator 104 can be calculated from a cross-sectional image of the separator 104. The area of the cross-sectional image can have any given value, and is preferably greater than or equal to 10 μm² and less than or equal to 200 μm².

The thickness of the separator 104 is preferably greater than or equal to 10 μm and less than or equal to 80 μm, further preferably greater than or equal to 20 μm and less than or equal to 60 μm. In this specification and the like, the thickness of the separator 104 can be measured on a cross-sectional image of the separator 104. The separator 104 using polyimide is preferable because it can have a high porosity and can have a typical thickness greater than or equal to 50 μm and less than or equal to 80 μm.

The separator 104 may have a multilayer structure. The multilayer structure can be obtained by coating the above insulating material with a ceramics material, a fluorine-containing material, a polyamide-containing material, a mixture thereof, or the like. The ceramics material can be referred to as an inorganic material; for example, one or more selected from aluminum oxide particles, silicon oxide particles, and magnesium oxide particles can be used as the ceramics material, and the one or more selected materials are preferably present on the surface of the separator 104. The separator 104 coated with the ceramics material is preferably in a state in which a layer containing one or more of aluminum oxide particles, silicon oxide particles, and magnesium oxide particles is observed on the surface of the separator 104. As the fluorine-containing material, for example, one or more selected from PVDF and polytetrafluoroethylene can be used, and the one or more selected materials are preferably present on the surface of the separator 104. In addition, the separator 104 coated with the fluorine-containing material is preferably in a state in which a layer containing one or more selected from PVDF and polytetrafluoroethylene is observed on the surface of the separator 104. As the polyamide-containing material, for example, one or more selected from nylon and aramid (meta-aramid and para-aramid) can be used, and the one or more selected materials are preferably present on the surface of the separator 104. The separator 104 coated with the polyamide-containing material is preferably in a state in which a layer containing one or more selected from nylon and aramid (meta-aramid and para-aramid) is observed on the surface of the separator 104.

With the use of the separator 104 having a multilayer structure, the capacity per volume of the secondary battery 100 can be increased because the safety of the secondary battery 100 can be maintained even when the total thickness of the separator is small.

The separator 104 can be processed into a pouch shape to wrap one of the positive electrode 103 and the negative electrode 108.

### <Carbon Layer 105>

Any material containing carbon can be used as the carbon layer 105 without particular limitations. Examples of the carbon material usable for the carbon layer 105 include carbon fiber (CF), and typically a carbon nanotube (referred to as CNT) is preferable. CNT is a substance composed of carbon, or specifically, a sheet in which hexagons of carbon atoms are arranged in a planar shape is rounded to be cylindrical. The diameter of the rounded structure can be greater than or equal to 10 nm and less than or equal to 25 nm. The CNT can be formed by an arc discharge method, a laser evaporation method (a laser ablation method), or a chemical vapor deposition method (a CVD method). CNT is chemically and thermally stable. Furthermore, the CNT has high conductivity like a metal. Thus, CNT is suitable for the carbon layer 105, and a carbon layer including the CNT is referred to as a CNT layer.

One example of CNT is a single-walled CNT, which has a single-layer cylindrical structure. The single-walled CNT is likely to be long and flexible. Another example of CNT is a multi-walled CNT, which has a structure where a first cylindrical structure having a first diameter is provided inside a second cylindrical structure having a second diameter larger than the first diameter. The multi-walled CNT may have three or more cylindrical structures. The multi-walled CNT is likely to be short and hard. As the carbon layer 105, the single-walled CNT and/or the multi-walled CNT can be used. As the carbon layer, a stack of the single-walled CNTs or a stack of the multi-walled CNTs can be used.

In the CNT layer, directions of major axes (major-axis directions) of CNTs can be aligned. In other words, in the CNT layer, the major axes of CNTs can be aligned in one direction or substantially one direction. A group of CNTs whose major axes are aligned in one direction or substantially one direction is referred to as a bundle of CNTs in some cases. A sheet including the group of CNTs whose major axes are aligned in one direction or substantially one direction is referred to as an unidirectionally aligned CNT layer in some cases. The unidirectionally aligned CNT layer has high tensile strength in the major axis direction and is suitable for the carbon layer 105.

Although the carbon layer 105 is illustrated as a single layer, the carbon layer 105 may be a stack of a plurality of carbon layers (a stacked-layer structure). The stacked-layer structure enables the carbon layer 105 to have an appropriate thickness. In the case where a plurality of CNT layers are stacked, the CNT layers are preferably stacked such that the major axes intersect with each other. The plurality of CNT layers in which the major axes intersect with each other are suitable for the carbon layer 105. In stacking, the CNTs at the interface can be aggregated by spraying an organic solvent.

The carbon layer 105 may include a vapor-grown carbon fiber (VGCF: registered trademark) as a carbon material. VGCF is suitable for the carbon layer 105 because it can have a diameter of greater than or equal to 90 nm and less than or equal to 200 nm, preferably greater than or equal to 90 nm and less than or equal to 110 nm and a fiber length of greater than or equal to 7 μm and less than or equal to 15 μm.

The carbon layer 105 may contain graphene. A carbon layer containing graphene is referred to as a graphene sheet. In this specification and the like, graphene contains carbon, has a plate-like shape, a sheet-like shape, or the like, and has a two-dimensional structure formed of six-membered rings composed of carbon atoms. Graphene may partly have a defect; in this case, a poly-membered ring such as a seven-membered ring, an eight-membered ring, a nine-membered ring, or a ten-membered ring is formed in graphene. Note that the poly-membered ring refers to a ring-shaped carbon skeleton in which a carbon bond in part of a six-membered ring composed of carbon atoms is broken and the broken carbon bond is bonded to another broken carbon bond. A region surrounded with carbon atoms in the poly-membered ring is a gap. In this specification and the like, graphene includes a multilayer graphene. Graphene is suitable for the carbon layer 105 because of its excellent electrical characteristics of high conductivity.

The carbon layer 105 may include a graphene compound as a carbon material. A carbon layer containing a graphene compound is referred to as a graphene compound sheet. In this specification and the like, a graphene compound includes graphene oxide, multilayer graphene oxide, reduced graphene oxide, reduced multilayer graphene oxide, and the like. In other words, a graphene compound may include a functional group, and examples of the functional group include an epoxy group, a carboxy group, and a hydroxy group. A graphene compound is suitable for the carbon layer 105 because of its high flexibility and excellent electrical characteristics of high conductivity.

In this specification and the like, reduced graphene oxide contains carbon and oxygen and has a two-dimensional structure formed of a six-membered ring composed of carbon atoms. The reduced graphene oxide preferably includes a portion where the carbon concentration is higher than 80 atomic % and the oxygen concentration is higher than or equal to 2 atomic % and lower than or equal to 15 atomic %.

### <Carbon Layer Slurry>

The above-described carbon layer 105 can be obtained from carbon layer slurry. Specifically, the separator 104 is coated with the carbon layer slurry, so that the carbon layer 105 can be obtained. In the case where the carbon layer slurry contains a solvent, a drying step is preferably performed. After the carbon layer slurry is dried, pressing with a roller press machine is preferably performed. Note that in the case where the separator 104 forms a wound body, the carbon layer 105 also preferably forms a wound body.

Note that the carbon layer slurry is a material solution containing at least the above-described carbon material and preferably further includes a binder. With the binder, the carbon layer 105 can be bonded to the separator 104. The binder will be described later.

As the solvent of the carbon layer slurry, water or an organic solvent can be used. Examples of water include deionized water. As the organic solvent, one or more selected from a ketone such as acetone, alcohols such as ethanol and isopropanol, ethers, dioxane, acetonitrile, N-methyl-2-pyrrolidone (NMP), and the like can be used.

Furthermore, the carbon layer slurry may further include a dispersant. Typically, in the case where carbon fiber is used as the carbon material, it is preferable to disperse the carbon fiber in an organic solvent using a dispersant. In the case where NMP is used as the organic solvent, polyvinylpyrrolidone (PVP) is preferably used as the dispersant. The PVP can be adsorbed onto the surface of the CNT and can inhibit the CNT from reaggregating after being dispersed.

The step of applying the carbon layer slurry onto the separator 104 is preferable to the step of applying the carbon layer slurry onto the negative electrode 108, because the former step can widen the range of choices of materials of the carbon layer slurry. For example, carbon layer slurry that contains water as a solvent cannot be applied onto the negative electrode 108 formed using a lithium metal; however, in one embodiment of the present invention, the application of the carbon layer slurry onto the separator 104 is preferable because water can be used as a solvent.

There are no limitations on the viscosity of the carbon layer slurry as long as it can be applied to the separator 104. The separator 104 may also have a multilayer structure to be easily coated with the carbon layer slurry.

### <Binder>

A binder is described next. The binder is a material included in the positive electrode 103, the negative electrode 108, or the carbon layer 105. As the binder, a high molecule having a carboxy group is preferably used. It can be said that the carboxy group contains two basic oxygen atoms, one acidic hydrogen atom, and one electrophilic carbon atom. It can also be said that the carboxy group contains OH, which is a hydroxy group, and C═O, which is a carbonyl group, and is a group having a polarity. Note that the carboxy group can be identified by Fourier transform Infrared Spectroscopy (FT-IR) or the like.

Examples of a high molecule having a carboxy group include polyglutamic acid (sometimes referred to as PGA), poly(acrylic acid) (sometimes referred to as PAA), and alginic acid (sometimes referred to as polysaccharide). Alternatively, polyamino acid may be used as the high molecule having a carboxy group; specifically, polyornithine or polysarcosine may be used for the binder. Furthermore, as a high molecule having a carbonyl group, polyaspartic acid may be used for the binder. Alternatively, a binary copolymer (copolymer) may be used as the high molecule including a ketone group; a copolymer of acrylic acid and maleic acid or a copolymer of acrylic acid and sulfonic acid may be used for the binder.

The use of a high molecule having a carboxy group for the binder also gives an effect of reducing the mixed amount of binder included in the positive electrode 103, the negative electrode 108, or the carbon layer 105. Among the above-described high molecules, polyglutamic acid or polyacrylic acid is preferable as the binder used for the positive electrode 103, the negative electrode 108, or the carbon layer 105.

Structural Formula (H2) shown below is a structural formula of polyglutamic acid.

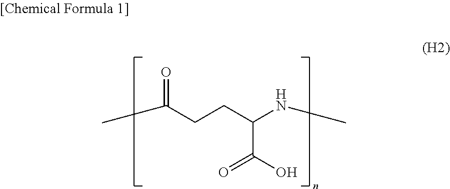

As the polyglutamic acid, either straight-chain γ-polyglutamic acid or cross-linked γ-polyglutamic acid may be used for the binder, and these acids are collectively referred to as a structure including γ-polyglutamic acid as a main component. Note that the cross-linked γ-polyglutamic acid is more suitable for the binder because it has a net-like structure. Furthermore, the molecular weight of the polyglutamic acid is preferably greater than or equal to 1 million, further preferably greater than or equal to 3 million, still further preferably greater than or equal to 10 million and less than or equal to 50 million.

Depending on the formation method, polyglutamic acid can be referred to as γ-polyglutamic acid containing another element (e.g., Ca, Al, Na, Mg, Fe, Si, or S) as a main component. That is, polyglutamic acid may be neutralized with an alkali metal ion, for example, a lithium ion or a sodium ion.

Since such polyglutamic acid has hydrophilicity, water, typically deionized water, can be used as the solvent. That is, in the case where polyglutamic acid is used as the binder, water needs to be selected as the solvent of the positive electrode slurry, negative electrode slurry, or carbon layer slurry.

Structural Formula (H1) shown below is a structural formula of polyacrylic acid.

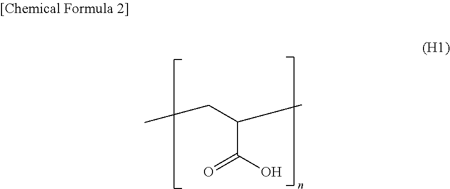

As is apparent from the structural formula (H1), polyacrylic acid includes a carboxy group. A material in which poly(acrylic acid) is cross-linked may be used. A cross-link structure, i.e., a net-like structure, can be formed, which is preferable because the function of the binder can be enhanced.

As examples of other binders, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Fluororubber can also be used as the binder.

Alternatively, as the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

### <Exterior Body>

The secondary battery 100 further includes the exterior body 109. The negative electrode 108, the separator 104, and the positive electrode 103 are held in the exterior body 109. The electrolyte solution 110 is injected into the exterior body 109, and the separator 104 and the like are impregnated with the electrolyte solution 110. As the exterior body 109, a film is preferably used in terms of weight reduction. The secondary battery 100 using a film as the exterior body 109 is referred to as a laminate-type secondary battery. Although not illustrated in the drawing mentioned in this embodiment, a can case may be used as the exterior body 109; in the case where a circular can case is used, the secondary battery is referred to as a coin-type secondary battery.

For an exterior body included in the laminate-type secondary battery, a metal material such as aluminum or a resin material can be used, for example. As the resin material, for example, an organic material such as polyethylene, polypropylene, a polycarbonate, an ionomer, or a polyamide can be used. As the exterior body having a three-layer structure, it is possible to use a three-layer structure in which a highly flexible metal thin film of aluminum, stainless steel, copper, nickel, or the like is provided over a film made of a resin material described above, and an insulating synthetic resin film of a polyamide-based resin, a polyester-based resin, or the like is provided over the metal thin film in a position corresponding to the outer surface of the exterior body.

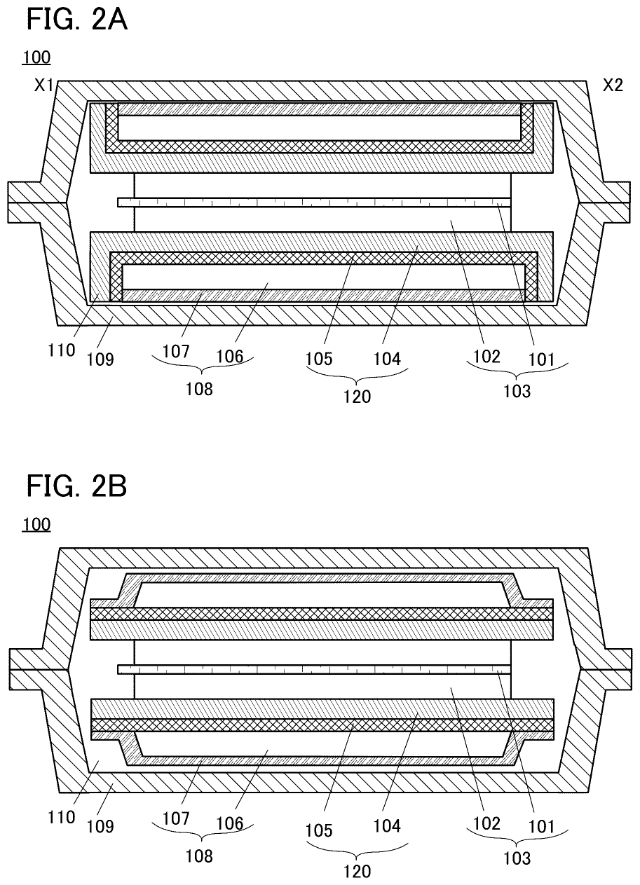

In the cross-sectional structure in FIG. 1B, the positive electrode 103, a separator stack 120, and the negative electrode 108 are in contact with each other. Next, FIGS. 2A and 2B illustrate a state where the positive electrode 103, the separator stack 120, and the negative electrode 108 are in contact with each other. The state in FIGS. 2A and 2B where the positive electrode 103, the separator stack 120, and the negative electrode 108 are in contact with each other can be obtained through pressing and is sometimes referred to as a close-contact state or an adhered state.

### <Pressing>

After the negative electrode 108 and the separator stack 120 face each other, pressing with a roller press machine or the like is preferably performed as needed. The negative electrode 108 and the separator stack 120 can be brought into close contact with each other with the roller press machine. Furthermore, this pressing can reduce unevenness that may be formed on the surface of the negative electrode 108. Since the negative electrode 108 having a flat surface is at a constant distance from the positive electrode 103, the reaction unevenness in the negative electrode 108 can be suppressed. The suppressed reaction unevenness can inhibit generation of a dendrite and/or growth of a dendrite, so that the safety of the secondary battery 100 can be improved. A cross-sectional structure after pressing is performed with the negative electrode 108 and the separator stack 120 facing each other is described with reference to FIGS. 2A and 2B.

In the secondary battery 100 illustrated in FIG. 2A, the negative electrode 108 is in close contact with the separator stack 120. FIG. 2A illustrates an example of a cross-sectional structure of the secondary battery along the X1-X2 direction illustrated in FIG. 1A, and the area of the separator stack 120 is larger than the area of the negative electrode 108; thus, the separator 104 is folded to the side surface of the negative electrode 108. Like the separator 104, the carbon layer 105 is also folded to the side surface of the negative electrode 108. Thus, the carbon layer 105 can include a region in contact with the negative electrode current collector 107. In FIG. 2A, the carbon layer 105 can have the same potential as the negative electrode current collector 107, and the carbon layer 105 can be regarded as including a region that is electrically in contact with the negative electrode current collector 107.

The negative electrode 108 and the separator stack 120 are in close contact with each other also in the secondary battery 100 illustrated in FIG. 2B, but the outer edge of the negative electrode 108 is different from that in FIG. 2A. FIG. 2B illustrates an example of a cross-sectional structure along the X1-X2 direction of the secondary battery illustrated in FIG. 1A, in which the area of the negative electrode current collector 107 is larger than the area of the negative electrode active material layer 106 in the negative electrode 108; thus, the negative electrode current collector 107 is folded to the side surface of the negative electrode active material layer 106. Thus, the carbon layer 105 can include a region in contact with the negative electrode current collector 107. In FIG. 2B, the carbon layer 105 can have the same potential as the negative electrode current collector 107, and the carbon layer 105 can be regarded as including a region that is electrically in contact with the negative electrode current collector 107.

Although the pressing is performed so that the negative electrode 108 and the separator stack 120 can be in close contact with each other in FIGS. 2A and 2B, pressing may be performed so that the positive electrode 103 and the separator stack 120 can be in close contact with each other. In this case, it is possible to understand a structure in which the positive electrode 103 and the separator stack 120 are in close contact with each other, by replacing the negative electrode 108 in FIGS. 2A and 2B with the positive electrode 103. It is preferable that a carbon layer not be provided on the surface of the separator stack 120 on the positive electrode 103 side. Needless to say, a carbon layer may be provided on the surface of the separator stack 120 on the positive electrode 103 side.

### <Roller Press Machine>

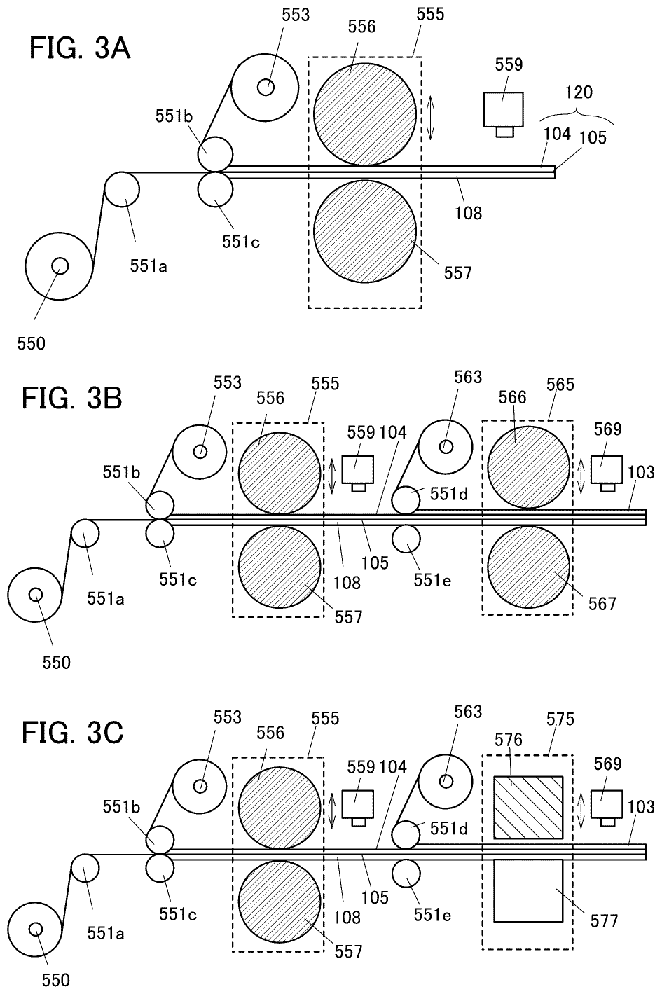

FIG. 3A illustrates an example of a roller press machine that enables pressing. Although not illustrated, the roller press machine preferably includes a dancer roll to control a tension, and an edge position control mechanism (EPC mechanism) to correct a position. A sheet-shaped component is wound into a roll shape around a first unwinder 550. As the sheet-shaped component, the negative electrode 108 is preferably used. The roll-shaped negative electrode 108 is preferably wound such that the negative electrode active material layer 106 faces inward. Furthermore, the roll-shaped negative electrode 108 is preferably wound such that the negative electrode current collector 107 is cut to have a protruding portion. A sheet-shaped component is wound into a roll shape around a second unwinder 553. As the sheet-like component, the separator stack 120 is preferably used. The roll-shaped separator stack 120 is preferably wound such that the carbon layer 105 faces outward.

The negative electrode 108 changes its traveling direction with a roller 551a, and the separator stack 120 changes its traveling direction with a roller 551b. The negative electrode 108 and the carbon layer 105 are pressed to each other by being sandwiched between the roller 551b and a roller 551c that faces the roller 551b. When pressed, the negative electrode 108 and the carbon layer 105 are in contact with each other. The negative electrode 108 and the carbon layer 105 being in contact with each other can be used as parts of the secondary battery 100.

In a preferable example of one embodiment of the present invention, the negative electrode 108 and the separator stack 120 are placed to face each other and then are brought into close contact with each other with a press mechanism 555. The press mechanism 555 includes an upper pressure roll 556 and a lower pressure roll 557 to allow linear pressure application, and the negative electrode 108 and the separator stack 120 are transferred between the upper pressure roll 556 and the lower pressure roll 557. The distance between the upper and lower pressure rolls can be variable, and FIG. 3A illustrates an example of a structure in which the upper pressure roll 556 moves up and down. The distance between the upper and lower pressure rolls is preferably changed depending on the thicknesses of the negative electrode 108, the separator 104, and the carbon layer 105, in which case the negative electrode 108 and the separator stack 120 can be in close contact with each other by an appropriate pressure.

One or both of the upper pressure roll 556 and the lower pressure roll 557 preferably have a heating mechanism. The heating mechanism enables the binder included in the carbon layer 105 to function as an adhesive region. Needless to say, the adhesive strength may be increased by additionally providing an adhesive layer at the interface between the negative electrode 108 and the separator stack 120. After adhering, the negative electrode 108 and the separator stack 120 can be checked with a camera 559. Although not illustrated, a camera may be provided in the press mechanism 555.

After the negative electrode 108 and the separator stack 120 are adhered to each other, the negative electrode 108 and the separator stack 120 are preferably cut to fit the area of the secondary battery 100. Note that the negative electrode and the separator that are held in the secondary battery 100 may form a wound body. Accordingly, the negative electrode 108 and the separator stack 120 are sometimes cut to have a size intended for the wound body.

Although the roller press machine in FIG. 3A is described for attachment of the negative electrode 108 and the separator stack 120 as an example, the roller press machine can also be used for attachment of the positive electrode 103 and the separator 104. After the positive electrode active material layer 102 and the separator 104 face each other, heating may be performed by a heating mechanism of the roller press machine. The binder included in the positive electrode active material layer 102 can function as an adhesive region. Needless to say, the adhesive strength may be increased by additionally providing an adhesive layer at the interface between the positive electrode 103 and the separator stack 120. For example, preferably, the separator 104 has a multilayer structure and an adhesive layer is provided as a layer of the multilayer structure that is positioned in contact with the positive electrode active material layer 102, in which case the bonding strength can be increased.

FIG. 3B illustrates another example of a roller press machine that enables pressing. In addition to the roller press machine illustrated in FIG. 3A, the roller press machine in FIG. 3B further includes a third unwinder 563 next to the camera 559. A sheet-shaped component is wound into a roll shape around the third unwinder 563. The positive electrode 103 is preferably used for the sheet-shaped component. The roll-shaped positive electrode 103 is preferably wound such that the positive electrode active material layer 102 faces outward. Furthermore, the roll-shaped positive electrode 103 is preferably wound such that the positive electrode current collector 101 is cut to have a protruding portion.

The positive electrode 103 changes its traveling direction with a roller 551d, and the positive electrode 103 and the separator 104 are pressed into each other by being sandwiched between the roller 551d and a roller 551e that face the roller 551d. When pressed, the positive electrode 103 and the separator 104 are in contact with each other, and the positive electrode 103 and the separator 104 being in contact with each other can be used as parts of the secondary battery 100.

In another preferable example of one embodiment of the present invention, the positive electrode 103, the negative electrode 108, and the separator stack 120 are placed to face each other as appropriate and then are brought into close contact with each other with a press mechanism 565. The press mechanism 565 includes an upper pressure roll 566 and a lower pressure roll 567, and the positive electrode 103, the negative electrode 108 and the separator stack 120 are transferred between the upper pressure roll 566 and the lower pressure roll 567. The distance between the upper and lower pressure rolls can be variable, and FIG. 3B illustrates an example of a structure in which the upper pressure roll 566 moves up and down. The distance between the upper and lower pressure rolls is preferably changed depending on the thicknesses of the positive electrode 103, the negative electrode 108, the separator 104, and the carbon layer 105, in which case the positive electrode 103, the negative electrode 108, and the separator stack 120 can be attached to each other by an appropriate pressure.

One or both of the upper pressure roll 566 and the lower pressure roll 567 preferably have a heating mechanism. The heating mechanism enables the binder included in each layer to function as an adhesive region. Needless to say, the adhesive strength may be increased by additionally providing an adhesive layer at the interface each between the layers. After adhering, the states of the positive electrode 103, the negative electrode 108, and the separator stack 120 can be checked with a camera 569. Although not illustrated, a camera may be provided in the press mechanism 565.

After the positive electrode 103, the negative electrode 108, and the separator stack 120 are adhered to each other, the positive electrode 103, the negative electrode 108, and the separator stack 120 are preferably cut to fit the area of the secondary battery 100. Note that the positive electrode, the negative electrode, and the separator that are held in the secondary battery 100 may form a wound body. Accordingly, the positive electrode 103, the negative electrode 108, and the separator stack 120 are sometimes cut to have a size intended for the wound body.

FIG. 3C illustrates another example of a roller press machine that enables pressing. Instead of the press mechanism 565 illustrated in FIG. 3B, the roller press machine in FIG. 3C includes a press mechanism 575 that enables area pressure application. In a preferable example of one embodiment of the present invention, the positive electrode 103, the negative electrode 108, and the separator stack 120 are placed to face each other as appropriate and then be in close contact with each other with the press mechanism 575. The press mechanism 575 includes a pressurizing plane 576 and a pressurizing stage 577. This structure is preferably employed, in which case the positive electrode 103, the negative electrode 108, and the separator stack 120 are transferred between the pressurizing plane 576 and the pressurizing stage 577 and can be attached to each other by the pressurizing plane 576. When the press mechanism 575 is used, the positive electrode 103, the negative electrode 108, and the separator stack 120 are preferably transferred to the press mechanism 575 in a state where at least the positive electrode 103 is cut to a size fitting for the area of the secondary battery 100. When the positive electrode 103 that has been cut is pressed by a pressurizing roll, misalignment with the separator stack 120 or the like may be caused; however, the use of the pressurizing plane 576 and the pressurizing stage 577 can inhibit the occurrence of the misalignment, which is preferable.

Such a roller press machine is preferably used, in which case at least the positive electrode 103, the negative electrode 108, and the separator stack 120 can be brought into close contact with each other.

By assembling the positive electrode 103, the negative electrode 108, and the separator stack 120 in a vacuum atmosphere, the positive electrode 103, the negative electrode 108, and the separator stack 120 can be brought into close contact with each other with atmospheric pressure. The vacuum atmosphere includes a reduced pressure atmosphere having a pressure higher than or equal to −0.1 MPa and lower than 0.08 MPa, which is shown by a differential pressure gauge placed in an assembly chamber.

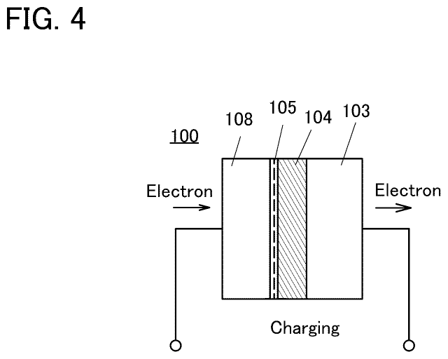

Here, a flow of electrons in charging the secondary battery 100 will be described with reference to FIG. 4. Two terminals illustrated in FIG. 4 are connected to a charger, and the secondary battery 100 is charged. In charging, electrons are released from the positive electrode 103, so that an oxidation reaction occurs. At this time, lithium ions are extracted to the electrolyte solution from the positive electrode 103. In addition, electrons are supplied to the negative electrode 108 in charging, so that a reduction reaction occurs. At this time, lithium ions in the electrolyte solution transfer to the negative electrode 108. In the case where graphite is used as the negative electrode active material, transferred lithium ions is inserted between the graphite layers. The potential of the negative electrode 108 in a state where lithium ions are inserted between the graphite layers is substantially equal to that of the case where a lithium metal is used as the negative electrode active material. Also in the case where silicon or an alloy thereof is used as the negative electrode active material, the potential is substantially equal to that of the case where a lithium metal is used as the negative electrode active material. The lithium metal is precipitated when charging at high rate or at a low temperature is performed in the state with this potential. Note that when the secondary battery 100 is regarded as a closed circuit, current flows in the same direction as the movement of lithium ions. Although not illustrated, in discharging, the negative electrode 108 releases electrons and the lithium metal is dissolved in the electrolyte solution. When charging and discharging are repeated in this manner, the lithium metal precipitation and dissolution are repeated on and from the negative electrode 108. When such a phenomenon is repeated, attachment of decomposition products of the electrolyte solution, omission of an electron conduction path, or the like makes an uneven surface of the negative electrode 108, the lithium metal becomes a dendrite, and the growth of the dendrite proceeds in some cases.

Note that in the secondary battery 100, an anode and a cathode change places in discharging and charging, and an oxidation reaction and a reduction reaction are also switched with each other; hence, an electrode with a high reaction potential is called a positive electrode and an electrode with a low reaction potential is called a negative electrode. For this reason, in this specification and the like, the positive electrode is referred to as a “positive electrode” or a “plus electrode” and the negative electrode is referred to as a “negative electrode” “minus electrode” in all the cases where charge is performed and discharge is performed. The use of the terms “anode” and “cathode”, which are related to an oxidation reaction and a reduction reaction, might cause confusion because the anode and the cathode change places at the time of charging and discharging. Therefore, the terms “anode” and “cathode” are not used in this specification and the like.

Next, structure examples of the separator 104, the carbon layer 105, and the negative electrode 108 of embodiments of the present invention, and the like will be described.

### Structure Example 1

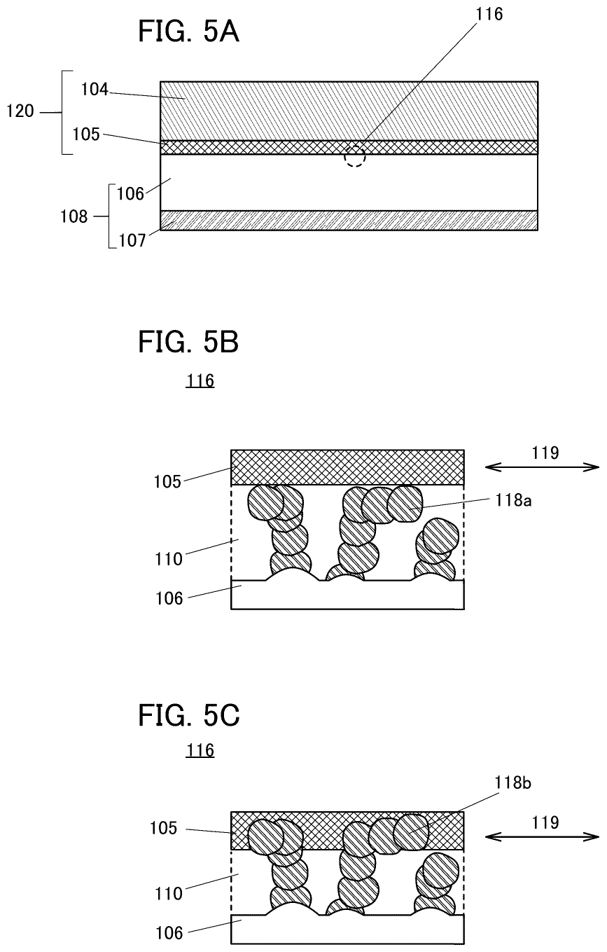

FIG. 5A illustrates the separator 104, the carbon layer 105, and the negative electrode 108. In this specification and the like, the separator 104 and the carbon layer 105 are collectively referred to as the separator stack 120. In the case where the separator 104 has a multilayer structure, the separator 104 having a multilayer structure and the carbon layer 105 are collectively referred to as the separator stack 120. The carbon layer 105 is positioned between the negative electrode 108 and the separator 104, specifically, between the negative electrode active material layer 106 and the separator 104. Furthermore, the carbon layer 105 is provided to overlap with the negative electrode active material layer 106, and the growth direction of the dendrite can be controlled with this structure. Furthermore, as illustrated in FIG. 2B and the like, the carbon layer 105 is preferably provided to overlap with, further preferably to be in contact with, the negative electrode current collector 107 in the peripheral portion of the carbon layer 105. That is, the negative electrode current collector 107 preferably extends to a region beyond the outer edge of the negative electrode active material layer 106 and overlaps with the carbon layer 105. Furthermore, the secondary battery 100 preferably has a structure in which the peripheral portion of the negative electrode current collector 107 that has been subjected to pressing or the like extends along the negative electrode active material layer 106 to a region in contact with the carbon layer 105. This is preferable because a defect of the separator 104 can be inhibited by maintaining the flatness of the separator 104. Needless to say, as illustrated in FIG. 2A, the peripheral portion of the flat separator 104 may be changed in shape so that the peripheral portion can be disposed along the negative electrode active material layer 106. Such a structure is preferable because the negative electrode current collector 107 and the carbon layer 105 can have the same potential in charging and discharging of the secondary battery 100.

FIG. 5B is an enlarged view of a region 116 surrounded by a dashed line in FIG. 5A. As illustrated in FIG. 5B, a region where the carbon layer 105 and the negative electrode active material layer 106 are apart from each other or are separated from each other is observed between the carbon layer 105 and the negative electrode active material layer 106. Furthermore, unevenness is seen on the surface or the top surface of the negative electrode active material layer 106. This unevenness reflects the shape of the negative electrode active material particle. When a repetitive charge and discharge cycle test is performed the secondary battery 100, current might be concentrated on unevenness. Then, lithium is unevenly deposited from the negative electrode active material layer 106, so that the dendrite 118a is likely to be formed. The dendrite 118a is likely to be formed from a projection portion of the negative electrode active material layer 106. Furthermore, the dendrite 118a grows by performing the repetitive charge and discharge on the secondary battery 100.

In one embodiment of the present invention, the carbon layer 105 is provided as illustrated in FIG. 5B; thus, the dendrite 118a reaches the carbon layer 105 and then grows in the lateral direction, i.e., along the carbon layer 105. In the case where a surface of the carbon layer 105 is observed, it can be said that the dendrite 118a has a portion along the surface of the carbon layer 105. An arrow 119 is added as an example of the growth direction of the dendrite 118a. The direction of the arrow 119 can be regarded as a direction intersecting with the normal direction of the secondary battery when the normal direction of the secondary battery is defined as penetrating the positive electrode and the negative electrode. In the case where the normal direction is “vertical”, the direction of the arrow 119 can be regarded as “horizontal”. The direction of the arrow 119 can be regarded as a direction along the major axes of CNTs in the case where the CNT layer is used as the carbon layer 105. The direction of the arrow 119 may be referred to as a direction along the negative electrode. In the case where a plurality of dendrites are present, the growth directions of the dendrites 118a may be different from one another. That is, the growth direction of the dendrite 118a is aligned or substantially aligned with the arrow 119; to be more specific, the dendrite 118a is preferably prevented from reaching the positive electrode.

The reason why the dendrite 118a grows in such a direction is probably because the carbon layer 105 and the negative electrode 108 have the same potential and the dendrite 118a grows while receiving electrons from the carbon layer 105 in the reduction reaction. Since the carbon layer 105 has high conductivity, the carbon layer 105 reacts with the electrolyte solution 110 actively in the reduction reaction. The dendrite 118a can grow along the carbon layer 105 after reaching the carbon layer 105. As described again, the growth directions of the dendrites 118a are different from one another. Such a phenomenon can prevent the dendrite 118a from reaching the positive electrode. Thus, the structure in which the carbon layer 105 is provided as illustrated in FIG. 5B reduces the internal short circuit of the secondary battery 100.

### Application Example 1

As illustrated in FIG. 5C, a dendrite 118b may reach the inside of the carbon layer 105. In other words, the dendrite 118b grows in the direction of the arrow 119 inside the carbon layer 105 in some cases. Such a phenomenon can prevent the dendrite 118b from reaching the positive electrode. Thus, the structure in which the carbon layer 105 is provided as illustrated in FIG. 5C reduces the internal short circuit of the secondary battery 100.

### Application Example 2

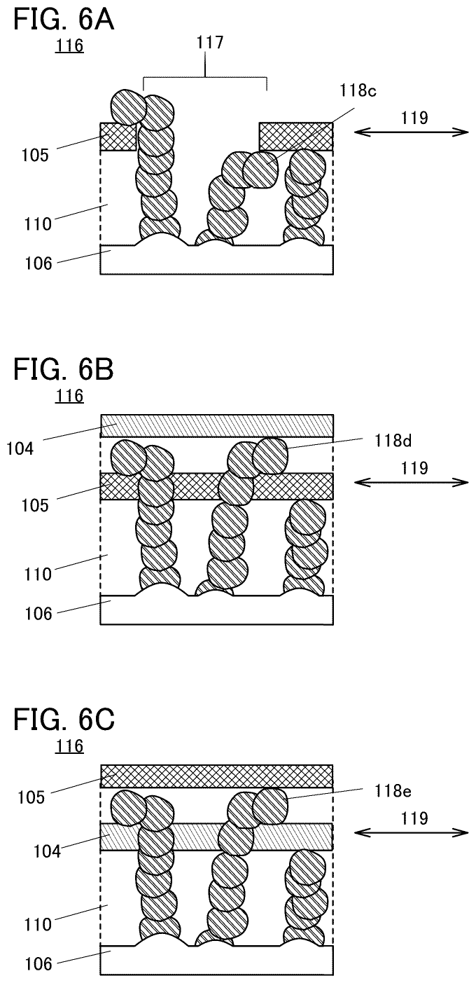

As illustrated in FIG. 6A, the carbon layer 105 may be divided unless a dendrite 118c reaches the positive electrode. When the carbon layer 105 is divided, a divided region is formed in the carbon layer 105. The divided region is observed as a gap 117 in a cross-sectional view of the above carbon layer 105. Lithium ions can enter and leave through the gap 117. The dendrite 118c may grow in the direction of the arrow 119 without passing through the gap 117. Furthermore, the dendrite 118c may grow in the direction of the arrow 119 after passing through the gap 117. Such a phenomenon can prevent the dendrite 118c from reaching the positive electrode. Thus, the structure in which the carbon layer 105 is provided as illustrated in FIG. 6A reduces the internal short circuit of the secondary battery 100.

### Application Example 3

As illustrated in FIG. 6B, a dendrite 118d may penetrate the carbon layer 105 unless the dendrite 118d reaches the positive electrode. In this example, there is no divided region in the carbon layer 105. Furthermore, the dendrite 118d may be between the separator 104 and the carbon layer 105 and may grow in the arrow 119 direction therebetween. Note that the dendrite 118d does not penetrate the separator 104. Such a phenomenon can prevent the dendrite 118d from reaching the positive electrode. Thus, the structure in which the carbon layer 105 is provided as illustrated in FIG. 6B reduces the internal short circuit of the secondary battery 100.

### Application Example 4

As illustrated in FIG. 6C, the carbon layer 105 may be positioned between the separator 104 and the positive electrode. A dendrite 118e may penetrate the separator 104. Furthermore, the dendrite 118e may be between the carbon layer 105 and the separator 104 and may grow in the arrow 119 direction therebetween. Note that the dendrite 118e should not penetrate the carbon layer 105. Such a phenomenon can prevent the dendrite 118e from reaching the positive electrode. Thus, the internal short circuit of the secondary battery 100 is reduced.

### Application Example 5

Although not illustrated, the carbon layer 105 may be tangled with the dendrite. In other words, the carbon layer 105 and the dendrite may become a single component, and the dendrite or the like may be observed inside and outside the carbon layer 105. Such a phenomenon can prevent the dendrite from reaching the positive electrode. Thus, the internal short circuit of the secondary battery 100 is reduced.

Based on the above application example 5, the growth direction of the dendrite is not necessarily aligned with the arrow 119 direction. That is, in one embodiment of the present invention, the growth direction of the dendrite is not important as long as the carbon layer 105 can prevent the dendrite from reaching the positive electrode.

In the structures illustrated in FIGS. 5B and FIGS. 6A to 6C, the thickness of the carbon layer 105 is greater than or equal to 25 nm, preferably greater than or equal to 25 nm and less than or equal to 50 μm, greater than or equal to 25 nm and less than or equal to 10 μm, greater than or equal to 25 nm and less than or equal to 1 μm, or greater than or equal to 25 nm and less than or equal to 500 nm. To obtain the above thickness, the carbon layer 105 is stacked in some cases. The thickness of the above carbon layer 105 may be greater than or equal to 0.5 times and less than or equal to 1.5 times the thickness of the separator.

With the above-described structure and the like, the dendrite does not reach the positive electrode and thus the internal short circuit of the secondary battery can be prevented.

### Example of Manufacturing Method

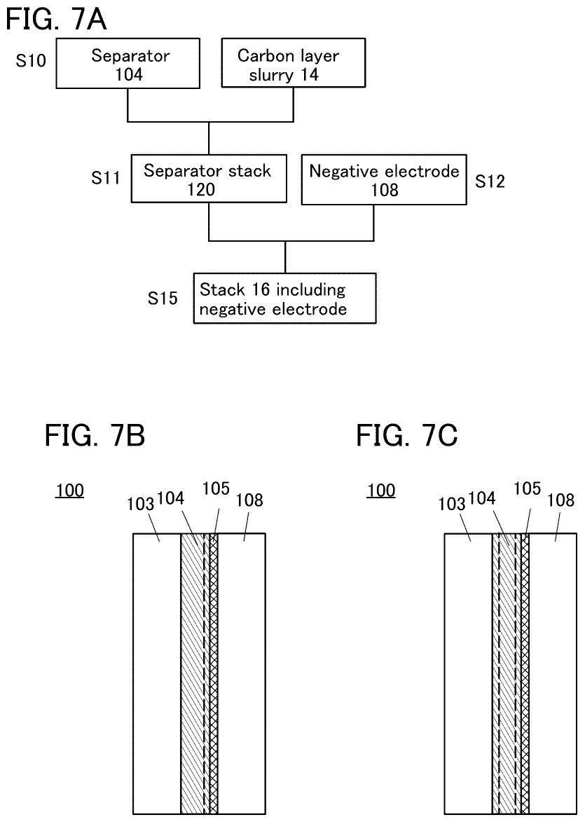

A manufacturing method example of the above-described separator stack 120 and the like is described with reference to FIG. 7A.

### <Step S10>

In Step S10 illustrated in FIG. 7A, the separator 104 and the carbon layer slurry 14 are prepared. In this manufacturing method, the carbon layer slurry 14 in which a carbon material, a solvent, and a binder are mixed is prepared. When the carbon layer slurry 14 in which the binder is mixed is used, a carbon layer including the binder can be formed. Note that a dispersant may be mixed in the carbon layer slurry 14.

### <Step S11>

In Step S11 illustrated in FIG. 7A, the separator 104 is coated with the carbon layer slurry 14. By drying subsequent to the coating, the separator 104 and the carbon layer 105 are bonded to each other. The separator stack 120 can be formed in this manner.

### <Coating Apparatus>

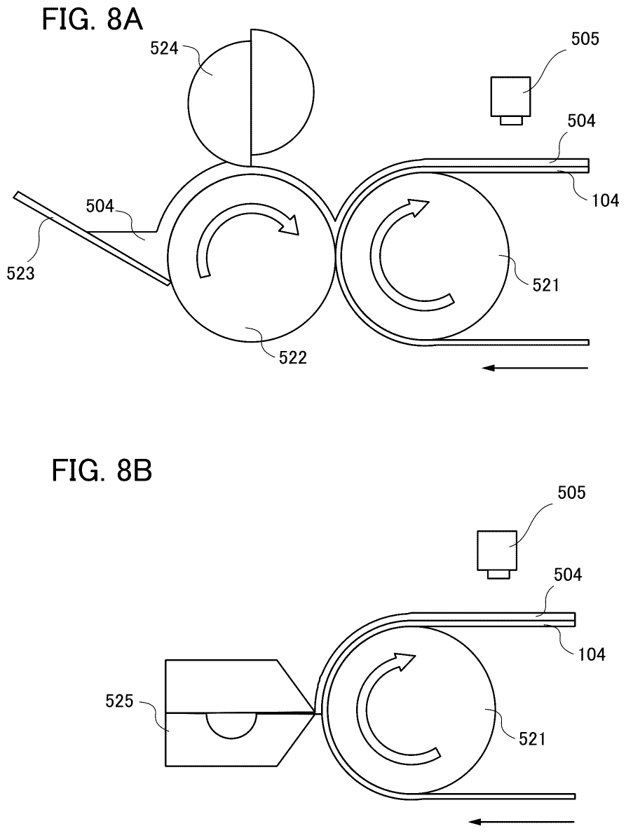

FIG. 8A illustrates a coating apparatus with which the separator 104 is coated with carbon layer slurry 504. The coating apparatus is referred to as a comma coater. The viscosity of the carbon layer slurry 504 used in the coating apparatus is not particularly limited, and the viscosity can be adjusted using a thickener.

The coating apparatus includes a back roll 521, a coating roll 522, a micro bar 524, and the like. A roll-shaped separator to be the separator 104 is moved by the back roll 521. The back roll 521 can rotate the coating roll 522. The carbon layer slurry 504 is held by the bottom surface of a dam 523 and the coating roll 522, and the separator 104 is coated with the carbon layer slurry 504 having a thickness that has been adjusted by the micro bar 524. Coating is also referred to as application. For monitoring the thickness of the carbon layer slurry 504 with which the separator 104 is coated, the coating apparatus preferably includes a thickness measurement sensor 505.

FIG. 8B illustrates another example of a coating apparatus with which the separator 104 is coated with the carbon layer slurry 504. The coating apparatus is referred to as a die coater. The viscosity of the carbon layer slurry 504 used in the coating apparatus is not particularly limited, and the viscosity can be adjusted using a thickener.

The coating apparatus includes a die 525, the back roll 521, and the like. The die 525 is an example of a coating nozzle and includes a manifold at the center of the die 525. The carbon layer slurry 504 is supplied to the manifold by a pump and the slurry 504 in the manifold is pushed out toward the end of the die. The negative electrode current collector 107 moved by the rotation of the back roll 521 is coated with the pushed-out carbon layer slurry 504. For monitoring the thickness of the carbon layer slurry 504 with which the negative electrode current collector 107 is coated, the coating apparatus preferably includes the thickness measurement sensor 505.

With such a coating apparatus, the separator stack 120 in which the carbon layer is attached to the separator can be obtained. By drying subsequent to the coating, a solvent and the like contained in the carbon layer slurry are removed.

Furthermore, the separator stack 120 is preferably pressed with a roller press machine as needed. The upper and lower rolls of the roller press machine are heated to 100° C. or higher, preferably 120° C. or higher. Note that in the case of using slurry including a binder, the upper and lower rolls are heated to the melting point of the binder or a higher temperature. The temperatures of the upper and lower rolls may be different from each other within the above temperature range. The step of pressing with the roller press machine is preferably performed, in which case adhesion between the separator 104 and the carbon layer 105 is increased.

In the case the separator stack 120 is manufactured in such a step, polyglutamic acid is preferably used as the binder of the carbon layer, in which case water, typically deionized water, can be selected as the solvent of the carbon layer slurry. Needless to say, an organic solvent can also be used as the solvent of the carbon layer slurry.

### <Step S12>

In Step S12 illustrated in FIG. 7A, the negative electrode 108 is prepared. The negative electrode 108 is a component including the negative electrode current collector 107 and the negative electrode active material layer 106. Specifically, the negative electrode current collector 107 is coated with negative electrode slurry including a negative electrode active material, a binder, and the like, drying is performed to remove a solvent, and pressing is performed with a roller press machine as needed, whereby the negative electrode 108 can be obtained. The negative electrode slurry may contain a conductive material. The viscosity of the negative electrode slurry is preferably adjusted using a thickener or the like.

### <Coating Apparatus>

The coating apparatus illustrated in FIGS. 8A and 8B can also be used for the coating step of the negative electrode 108. The structure and the like of the coating apparatus can be understood by replacing, respectively, the carbon layer slurry and the separator with the negative electrode slurry and the negative electrode current collector. After coating, the negative electrode 108 may be pressed with a roller press machine as necessary. A linear pressure is higher than or equal to 10 kN/m and lower than or equal to 50 kN/m, preferably higher than or equal to 15 kN/m and lower than or equal to 25 KN/m. The upper and lower rolls of the roller press machine are heated to 100° C. or higher, preferably 120° C. or higher. Note that in the case of slurry including a binder, the upper and lower rolls are heated to the melting point of the binder or a higher temperature. The temperatures of the upper and lower rolls may be different from each other within the above temperature range. The negative electrode 108 is completed in this manner.

As the solvent of the negative electrode slurry, water or an organic solvent can be used. In the case where a lithium metal is used as the negative electrode active material, it is difficult to select water as the solvent of the negative electrode slurry. That is, in the case of using a lithium metal, an organic solvent is selected as the solvent of the negative electrode slurry. In the case where a lithium metal is used, any binder that can be dispersed in an organic solvent can be used.

The negative electrode 108 is obtained using such a coating apparatus. In the negative electrode 108, the thickness of the negative electrode active material layer 106 is greater than or equal to 100 μm and less than or equal to 300 μm, preferably greater than or equal to 110 μm and less than or equal to 150 μm. The loading level of the negative electrode active material is greater than or equal to 3 mg/cm² and less than or equal to 20 mg/cm², preferably greater than or equal to 12 mg/cm² and less than or equal to 18 mg/cm².

### <Negative Electrode Current Collector 107>

The negative electrode current collector 107 is described. The negative electrode current collector can be formed using a material that has high conductivity, such as a metal like copper, stainless steel, gold, platinum, or titanium, or an alloy thereof. It is also possible to use an aluminum alloy to which an element that improves heat resistance, such as silicon, titanium, neodymium, scandium, or molybdenum, is added for the negative electrode current collector. A metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel. The negative electrode current collector can have a foil-like shape, a plate-like shape, a sheet-like shape, a net-like shape, a punching-metal shape, an expanded-metal shape, or the like as appropriate. The negative electrode current collector preferably has a thickness greater than or equal to 5 μm and less than or equal to 30 μm.

### <Negative Electrode Active Material>

A negative electrode active material included in the negative electrode active material layer 106 is described. For the negative electrode active material, a material capable of lithiation and delithiation can be used. For the negative electrode active material, a material that enables charge and discharge reactions by an alloying reaction and a dealloying reaction with lithium can be used. For the negative electrode active material, one or more composite materials selected from a lithium metal, carbon, and silicon can be used, for example. Silicon is preferably used because of its high theoretical capacity of 4200 mAh/g per weight of the active material. In the case where a lithium metal is used as the negative electrode active material, the negative electrode current collector can be omitted.

Examples of carbon include graphite, graphitizing carbon (soft carbon), non-graphitizing carbon (hard carbon), CNT, graphene, and carbon black. That is, in the case where the multi-walled CNT is used for the carbon layer 105 or the case where the multilayer graphene is used for the carbon layer 105, the carbon layer 105 is capable of lithiation and delithiation.

Graphite has a low potential substantially equal to that of a lithium metal when lithium ions are inserted into the graphite (when a lithium-graphite intercalation compound is formed). The potential of graphite is typically greater than or equal to 0.05 V and less than or equal to 0.3 V vs. Li/Li⁺. For this reason, a secondary battery using graphite can have a high operating voltage. In addition, graphite is preferable because of its advantages such as a relatively high discharge capacity per unit volume, relatively small volume expansion, low cost, and a higher level of safety than that of a lithium metal.

The negative electrode active material with a small median diameter (D50) may become bulky, hindering an increase in electrode density. Thus, the median diameter (D50) of the negative electrode active material preferably satisfies the range of greater than or equal to 3 μm and less than or equal to 20 μm, further preferably greater than or equal to 7 μm and less than or equal to 12 μm. Graphite is a typical example of the negative electrode active material satisfying the above range, and the median diameter (D50) of graphite preferably satisfies the above range as a powder characteristic

Examples of graphite include artificial graphite and natural graphite. Examples of artificial graphite include mesocarbon microbeads (MCMB), coke-based artificial graphite, and pitch-based artificial graphite. Artificial graphite may have a carbon coat layer that is a low crystalline layer. Since artificial graphite has a spherical shape, the artificial graphite is referred to as spherical graphite. For example, MCMB is one of preferable materials as spherical graphite. Moreover, MCMB can relatively easily have a small specific surface area. In the case where the specific surface area is large, the decomposition reaction with the electrolyte solution occurs significantly on the surface of the negative electrode active material; thus, favorable cycle characteristics cannot be obtained in some cases. In order to inhibit the above decomposition reaction, the specific surface area of carbon preferably satisfies greater than or equal to 0.8 m²/g and less than or equal to 8 m²/g, further preferably greater than or equal to 1 m²/g and less than or equal to 2 m²/g. Typically, spherical graphite preferably has the above-described specific surface area as a powder characteristic. The specific surface area can be measured by a Brunauer-Emmett-Teller (BET) method. The BET method is an analytical method in which Langmuir's theory of adsorption is extended to multilayer molecular adsorption of adsorbed gas molecules, which is the most common method for calculating the specific surface area. For measuring the specific surface area by the BET method, an automated specific surface area analyzer TriStar II 3020 can be used.

Examples of natural graphite include flake graphite and spherical natural graphite. Natural graphite may include a carbon coat layer that is a low crystalline layer.

Alternatively, a silicon-carbon composite material containing carbon and silicon can be used as the negative electrode active material. In the silicon-carbon composite material, it is preferable that carbon and silicon be in a mixture state and the sintered state through heat treatment be observed. In the silicon-carbon composite material, a graphite particle is preferably used for carbon, and the median diameter (D50) of the graphite particle is greater than or equal to 1 μm and less than or equal to 20 μm, preferably greater than or equal to 3 μm and less than or equal to 20 μm, further preferably greater than or equal to 7 μm and less than or equal to 12 μm. The median diameter (D50) of the graphite particle can be determined in consideration of the median diameter (D50) of silicon.

The specific surface area of the graphite particle is preferably greater than or equal to 0.5 m²/g and less than or equal to 3 m²/g. The specific surface area can be measured by the BET method. The specific surface area by the BET method is a value measured by a nitrogen gas adsorption one-point BET method, and an automated surface area and porosity analyzer, Tristar II 3020 (Micromeritics) can be used as a measuring instrument.

In the silicon-carbon composite material, silicon particles are preferably used for silicon. The silicon particle contains a silicon material, specifically, preferably one selected from silicon, silicon oxide, and a silicon alloy. Examples of silicon oxide include silicon monoxide (SiO). In this specification and the like, SiO refers, for example, to silicon monoxide. Silicon monoxide can also be expressed as SiOₓ. It is preferable that x be greater than or equal to 0.2 and less than or equal to 1.5, further preferably greater than or equal to 0.3 and less than or equal to 1.2.

The median diameter (D50) of the silicon particle is preferably less than 1 μm, typically greater than or equal to 50 nm and less than or equal to 800 nm, further preferably greater than or equal to 100 nm and less than or equal to 500 nm. A silicon particle with such a size is referred to as a nanosilicon particle in some cases. Although silicon has a problem of expansion and contraction at the time of charging and discharging, a nanosilicon particle that is miniaturized to have the above median diameter (D50) is suitable for reducing charge and discharge deterioration. The silicon particle preferably has a uniform median diameter (D50) through a grinding step of a silicon material.

The specific surface area of the silicon particle is preferably greater than or equal to 10 m²/g and less than or equal to 35 m²/g, further preferably greater than or equal to 10 m²/g and less than or equal to 15 m²/g. The specific surface area can be measured by the BET method. The specific surface area by the BET method is a value measured by a nitrogen gas adsorption one-point BET method, and an automated surface area and porosity analyzer, Tristar II 3020 (Micromeritics) can be used as a measuring instrument.

With the structure in which the negative electrode active material contains both graphite particles and silicon particles, a secondary battery with high discharge capacity can be achieved. Moreover, the median diameter (D50) of the graphite particle is different from, specifically larger than the median diameter (D50) of the silicon particle; when these particles are mixed and used for the negative electrode, a loading level of the negative electrode active material can be increased. The output characteristics of a lithium-ion secondary battery can be increased with a small loading level, but can be decreased with a high loading level. Thus, the loading level of the negative electrode active material is preferably higher than or equal to 3 mg/cm² and lower than or equal to 10 mg/cm².

In the negative electrode active material layer 106, the weight of the graphite particle is preferably greater than that of the silicon particle; typically, the weight proportion of the graphite particle is preferably greater than or equal to 5 times and less than or equal to 35 times that of the silicon particle. In other words, the silicon weight proportion in the total weight of the powder materials forming the negative electrode active material is preferably greater than or equal to 2 wt % and less than or equal to 37.5 wt %.

As the negative electrode active material, for example, a material containing one or more selected from tin, gallium, aluminum, germanium, lead, antimony, bismuth, silver, zinc, cadmium, indium, and the like can be used.

As the negative electrode active material, a compound containing one or more selected from tin, gallium, aluminum, germanium, lead, antimony, bismuth, silver, zinc, cadmium, indium, and the like can also be used. A compound containing two or more of these elements can be referred to as an alloy material, and for example, magnesium silicide (Mg₂Si) can be given.

Other examples of the alloy material include a magnesium-germanium alloy (Mg₂Ge), tin (II) oxide (SnO), tin (IV) oxide (SnO₂), a magnesium-tin compound (Mg₂Sn), tin disulfide (SnS₂), other main binary alloys of tin (V₂Sn₃, FeSn₂, CoSn₂, Ni₃Sn₂, Cu₆Sn₅, Ag₃Sn, LaSn₃, La₃Co₂Sn₇, and SbSn), and binary alloys of antimony (Ag₃Sb, Ni₂MnSb, CeSb₃, CoSb₃, and InSb).

As the negative electrode active material, an oxide such as titanium dioxide (TiO₂), lithium titanium oxide (Li₄Ti₅O₁₂), a lithium-graphite intercalation compound (LiₓC₆), niobium pentoxide (Nb₂O₅), tungsten dioxide (WO₂), or molybdenum dioxide (MoO₂) can be used.

Still alternatively, as the negative electrode active material, Li₃₋ₓMₓN (M=Co, Ni, or Cu) with a Li₃N structure, which is a nitride containing lithium and a transition metal, can be used. For example, Li_{2.6}C_{0.4}N is preferable because of its high discharge capacity (900 mAh/g per weight of the active material and 1890 mAh/cm³).

A nitride containing lithium and a transition metal is preferably used, in which case lithium ions are contained in the negative electrode active material and thus the negative electrode active material can be used in combination with a material for the positive electrode active material which does not contain lithium ions, such as V₂O₅ or Cr₃O₈. Note that in the case of using a material containing lithium ions as the positive electrode active material, the nitride containing lithium and a transition metal can be used as the negative electrode active material by extracting the lithium ions contained in the positive electrode active material in advance.

As another mode of the negative electrode, a negative electrode that does not contain a negative electrode active material after completion of the fabrication of the secondary battery may be used. As the negative electrode that does not contain a negative electrode active material, for example, a negative electrode can be used in which only a negative electrode current collector is included after completion of the fabrication of the secondary battery and in which lithium ions extracted from the positive electrode active material due to charge of the battery are precipitated as a lithium metal on the negative electrode current collector and form the negative electrode active material layer. A battery including such a negative electrode is referred to as a negative electrode-free (anode-free) battery, a negative electrodeless (anodeless) battery, or the like in some cases.

When the negative electrode that does not contain a negative electrode active material is used, a film for making uniform lithium precipitation may be included over the negative electrode current collector. For the film for making uniform lithium precipitation, for example, a solid electrolyte having lithium ion conductivity can be used. As the solid electrolyte, a sulfide-based solid electrolyte, an oxide-based solid electrolyte, a high molecule-based solid electrolyte, or the like can be used. In particular, the high molecule-based solid electrolyte can be uniformly formed as a film over a negative electrode current collector relatively easily, and thus is preferable as the film for making uniform lithium precipitation. Moreover, as the film for making uniform lithium precipitation, for example, a metal film that forms an alloy with lithium can be used. As the metal film that forms an alloy with lithium, for example, a magnesium metal film can be used. It is suitable for the film for making uniform lithium precipitation because lithium and magnesium form a solid solution in a wide range of compositions.

When the negative electrode that does not contain a negative electrode active material is used, a negative electrode current collector having unevenness can be used. When the negative electrode current collector having unevenness is used, a depression of the negative electrode current collector becomes a cavity in which lithium contained in the negative electrode current collector is easily precipitated, so that the lithium can be prevented from having a dendrite-like shape when being deposited.

The negative electrode active material layer 106 can include a binder similar to the binder included in the carbon layer.

Polyglutamic acid, which is described as a material of the binder, contains nitrogen in addition to the carboxy group as shown in Structural Formula (H1). The nitrogen includes an unshared electron pair and thus is expected to interact with a lithium ion. For example, the unshared electron pair possibly draws lithium ions to aid insertion of lithium ions into the negative electrode active material.

As is apparent from the structural formula, polyglutamic acid includes C═O, which is a carbonyl group. When the binder includes a group having a polarity, such as a carbonyl group, interaction with a lithium ion serving as a carrier ion is expected, and insertion and extraction of lithium ions in the negative electrode active material may be aided.

Such polyglutamic acid can provide a secondary battery having favorable characteristics at low temperatures.

### <Thickener>

The negative active electrode material layer 106 preferably includes a thickener in addition to the binder. For the thickener, for example, a water-soluble high molecule is preferably used. As the water-soluble high molecule, a polysaccharide can be used, for example. As the polysaccharide, starch; a cellulose derivative such as carboxymethyl cellulose (CMC), methyl cellulose, ethyl cellulose, hydroxypropyl cellulose, diacetyl cellulose, or regenerated cellulose; or the like can be used.

### <Conductive Material>

The negative electrode active material layer 106 preferably includes a conductive material. The conductive material has a function of giving aid to, for example, a current path between the active material and the current collector or a current path between a plurality of the active materials. In order to have such a function, the conductive material preferably includes a material having lower resistance than the active material. The conductive material is also referred to as a conductive additive or a conductivity-imparting agent because of its function. A conductive material is attached between a plurality of active materials, whereby the plurality of active materials are electrically connected to each other, and the conductivity increases accordingly. Note that the term “attach” in this specification and the like refers not only to a state where an active material and a conductive material are physically in close contact with each other, but also the following cases: a case where covalent bonding occurs, a case where bonding with the Van der Waals force occurs, a case where a conductive material covers part of the surface of an active material, a case where a conductive material is embedded in surface roughness of an active material, a case where an active material and a conductive material are electrically connected to each other without being in contact with each other, and other cases.

As the conductive material, a carbon material or a metal material is typically used. The conductive material is in a particulate form; examples of the particulate conductive material include carbon black (e.g., furnace black, acetylene black, or graphite). Some conductive materials are in a fibrous form; examples of the fibrous conductive material include CNT and VGCF (registered trademark). Other conductive materials are in a sheet form; examples of the sheet-shaped conductive material include multilayer graphene. The sheet-shaped conductive material sometimes looks like a thread in observation of a cross section of a positive electrode.

The particulate conductive material can enter a gap between, for example, negative electrode active materials, and easily aggregates. Thus, the particulate conductive material can give aid to a conductive path between negative electrode active materials provided close to each other. Although having a bent region, the fibrous conductive material is larger than a negative electrode active material. The fibrous conductive material can thus give aid to not only a conductive path between adjacent negative electrode active materials but also a conductive path between negative electrode active materials that are apart from each other. Conductive materials in two or more forms as described above are preferably mixed.

In the case where multilayer graphene as a sheet-shaped conductive material and carbon black as a particulate conductive material are used, the weight of the carbon black is preferably greater than or equal to 1.5 times and less than or equal to 20 times, further preferably greater than or equal to 2 times and less than or equal to 9.5 times that of the multilayer graphene in slurry in which the carbon black and the multilayer graphene are mixed.

When the mixing ratio between the multilayer graphene and the carbon black is in the above range, the carbon black does not aggregate and is easily dispersed. When the mixing ratio between the multilayer graphene and the carbon black is in the above range, the electrode density can be higher than when only the carbon black is used as a conductive material. A higher electrode density leads to higher capacity per unit weight.

Moreover, when the mixing ratio between the multilayer graphene and the carbon black is in the above range, rapid charging is possible.

A graphene compound may be used instead of the above-described multilayer graphene as the conductive material. As a graphene compound, fluorine-containing graphene may be used. Fluorine in the graphene compound is preferably adsorbed on the surface. Fluorine-containing graphene can be formed by making graphene and a fluorine compound contact each other (which is called fluorination treatment). The fluoridation treatment is preferably performed using fluorine (F₂) or a fluorine compound. The fluorine compound is preferably hydrogen fluoride, halogen fluoride (e.g., ClF₃ or IF₅), a gaseous fluoride (e.g., BF₃, NF₃, PF₅, SiF₄, or SF₆), a metal fluoride (e.g., LiF, NiF₂, AlF₃, or MgF₂), or the like. The fluorination treatment is preferably performed using a gaseous fluoride, which may be diluted with an inert gas. The fluorination treatment is preferably performed at room temperature or in a temperature range higher than or equal to 0° C. and lower than or equal to 250° C., which includes room temperature. Performing the fluorination treatment at higher than or equal to 0° C. enables adsorption of fluorine onto a surface of graphene.

Graphene or a graphene compound is suitable for the conductive material because of its excellent physical properties of high flexibility and high mechanical strength. Graphene or a graphene compound sometimes has a curved surface, thereby enabling low-resistant surface contact. Furthermore, graphene or a graphene compound has extremely high conductivity even with a small thickness in some cases and thus allows a conductive path to be formed in an active material layer efficiently even with a small amount. Hence, the use of graphene or a graphene compound as the conductive material can increase the area where the active material and the conductive material are in contact with each other. Graphene or a graphene compound may have a hole.

In the case where a negative electrode active material with a size less than or equal to 1 μm, such as a nanosilicon particle, is used, more conductive paths for connecting active materials are needed. In such a case, it is preferable that graphene or a graphene compound that can efficiently form a conductive path even with a small amount be used.

It is particularly effective to use graphene or a graphene compound, which has the above-described properties, as a conductive material of a secondary battery that needs to be rapidly charged and discharged. For example, a secondary battery for a two- or four-wheeled vehicle, a secondary battery for a drone, or the like is required to be rapidly charged and discharged in some cases. In addition, a mobile electronic device or the like is required to have rapid charge characteristics in some cases. Rapid charging refers to charging at 400 mA/g or more, or charging at 1000 mA/g or more, for example. Rapid discharging refers to discharging at 400 mA/g or more, or discharging at 1000 mA/g or more, for example.

### <Step S15>

Next, in Step S15 illustrated in FIG. 7A, the separator stack 120 and the negative electrode 108 are attached to each other, whereby the stack 16 including the negative electrode can be obtained. Since the step of attaching the carbon layer 105 and the separator 104 and the step of forming the negative electrode 108 are performed separately, the range of options of materials for the carbon layer slurry is widened, which is preferable. In addition, the range of options of materials for the negative electrode slurry is also widened.

In the case where the carbon layer 105 includes a binder, the carbon layer 105 is preferably bonded to the separator 104 by pressing with a roller press machine. The upper and lower rolls of the roller press machine are heated to 100° C. or higher, preferably 120° C. or higher. Note that in the case of using slurry including a binder, the upper and lower rolls are heated to the melting point of the binder or a higher temperature. The temperatures of the upper and lower rolls may be different from each other within the above temperature range.

According to this manufacturing method example, the separator stack 120 including the carbon layer 105 can be formed. Then, a stack including a negative electrode in which the separator stack 120 is attached to the negative electrode 108 can be formed. Since the separator stack 120 includes the carbon layer 105, a dendrite is inhibited from reaching the positive electrode.

After the separator stack 120 and the negative electrode 108 are attached to each other, the positive electrode 103 is preferably attached to the separator 104 such that the positive electrode 103 face each other. After that, pressing is preferably performed using a roller press machine or the like as needed. Needless to say, the positive electrode 103 may be attached to the separator 104, and then the negative electrode 108 may be attached to the separator 104. The secondary battery 100 is completed in this manner.

FIGS. 7B and 7C are each a cross-sectional view illustrating an example of the secondary battery 100 that can be formed according to this manufacturing method example. In FIG. 7B, the separator 104 has a two-layer structure, and in FIG. 7C, the separator has a three-layer structure. As illustrated in FIG. 7B, a layer containing one or more selected from aluminum oxide particles, silicon oxide particles, and magnesium oxide particles is preferably provided on one surface of the separator 104 on the carbon layer 105 side. As illustrated in FIG. 7C, layers containing one or more selected from aluminum oxide particles, silicon oxide particles, and magnesium oxide particles are preferably provided on both surfaces of the separator 104. After the secondary battery 100 is charged and discharged, the one or more selected from the aluminum oxide particles, the silicon oxide particles, and the magnesium oxide particles are sometimes dissolved into the negative electrode 108. In addition, the one or more selected from the aluminum oxide particles, the silicon oxide particles, and the magnesium oxide particles are sometimes dissolved into the positive electrode 103 after the secondary battery 100 is charged and discharged.

Through the step of pressing with the roller press machine or the like, the materials included in the secondary battery 100 can be in close contact with each other. Furthermore, the separator 104 is mainly impregnated with the electrolyte solution 110, whereby the electrolyte solution 110 can sufficiently spread to the positive electrode 103 and the negative electrode 108. An appropriate amount of the electrolyte solution 110 included in the secondary battery 100 improves the safety and increases the effect of preventing firing of the secondary battery 100. In other words, the secondary battery 100 is unlikely to catch fire when a nail penetration test is performed on the secondary battery 100, which is preferable.

The contents in this embodiment can be combined with the contents in any of the other embodiments as appropriate.

### Embodiment 2

In this embodiment, a structure example of a secondary battery will be described.

### [Negative Electrode]

The negative electrode is as described in the above embodiment.

### [Positive Electrode]

The positive electrode includes a positive electrode active material layer and a positive electrode current collector. The positive electrode active material layer contains a positive electrode active material and may further contain at least one of a conductive material and a binder. The positive electrode active material described in the above embodiment can be used.

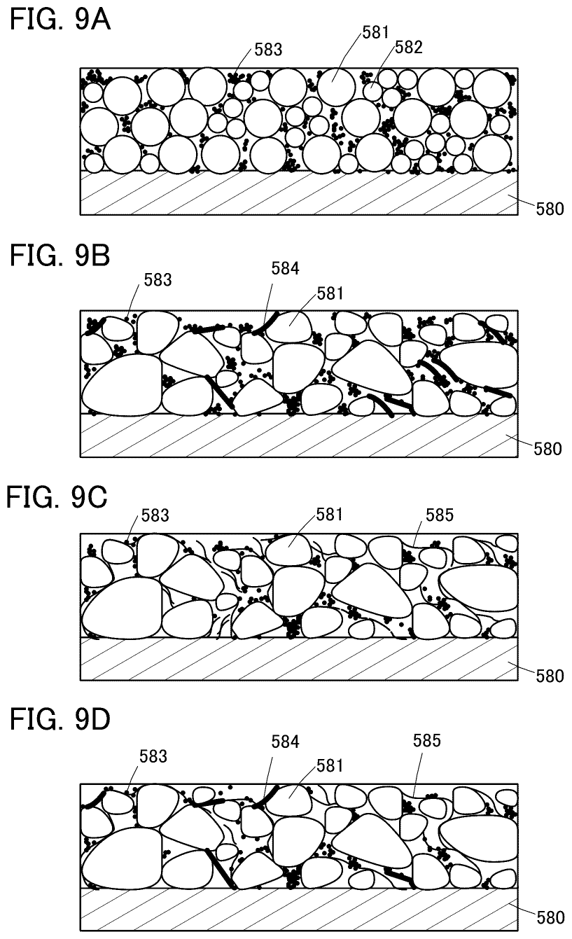

FIG. 9A illustrates an example of a schematic cross-sectional view of the positive electrode.

For example, metal foil can be used for a positive electrode current collector 580. The positive electrode can be formed by applying slurry onto metal foil and drying the slurry. Pressing may be performed after drying. The positive electrode is obtained by forming a positive electrode active material layer over the positive electrode current collector 580.

The positive electrode active material layer contains a positive electrode active material 581. A positive electrode active material is referred to as a positive electrode active material particle in some cases. The positive electrode active material 581 has a function of taking and/or releasing lithium ions in accordance with charging and discharging. For the positive electrode active material 581 used as one embodiment of the present invention, a material with less deterioration due to high-voltage charging and discharging can be used. Note that for the positive electrode active material 581, two or more kinds of materials having different particle diameters can be used as long as the materials have less deterioration due to high-voltage charging and discharging.

Any of the conductive materials described in the above embodiment can be appropriately selected as a conductive material. In FIG. 9A, a carbon black 583 is illustrated as a conductive material.

In the positive electrode of the secondary battery, a binder may be mixed in order to adhere the positive electrode current collector 580 such as metal foil and the positive electride active material to each other. Since the binder is a high molecular material, a large amount of binder lowers the proportion of the active material in the positive electrode, thereby reducing the discharge capacity of the secondary battery. Therefore, the amount of binder mixed is preferably reduced to a minimum. In FIG. 9A, a region not filled with any of the positive electrode active material 581, a second positive electrode active material 582, and the carbon black 583 indicates a space or a binder.

Although FIG. 9A illustrates an example in which the positive electrode active material 581 has a spherical shape, there is no particular limitation on the shape of the positive electrode active material 581. For example, the cross-sectional shape of the positive electrode active material 581 may be an ellipse, a rectangle, a trapezoid, a pyramid, a polygon with rounded corners, or an asymmetrical shape. For example, FIG. 9B illustrates an example in which the positive electrode active material 581 has a polygon shape with rounded corners.

In the positive electrode in FIG. 9B, graphene 584 is used as a carbon material used as the conductive material. FIG. 9B illustrates a positive electrode active material layer in which the positive electrode active material 581, the graphene 584, and the carbon black 583 are provided over the positive electrode current collector 580.

In the step of mixing the graphene 584 and the carbon black 583 to obtain positive electrode slurry, the weight of mixed carbon black is preferably 1.5 times to 20 times, further preferably 2 times to 9.5 times the weight of graphene.

When the graphene 584 and the carbon black 583 are mixed in the above range, the carbon black 583 is excellent in dispersion stability and less likely to be aggregated at the time of preparing the positive electrode slurry. Furthermore, a positive electrode containing the graphene 584 and the carbon black 583 which are mixed in the above range can have higher density than that including only the carbon black 583 as the conductive material. A higher electrode density leads to higher capacity per unit weight.

A positive electrode containing a first carbon material (graphene) and a second carbon material (acetylene black) which are mixed in the above range enables rapid charging, although having lower electrode density than a positive electrode containing only graphene as a conductive material. Thus, use of such a positive electrode for lithium-ion secondary batteries for vehicles is particularly effective.

FIG. 9C illustrates an example of a positive electrode using carbon fiber 585 instead of graphene. FIG. 9C illustrates an example different from that in FIG. 9B. With the use of the carbon fiber 585, aggregation of the carbon black 583 can be prevented and the dispersibility can be increased.

In FIG. 9C, a region that is not filled with any of the positive electrode active material 581, the carbon fiber 585, and the carbon black 583 indicates a space or a binder.

FIG. 9D illustrates another example of a positive electrode. FIG. 9C illustrates an example in which the carbon fiber 585 is used in addition to the graphene 584. With the use of both the graphene 584 and the carbon fiber 585, aggregation of carbon black such as the carbon black 583 can be prevented and the dispersibility can be further increased.

In FIG. 9D, a region not filled with any of the positive electrode active material 581, the carbon fiber 585, the graphene 584, and the carbon black 583 indicates a space or a binder.

A lithium-ion secondary battery can be fabricated by using any one of the positive electrodes in FIGS. 9A to 9D; setting, in a container (e.g., an exterior body or a metal can), a stack in which a separator is provided over the positive electrode and a negative electrode is provided over the separator; and filling the container with a liquid electrolyte.

### [Electrolyte Solution]

The electrolyte solution contains an organic solvent; the organic solvent of the electrolyte of one embodiment of the present invention is not limited to a liquid at 25° C. and may be a solid at 25° C. or a semi-solid at normal temperature. Note that the organic solvent of the electrolyte of one embodiment of the present invention is preferably a liquid in a wide temperature range from temperatures below freezing to high temperatures; however, the present invention is not limited thereto. The organic solvent may be a liquid, a solid, or a semi-solid in a wide temperature range from temperatures below freezing to high temperatures.

As an organic solvent, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), 1,3-propanesultone (PS), fluoroethylene carbonate (FEC), methyl 3,3,3-trifluoropropionate (MTFP), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination in an appropriate ratio. Typically, ethylene carbonate (EC) and diethyl carbonate (DEC) are preferably used at a volume ratio of 3:7.

PS has a HOMO level and a LUMO level equivalent to those of EC and DEC; thus, PS is less likely to be oxidized and reduced even at a high cut-off voltage, and is likely to be a high molecule when decomposed on the surface of the positive electrode active material. Accordingly, PS is advantageous in that it is unlikely to be gasified by becoming a decomposition product with a small molecular weight. Thus, the electrolyte solution preferably contains PS at higher than or equal to 0.1 wt % and lower than or equal to 10 wt %, further preferably higher than or equal to 0.25 wt % and lower than or equal to 7.5 wt %.

FEC, which is one of cyclic carbonates, has a high dielectric constant and thus has an effect of promoting dissociation of a lithium salt when used in an organic solvent. Meanwhile, because FEC includes a substituent with an electron-withdrawing property, a lithium ion is desolvated with FEC more easily than with EC. Specifically, the solvation energy of a lithium ion is lower in FEC than in EC not including a substituent with an electron-withdrawing property. Thus, lithium ions are likely to be extracted from surfaces of a positive electrode active material and a negative electrode active material, which can reduce an internal resistance of a secondary battery. In addition, FEC has a deep highest occupied molecular orbital (HOMO) level and is thus not easily oxidized, meaning high oxidation resistance. On the other hand, FEC disadvantageously has high viscosity. In view of this, a mixed organic solvent containing not only FEC but also MTFP is preferably used for the electrolyte solution. MTFP, which is one of linear carbonates, can have an effect of reducing the viscosity of an electrolyte solution or maintaining the viscosity at room temperature (typically, 25° C.) even at low temperatures (typically, 0° C.). Furthermore, while the solvation energy is lower in MTFP than in methyl propionate (abbreviation: MP) not including a substituent with an electron-withdrawing property, MTFP may solvate a lithium ion when used for the electrolyte solution. In the case of using a mixed organic solvent containing both FEC and MTFP, y in the volume ratio FEC:MTFP=1:y preferably satisfies 2≤y≤20, further preferably 4≤y≤9.

It is preferable that the above-described organic solvent be highly purified and contain a small amount of dust particles or molecules other than constituent molecules of the organic solvent (hereinafter also simply referred to as impurities and include oxygen (O₂), water (H₂O), and moisture).

It is preferable that generation of a reaction by-product in synthesis be inhibited through appropriate purification. Specifically, the impurity in the electrolyte is less than or equal to 100 ppm, preferably less than or equal to 50 ppm, further preferably less than 10 ppm. The content of water among impurities can be detected by Karl Fischer titration.

Furthermore, it is preferable that peaks attributed to impurities in the above-described organic solvent be hardly observed by NMR measurement or the like. The expression “hardly observed” includes the case where the ratio of the integral area of the peak attributed to impurities to the integral area of the peak attributed to the main component (such a ratio is simply referred to as an integral ratio) is less than or equal to 0.005, preferably less than or equal to 0.002. An apparatus used for the NMR measurement is not particularly limited, and for example, “AVANCE III 400” (Bruker Corporation) can be used. Among the five peaks of acetonitrile derived from acetonitrile-d₃ used in a solvent in the ¹H-NMR measurement, the center peak can be 1.94 ppm.

For example, in the case of MTFP, it is known that when 1H-NMR is measured using an acetonitrile-d₃ solvent, four peaks appear at 8 of greater than or equal to 3.29 ppm and less than or equal to 3.43 ppm. However, in the case where another peak appears in the vicinity of the above range, for example, another peak appears at 8 of greater than or equal to 3.24 ppm and less than or equal to 3.29 ppm, the peak is probably derived from impurities. Accordingly, when the ratio (integral ratio) of a peak area greater than or equal to 3.24 ppm and less than or equal to 3.29 ppm to a peak area greater than or equal to 3.29 ppm and less than or equal to 3.43 ppm is less than or equal to 0.005, preferably less than or equal to 0.002, peaks attributed to impurities are hardly observed.

In order to form a coating film (solid electrolyte interphase film) at the interface between the electrode (active material layer) and the electrolyte solution for the purpose of improvement of the safety or the like, an additive agent such as vinylene carbonate (VC), propane sultone (PS), tert-butylbenzene (TBB), fluoroethylene carbonate (FEC), lithium bis(oxalate)borate (LiBOB), or a dinitrile compound such as succinonitrile or adiponitrile is preferably added to the electrolyte solution. The concentration of such an additive agent in the solvent is preferably, for example, higher than or equal to 0.1 wt % and lower than or equal to 5 wt %. In the case where ethylene carbonate (EC) and diethyl carbonate (DEC) are used, it is preferable to use a solution obtained by adding 2 wt % of vinylene carbonate (VC) to a mixed organic solvent where ethylene carbonate (EC) and diethyl carbonate (DEC) are mixed at a volume ratio of 3:7 and a lithium salt described later is dissolved.

Alternatively, the use of one or more kinds of ionic liquids (room temperature molten salts) that are unlikely to burn and volatize as the solvent of the electrolyte solution can prevent a power storage device from exploding and catching fire even when the power storage device internally shorts out or the internal temperature increases owing to overcharging or the like. An ionic liquid contains a cation and an anion, specifically, an organic cation and an anion. Examples of the organic cation used for the electrolyte solution include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As the electrolyte dissolved in the above solvent (also referred to as a lithium salt), one of lithium salts such as LiPF₆, LiClO₄, LiAsF₆, LiBF₄, LiAlCH₄, LiSCN, LiBr, LiI, Li₂SO₄, Li₂B₁₀Cl₁₀, Li₂B₁₂Cl₁₂, LiCF₃SO₃, LiCAF₉SO₃, LiC(CF₃SO₂)₃, LiC(C₂F₅SO₂)₃, LiN(CF₃SO₂)₂, LiN(C₄F₉SO₂) (CF₃SO₂), LiN(C₂F₅SO₂)₂, and lithium bis(oxalate)borate (Li(C₂O₄)₂ or LiBOB) can be used, or two or more of these lithium salts can be used in an appropriate combination and in an appropriate ratio.

The electrolyte solution is preferably highly purified and contains a small amount of dust particles or elements other than the constituent elements of the electrolyte solution (hereinafter, also simply referred to as impurities). Specifically, the weight ratio of impurities to the electrolyte solution is preferably less than or equal to 1%, further preferably less than or equal to 0.1%, still further preferably less than or equal to 0.01%.

Alternatively, a polymer gel electrolyte obtained in such a manner that a polymer is swelled with an electrolyte solution may be used.

When a polymer gel electrolyte is used, safety against liquid leakage and the like is improved. Moreover, a secondary battery can be thinner and more lightweight.

As a gelled polymer, a silicone gel, an acrylic gel, an acrylonitrile gel, a polyethylene oxide-based gel, a polypropylene oxide-based gel, a fluorine-based polymer gel, or the like can be used. For example, a polymer having a polyalkylene oxide structure, such as polyethylene oxide (PEO), PVDF, polyacrylonitrile, or a copolymer containing any of them can be used. For example, PVDF-HFP, which is a copolymer of PVDF and hexafluoropropylene (HFP), can be used. The formed polymer may be porous.

In addition, as the electrolyte solution, a solid electrolyte including an inorganic material such as a sulfide-based or oxide-based inorganic material, or a solid electrolyte including a high molecular material such as a polyethylene oxide (PEO)-based polymer material may be used. When the solid electrolyte is used, a separator or a spacer is not necessary. Furthermore, the battery can be entirely solidified; therefore, there is no risk of liquid leakage and thus the safety of the battery is dramatically improved.

### [Separator]

The separator is as described in the above embodiment.

### [Exterior]

The exterior is as described in the above embodiment.

This embodiment can be implemented in appropriate combination with any of the other embodiments.

### Embodiment 3

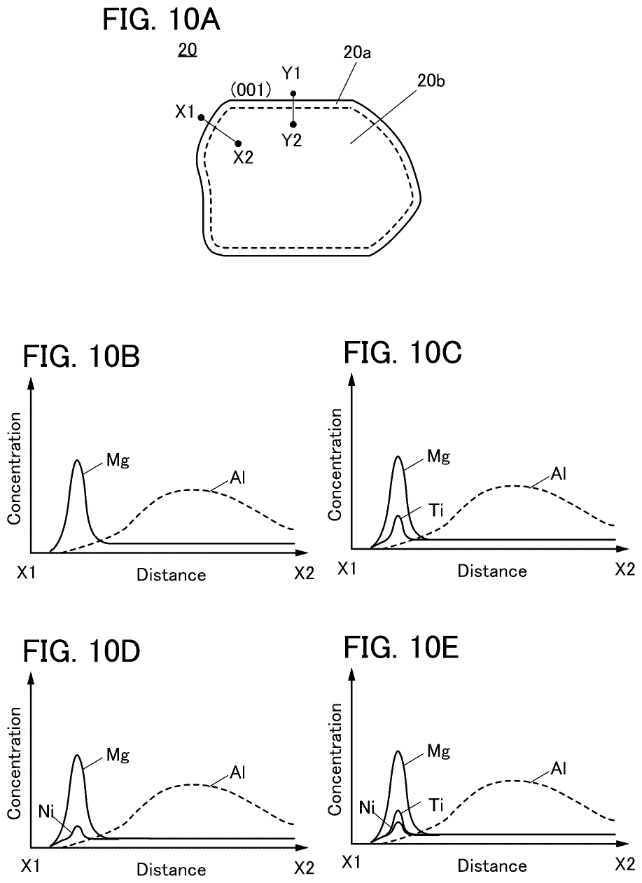

In this embodiment, a positive electrode active material particle 20 of one embodiment of the present invention will be described with reference to FIGS. 10A to 10E, FIG. 11, and FIGS. 12A to 12C. The positive electrode active material particle 20 can be used as the positive electrode active material 581 or the like.

FIG. 10A is a cross-sectional view of the positive electrode active material particle 20 of one embodiment of the present invention. The positive electrode active material particle 20 preferably includes a surface portion 20a and an inner portion 20b. The dashed line in FIG. 10A denotes an example of a boundary between the surface portion 20a and the inner portion 20b.

In this specification and the like, the surface portion 20a can be regarded as a region ranging from the surface of the particle to a depth of 20 nm or less in a depth direction, a region ranging from the surface of the particle to a depth of 10 nm or less in the depth direction, a region ranging from the surface of the particle to a depth of 5 nm or less in the depth direction, or a region ranging from the surface of the particle to a depth of 3 nm or less in the depth direction. Note that the depth direction refers to a direction perpendicular or substantially perpendicular to the surface of the particle. The term “perpendicular or substantially perpendicular” refers to an angle within the range of 80° to 100°, both inclusive, with respect to the surface. A plane generated by a fissure and/or a crack can be considered as a surface of a particle. The surface portion 20a can be rephrased as the vicinity of a surface, a region in the vicinity of a surface, or a shell.

A region deeper than the surface portion 20a can be referred to as the inner portion 20b. The inner portion 20b is synonymous with an inner region or a core.

The positive electrode active material particle 20 includes lithium cobalt oxide as its main component, which preferably belongs to the space group R-3m. The inner portion 20b preferably includes a layered rock-salt crystal structure. The surface portion 20a preferably includes a rock-salt crystal structure whose crystal orientations are aligned or substantially aligned with those of the layered rock-salt crystal structure. Needless to say, the surface portion 20a needs to partly include the layered rock-salt crystal structure to allow insertion and extraction of lithium ions. Accordingly, the surface portion 20a preferably includes both the layered rock-salt crystal structure and the rock-salt crystal structure.

In FIG. 10A, (001) refers to a (001) plane of lithium cobalt oxide. The surface portion 20a includes a region having a (001) plane (also referred to as a region having a (001) orientation, a region having a surface parallel to the (001) plane, or a basal region). The surface portion 20a also includes an edge region. The edge region is a region including a surface that is exposed in a direction intersecting the (001) plane or a region having an orientation other than the (001) orientation. In FIG. 10A, the line X1-X2 is along a cross section of the edge region, and the line Y1-Y2 is along a cross section of the basal region.

FIGS. 10B to 10E are schematic diagrams showing distributions of additive elements in the edge region. In FIGS. 10B to 10E, the horizontal axis represents the distance from a measurement point and the vertical axis represents the concentration of an element. When the particle surface is determined on the horizontal axis, the distance from the particle surface is obtained. A schematic view like FIGS. 10B to 10E is obtained from a graph of a cross-sectional analysis result. The analysis direction of the cross-sectional analysis is from the surface of the particle toward the inner portion 20b, and the analysis in this direction is referred to as depth direction analysis. That is, the distance on the horizontal axis can also be regarded as the depth in a particle. For the cross-sectional analysis, line analysis using a scanning transmission electron microscope and energy dispersive x-ray spectroscopy (STEM-EDX) can be used, for example.

Thus, the positive electrode active material particle 20 does not contain a material to which a metal oxide that does not contain a lithium site contributing to charging and discharging, such as aluminum oxide, is attached, or a carbonate, a hydroxy group, or the like which is chemically adsorbed after formation of the positive electrode active material. Thus, the surface of the positive electrode active material particle 20 is the surface of the particle including the surface portion 20a and the inner portion 20b. The attached metal oxide refers to, for example, a metal oxide having a crystal orientation that is not aligned with a crystal orientation of the inner portion 20b.

Furthermore, an electrolyte, an organic solvent, a binder, a conductive material, and a compound originating from any of these that are attached to the positive electrode active material particle 20 are not contained in the positive electrode active material particle 20 either. The electrolyte, the organic solvent, the binder, the conductive material, and the compound originating from any of these that are attached can be removed by cleaning.

### <Element Contained>

The positive electrode active material particle 20 contains lithium, the transition metal M, oxygen, and an additive element. The transition metal M is one or more of cobalt, nickel, and manganese. When cobalt is selected as the transition metal M, the positive electrode active material particle 20 can be regarded as containing lithium cobalt oxide (LiCoO₂) and an additive element. Note that the lithium cobalt oxide does not need to exactly satisfy the composition represented by the chemical formula. That is, the composition of the lithium cobalt oxide is not limited to Li:Co:O=1:1:2 (atomic ratio).

The positive electrode active material particle 20 needs to contain a transition metal M which can take part in an oxidation-reduction reaction in order to maintain a neutrally charged state even when lithium ions are inserted and extracted. Using cobalt at greater than or equal to 75 at % (atomic %), preferably greater than or equal to 90 at %, further preferably greater than or equal to 95 at % as the transition metal contained in the positive electrode active material particle 20 brings many advantages such as relatively easy synthesis, easy handling, and excellent charging and discharging cycle performance, which is preferable.

### <Additive Element>

As the additive element contained in the positive electrode active material particle 20, one or two or more selected from magnesium, fluorine, nickel, aluminum, titanium, zirconium, vanadium, iron, manganese, chromium, niobium, arsenic, zinc, silicon, sulfur, phosphorus, and boron are preferably used. Although nickel is used as a main component of the positive electrode active material particle 20 in some cases, nickel may be further added as an additive element to the positive electrode active material particle 20.

### [Magnesium]

When magnesium is present in the surface portion 20a, the layered rock-salt crystal structure is easily maintained. This phenomenon will be described. It is possible that the surface portion 20a is affected by magnesium dissolved from the separator 104.

A magnesium ion is a divalent cation, and the magnesium ion is more stable in a lithium site than in a cobalt site in a layered rock-salt crystal structure; thus, magnesium is likely to enter the lithium sites. Magnesium occupying the lithium sites functions as a pillar supporting CoO₂ layers; thus, the layered rock-salt crystal structure is easily maintained.

Moreover, magnesium can inhibit extraction of oxygen therearound in a state where x in LiₓCoO₂ is, for example, 0.24 or less. In addition, a high magnesium concentration in the surface portion 20a can be expected to increase the corrosion resistance to hydrofluoric acid generated by the decomposition of the electrolyte solution. In order to elicit the effect of corrosion resistance to hydrofluoric acid, the concentration of magnesium in the surface portion is preferably high.

Too small an amount of magnesium fails to sufficiently elicit the above effect, whereas too large an amount of magnesium decreases the capacity. Thus, in the entire positive electrode active material particle 20, the number of magnesium atoms is preferably greater than or equal to 0.002 times and less than or equal to 0.06 times, further preferably greater than or equal to 0.005 times and less than or equal to 0.03 times, still further preferably approximately 0.01 times the number of cobalt atoms, for example. The amount of magnesium contained in the entire positive electrode active material particle 20 may be, for example, a value obtained by performing an element analysis entirely on the positive electrode active material particles 20 with glow discharge mass spectrometry (GD-MS), inductively coupled plasma mass spectrometry (ICP-MS), or the like or may be a value based on the ratio of the raw materials mixed in the process of forming the positive electrode active material particles 20.

### [Aluminum]

Aluminum can be present at a cobalt site in a layered rock-salt crystal structure. That is, aluminum is present in the inner portion 20b. Since aluminum is a trivalent representative element and its valence does not change, lithium around aluminum is less likely to move even in charge and discharge. Thus, aluminum and lithium around aluminum serve as pillars to suppress a change in the crystal structure. This would reduce degradation of the positive electrode active material particle 20 if force of expansion and contraction of the positive electrode active material particle 20 in the c-axis direction operates owing to insertion and extraction of lithium ions, i.e., owing to a change in charge depth or charge rate.

Furthermore, aluminum has an effect of inhibiting dissolution of cobalt around aluminum and improving cycle performance. Moreover, an Al—O bond is stronger than a Co—O bond and thus extraction of oxygen around aluminum can be inhibited. These effects improve thermal stability. Therefore, a secondary battery that contains aluminum can have a higher degree of safety.

Meanwhile, an excess amount of aluminum may adversely affect insertion and extraction of lithium. Thus, the entire positive electrode active material particle 20 preferably contains an appropriate amount of aluminum. For example, in the entire positive electrode active material particle 20, the number of aluminum atoms is preferably greater than or equal to 0.05% and less than or equal to 4%, further preferably greater than or equal to 0.1% and less than or equal to 2%, still further preferably greater than or equal to 0.3% and less than or equal to 1.5% of the number of cobalt atoms. Alternatively, the number of aluminum atoms is preferably greater than or equal to 0.05% and less than or equal to 2% of the number of cobalt atoms. Alternatively, the number of aluminum atoms is preferably greater than or equal to 0.1% and less than or equal to 4% of the number of cobalt atoms. Here, the amount of aluminum contained in the entire positive electrode active material particle 20 may be a value obtained by performing an element analysis entirely on the positive electrode active material particles 20 with GD-MS, ICP-MS, or the like or may be a value based on the ratio of the raw materials mixed in the process of forming the positive electrode active material particles 20, for example.

### [Fluorine]

When part of oxygen in the surface portion 20a is replaced with fluorine, which is a monovalent anion, the lithium extraction energy is lowered. This is because the oxidation-reduction potential of cobalt ions associated with lithium extraction differs depending on the presence or absence of fluorine. That is, when fluorine is not included, cobalt ions change from a trivalent state to a tetravalent state owing to lithium extraction. Meanwhile, when fluorine is included, cobalt ions change from a divalent state to a trivalent state owing to lithium extraction. The oxidation-reduction potential of cobalt ions differs between these cases. It can thus be said that when part of oxygen is replaced with fluorine in the surface portion 20a of the positive electrode active material particle 20, lithium ions near fluorine are likely to be extracted and inserted smoothly. Thus, a secondary battery including the positive electrode active material particle 20 can have improved charge-discharge characteristics, improved large current characteristics, or the like.

When fluorine is present at the surface that is in contact with an electrolyte solution, or when a fluoride is attached to the surface, an overreaction between the positive electrode active material particle 20 and the electrolyte solution can be suppressed. In addition, the corrosion resistance to hydrofluoric acid can be effectively increased.

### [Nickel]

In lithium cobalt oxide having a layered rock-salt crystal structure, nickel can occupy a cobalt site and/or a lithium site. That is, aluminum can be present in the surface portion 20a. Since nickel has a lower oxidation-reduction potential than cobalt, nickel occupying a cobalt site can facilitate release of lithium and electrons during charging, for example. As a result, the charge and discharge speed is expected to be increased.

In addition, when nickel occupies a lithium site, a shift in the layered structure formed of octahedrons of cobalt and oxygen atoms can be inhibited. This is probably because nickel occupying the lithium sites also serves as a pillar supporting the CoO₂ layers. Moreover, when nickel occupies lithium sites, the crystal structure is expected to be more stable in a charged state at high temperatures, e.g., 45° C. or higher.

Ionization tendency is the lowest in nickel, followed in order by cobalt, aluminum, and magnesium (Mg>Al>Co>Ni). Therefore, it is considered that in charging, nickel is less likely to be dissolved into an electrolyte solution than the other elements described above. Accordingly, nickel is considered to have a high effect of stabilizing the crystal structure of the surface portion 20a in a charged state.

Furthermore, in nickel, Ni²⁺ is more stable than Ni³⁺ and Ni⁴⁺, and nickel has higher trivalent ionization energy than cobalt. Thus, it is known that a spinel crystal structure does not appear only with nickel and oxygen. Therefore, nickel is considered to have an effect of inhibiting a phase change from a layered rock-salt crystal structure to a spinel crystal structure.

Meanwhile, an excess amount of nickel increases the influence of distortion due to the Jahn-Teller effect, which is not preferable. Moreover, an excess amount of nickel may adversely affect insertion and extraction of lithium. Thus, the entire positive electrode active material particle 20 preferably contains an appropriate amount of nickel. Specifically, in the entire positive electrode active material particle 20, the number of nickel atoms is preferably greater than 0% and less than or equal to 7.5%, further preferably greater than or equal to 0.05% and less than or equal to 4%, still further preferably greater than or equal to 0.1% and less than or equal to 2%, yet still further preferably greater than or equal to 0.2% and less than or equal to 1% of the number of cobalt atoms. The amount of nickel in the entire positive electrode active material particle 20 described here may be a value obtained by performing an element analysis entirely on the positive electrode active material particles 20 with GD-MS, ICP-MS, or the like or may be a value based on the ratio of the raw materials mixed in the process of forming the positive electrode active material, for example.

### [Titanium]

When titanium is present in the surface portion 20a as the additive element, an effect of promoting insertion and extraction of lithium ions into and from the positive electrode active material particle 20 can be expected. This phenomenon will be described.

Although titanium is stable in octahedral sites with six coordinated oxygen atoms in an oxide, titanium oxide and lithium titanate cannot have a stable layered rock-salt crystal structure. For example, the rutile crystal structure is the most stable phase for TiO₂, which is a titanium oxide, and Li₄Ti₅O₁₂, which is a lithium titanate, has a spinel crystal structure. Thus, when a slight amount of titanium is present in the surface portion 20a having a layered rock-salt crystal structure or a rock-salt crystal structure, defects are generated in part of the crystal structure in the surface portion 20a. It is known that lithium cobalt oxide has a large band gap and high resistance in a discharged state (the discharged state is also referred to as a state where x in LiₓCoO₂ is 1). Thus, introduction of a defect due to titanium to part of the surface portion 20a can reduce the band gap and reduce the resistance.

In addition, in an oxide, Co³⁺ is the most stable state for cobalt, whereas Ti⁴⁺ is the most stable state for titanium. Thus, in an oxide, charge neutrality with oxygen is maintained by a cobalt ion and a lithium ion in the periphery of cobalt, whereas without a lithium ion, charge neutrality with oxygen is easily maintained in the periphery of titanium. Furthermore, a defect is sometimes induced at a cation site in the vicinity of Ti⁴⁺ and reduces diffusion resistance of cations, especially lithium ions. Thus, the diffusion resistance of lithium ions is reduced in the periphery of titanium. Accordingly, when titanium is present in the surface portion 20a, the diffusion resistance of lithium ions at the interface between the electrolyte solution and the positive electrode active material particle 20 can be reduced.

Too small an amount of titanium fails to sufficiently elicit the above effect, whereas too large an amount of titanium may form a heterophase (e.g., MgTiO₃ with an ilmenite crystal structure) with another additive element such as magnesium. Furthermore, when formation of the heterophase deprives the surface portion 20a of magnesium, the concentration of magnesium in the surface portion 20a is liable to be reduced. In the case where charging with a high voltage exceeding 4.6 V (vs. Li/Li⁺) is performed, the surface portion 20a preferably contains magnesium to inhibit a phase change. Thus, it is a great disadvantage that the formation of a heterophase deprives the surface portion 20a of magnesium. When the number of defects due to titanium increases too much, oxygen is liable to be easily released from the surface. Therefore, it is preferable that titanium be present in the surface portion 20a together with magnesium, fluorine, and the like or titanium be present in the surface of the surface portion 20a and a region close to the surface of the surface portion 20a at a concentration lower than that of magnesium.

Specifically, the number of Ti atoms in the entire positive electrode active material particle 20 is preferably greater than or equal to 0.0001 times and less than or equal to 0.005 times (0.01% to 0.5%), further preferably greater than or equal to 0.0005 times and less than or equal to 0.0025 times (0.05% to 0.25%) the number of Co atoms. The amount of titanium in the entire positive electrode active material particle 20 may be a value obtained by performing an element analysis entirely on the entire positive electrode active material particles 20 using GD-MS, ICP-MS, or the like, or may be a value based on the ratio of the raw materials mixed in the process of forming the positive electrode active material particles 20, for example.

### [Other Additive Elements]

The surface portion 20a preferably contains phosphorus, in which case a short circuit between the positive electrode and the negative electrode can be sometimes inhibited while x in LiₓCoO₂ is kept small. For example, a compound containing phosphorus and oxygen is preferably included in the surface portion 20a.

When the positive electrode active material particle 20 contains phosphorus, phosphorus may react with hydrogen fluoride generated by the decomposition of the electrolyte solution or the electrolyte, which may decrease the hydrogen fluoride concentration in the electrolyte and is preferable. In the case where the electrolyte contains LiPF₆, there is a concern about generation of hydrogen fluoride by a reaction with water. In addition, hydrogen fluoride might be generated by the reaction of poly(vinylidene fluoride) (PVDF) used as a component of the positive electrode and alkali. The decrease in hydrogen fluoride concentration in the electrolyte can inhibit corrosion of a current collector in some cases. Furthermore, the decrease in hydrogen fluoride concentration in the electrolyte can inhibit a reduction in adhesion properties due to gelling and/or insolubilization of PVDF in some cases.

In the case where the positive electrode active material particle 20 has a crack or the like, development of the crack or the like can be suppressed by phosphorus, more specifically, a compound containing phosphorus and oxygen or the like being in the inner portion, e.g., a filling portion, of the positive electrode active material particle having the crack or the like as a surface.

### [Synergistic Effect Between a Plurality of Additive Elements]

When the surface portion 20a contains both magnesium and nickel, it is possible that divalent nickel be more stably in the vicinity of divalent magnesium. Thus, magnesium can be inhibited from being dissolved out even when x in Li CoO₂ is small. This can contribute to stabilization of the surface portion 20a.

For the above reason, magnesium is preferably added to the positive electrode active material particle 20 in a step prior to the step of adding nickel in the manufacturing process. Magnesium has a large ion radius and thus is likely to remain in the surface portion of lithium cobalt oxide regardless of which step magnesium is added in, but nickel can be widely diffused to the inner portion of lithium cobalt oxide when magnesium is absent. Thus, when nickel is added before magnesium is added, there is a concern that nickel is diffused to the inner portion of lithium cobalt oxide and a preferable amount of nickel does not remain in the surface portion.

Furthermore, in the case where the surface portion 20a contains magnesium, nickel, and titanium, the presence of nickel inhibits formation of a heterophase such as MgTiO₃ with the ilmenite crystal structure. The ilmenite crystal structure has hexagonal close-packed anions and is different from a rock-salt crystal structure and a layered rock-salt crystal structure that are cubic close-packed structures; thus, a certain amount of activation energy is needed for the phase transition. NiO (II) is a compound having low chemical activity and thus has an effect of inhibiting formation of MgTiO₃.

For the above reason, when titanium is added to the positive electrode active material particle 20 in a step after the steps of adding magnesium and nickel in the manufacturing process, the effect of nickel inhibiting formation of a heterophase can be strongly elicited.

When a plurality of the additive elements are contained as described above, the effects of the additive elements contribute synergistically to further stabilization of the surface portion 20a. In particular, magnesium, nickel, and aluminum are preferably contained, in which case a high effect of stabilizing the composition and the crystal structure can be obtained.

Note that the surface portion 20a occupied by only a compound of an additive element and oxygen is not preferable because the insertion and extraction of lithium becomes difficult. For example, it is not preferable that the surface portion 20a be occupied by only MgO, and/or a structure in which MgO and CoO (II) form a solid solution. Thus, the surface portion 20a should contain at least a metal element M typified by cobalt, also contain lithium in a discharged state, and have the path for insertion and extraction of lithium.

To ensure the sufficient path through which lithium is inserted and extracted, the concentration of cobalt is preferably higher than that of magnesium in the surface portion 20a. For example, when measurement by XPS is performed on the surface of the positive electrode active material, Mg/Co, which is the ratio of the number of magnesium atoms Mg to the number of cobalt atoms Co is preferably less than or equal to 0.62. In addition, the concentration of cobalt is preferably higher than those of nickel, aluminum, and fluorine in the surface portion 20a.

Moreover, too large an amount of nickel may hinder diffusion of lithium; thus, the concentration of magnesium is preferably higher than that of nickel in the surface portion 20a. For example, when measurement by XPS is performed on the surface of the positive electrode active material, the number of nickel atoms is preferably 1/6 or less of that of magnesium atoms.

It is preferable that some additive elements, in particular, magnesium and nickel have higher concentrations in the surface portion 20a than in the inner portion 20b and is present randomly also in the inner portion 20b at low concentrations. When magnesium and nickel are present at the lithium sites of the inner portion 20b at appropriate concentrations, an effect of facilitating maintenance of the layered rock-salt crystal structure can be obtained in a manner similar to the above. When nickel is present in the inner portion 20b at an appropriate concentration, a shift in the layered structure formed of octahedrons of cobalt and oxygen atoms can be suppressed in a manner similar to the above. Also in the case where both magnesium and nickel are contained, a synergistic effect of suppressing dissolution of magnesium can be expected in a manner similar to the above.

The detected amount of an additive element is a detected amount of characteristic X-ray (simply referred to as the detected amount) that can be determined not to be noise in terms of intensity, spatial resolution, and the like in STEM-EDX line analysis. The state where the amount of an additive element is continuously detected is referred to as a distribution of the additive element. In addition, a local maximum value of the detected amount, that is, a peak of the detected amount, is preferably observed in the distribution. A plurality of the peaks may be observed in the distribution.

In the case where the additive elements are magnesium, fluorine, nickel, and titanium, the peaks of the detected amounts are each preferably positioned in the surface portion 20a. In other words, the peak of the detected amount of each of magnesium, fluorine, nickel, and titanium is preferably in the range from the surface to 20 nm or less. Although the above additive elements each have a plurality of peaks of the detected amount in some cases, each of magnesium, fluorine, nickel, and titanium preferably has a maximum value (maximum peak) of the peak in the surface portion 20a or in the range from the surface to 20 nm or less.

### [Distribution]

FIGS. 10B to 10E show examples of desired distributions of magnesium, aluminum, nickel, and titanium among the additive elements. The distance on the horizontal axis in FIGS. 10B to 10E substantially corresponds to the distance from X1 to X2 of the positive electrode active material particle 20 illustrated in FIG. 10A.

As illustrated in FIGS. 10B to 10E, magnesium is preferably distributed such that the concentration in the surface portion 20a is higher than the concentration in the inner portion 20b. As illustrated in FIGS. 10C and 10E, titanium is preferably distributed such that the concentration in the surface portion 20a is higher than the concentration in the inner portion 20b. The phrase “the concentration in the surface portion 20a is higher than the concentration in the inner portion 20b” is expressed as “the detected amount in the surface portion 20a is larger than the detected amount in the inner portion 20b.”

The state where the start position (also referred to as a rising position) of a magnesium distribution and the rising position of a titanium distribution overlap with each other and the end position (also referred to as a falling position) of the magnesium distribution and the falling position of the titanium distribution overlap with each other as illustrated in FIGS. 10C and 10E is described with an expression “the distributions overlap with each other”. That is, it is preferable that the distribution of magnesium and the distribution of titanium overlap with each other. In addition, the state where the rising position and the falling position of the titanium distribution are located between the rising position and the falling position of the magnesium distribution is described with an expression “the distributions have an overlapping region”. The structure in which the distributions have an overlapping region includes a state where the rising positions of the distributions are misaligned, the falling positions of the distributions are misaligned, and the distributions have an overlapping region.

Moreover, as illustrated in FIGS. 10B to 10E, a peak, typically the maximum peak, of magnesium is preferably located in the surface portion 20a, further preferably in a region that is closer to the surface in the surface portion 20a. For example, a peak of the concentration of magnesium is preferably located in the range from the surface or the reference point to 3 nm or less.

As illustrated in FIGS. 10C and 10E, the peak, typically the maximum peak, of titanium is also preferably located in the surface portion 20a, further preferably in a region that is closer to the surface in the surface portion 20a.

As illustrated in FIGS. 10C and 10E, the peak position of magnesium and the peak position of titanium may overlap with each other. In the case where the peak position of magnesium is different from the peak position of titanium, the difference between the peak positions is preferably less than or equal to 3 nm, further preferably less than or equal to 1 nm. In the case where the full width at half maximum of the distribution with reference to the peak position can be calculated, the full width at half maximum of the titanium distribution is preferably smaller than that of the magnesium distribution.

As illustrated in FIGS. 10D and 10E, the nickel distribution preferably overlaps with the magnesium distribution and the titanium distribution. Alternatively, the nickel distribution preferably has a region overlapping with the magnesium distribution and the titanium distribution. The peak position of nickel is preferably located in the surface portion 20a, further preferably in a region that is closer to the surface in the surface portion 20a. For example, the peak position of the nickel concentration is preferably located in the range from the surface or the reference point to 3 nm or less. In the case where the full width at half maximum of the distribution can be calculated with reference to the peak position, the full width at half maximum of the nickel distribution is preferably smaller than that of the magnesium distribution.

As illustrated in FIG. 10E, the distributions of magnesium, nickel, and titanium are preferably located in the edge region of the surface portion 20a. On the other hand, in the surface portion 20a, the above elements are not necessarily distributed as described above in the basal region.

The detected amount of magnesium in the inner portion 20b is smaller than that in the surface portion 20a as described above; however, magnesium is preferably present in a slight amount in the inner portion 20b. In some cases, the detected amount of titanium in the inner portion 20b is much smaller than that of titanium in the surface portion 20a or lower than or equal to 1 at %, or no titanium is detected in the inner portion 20b. In some cases, the detected amount of nickel in the inner portion 20b is much smaller than that of nickel in the surface portion 20a or lower than or equal to 1 at %, or no nickel is detected in the inner portion 20b.

Although not illustrated in the drawing, as in the case of magnesium, the detected amount of fluorine is preferably larger in the surface portion 20a than in the inner portion 20b. Peaks of the detected amount is preferably located in a region that is closer to the surface in the surface portion 20a. For example, the peak of the detected amount is preferably located in a region ranging from the surface or the reference point to 3 nm or less. Similarly, the detected amounts of silicon, phosphorus, boron, and/or calcium are/is also preferably larger in the surface portion 20a than in the inner portion 20b. Peaks of the detected amounts are preferably located in regions that are closer to the surface in the surface portion 20a. For example, the peaks of the detected amounts are preferably located in a region ranging from the surface or the reference point to 3 nm or less.

The peak position of the detected amount of aluminum is preferably located inward from the distribution of magnesium or titanium as shown in FIGS. 10B to 10E. A peak of the detected amount of at least aluminum among the additive elements is preferably located in a region that is located in an inner portion from the peak of the detected amount of magnesium or titanium. The distribution of magnesium or titanium may include a region overlapping with the distribution of aluminum, but may have almost no region overlapping with the distribution of aluminum. A peak of the detected amount of aluminum may be located in the surface portion 20a or in a region deeper than the surface portion 20a. For example, the peak is preferably located in a region ranging from 5 nm to 30 nm, both inclusive, toward the inner portion from the surface or the reference point.

Aluminum is distributed more inwardly than magnesium or titanium. This is probably because the diffusion rate of aluminum is higher than those of magnesium and the like. On the other hand, the detected amount of aluminum is small in the region that is the closest to the surface. This is presumably because aluminum can stay stably in a region other than a region where magnesium or the like is present at a high concentration or a high intensity.

To be specific, in a region having a layered rock-salt crystal structure belonging to the space group R-3m or a cubic rock-salt crystal structure, the distance between a cation and oxygen in a region where magnesium is present at a high concentration or a high intensity is longer than the distance between a cation and oxygen in LiAlO₂ having a layered rock-salt crystal structure, and aluminum is thus unlikely to stay stably. In the vicinity of cobalt, valence change due to replacement of Li⁺ with Mg²⁺ can be offset by Co²⁺ which is changed from Co₃₊, so that cation balance can be maintained. By contrast, Al is always trivalent and is thus presumed to be unlikely to stay stably in the vicinity of magnesium in a rock-salt or layered rock-salt crystal structure.

The distributions of the additive elements in the basal region may be different from the distributions in FIGS. 10B to 10E. For example, the detected amounts of one or two or more selected from the additive elements in the basal region and the surface portion 20a including the basal region may be smaller than those in the edge region and the surface portion 20a including the edge region. Specifically, the detected amounts of one or two or more of magnesium, nickel, and titanium may be small. Alternatively, in the basal region and the surface portion 20a including the basal region, one or two or more selected from the additive elements may be detected at 1 at % or less, or may not be detected. Specifically, nickel may be detected at 1 at % or less, or may not be detected. Especially in the case of an analysis method, e.g., EDX, in which characteristic X-rays are detected, the energy of cobalt Kβ line is close to that of nickel Kα line and it is thus difficult to detect a slight amount of nickel in a material whose main element is cobalt. Alternatively, the peaks of the detected amounts of one or two or more of the additive elements may be located closer to the surface in the basal region and the surface portion 20a including the basal region than in the edge region and the surface portion 20a including the edge region. Specifically, the peaks of the detected amounts of magnesium and aluminum may be located closer to the surface in the basal region and the surface portion 20a including the basal region than in the edge region and the surface portion 20a including the edge region.

In a layered rock-salt crystal structure belonging to R-3m, cations are arranged parallel to the (001) plane. In other words, a CoO₂ layer and a lithium layer are alternately stacked parallel to the (001) plane. Accordingly, a diffusion path of lithium ions is also formed in parallel to the (001) plane. The CoO₂ layer is relatively stable and thus, the surface of the positive electrode active material particle 20 is more stable when having the (001) orientation. A main diffusion path of lithium ions in charging and discharging is not exposed at the (001) plane.

By contrast, a diffusion path of lithium ions is exposed at a surface having an orientation other than the (001) orientation. Thus, the surface and the surface portion 20a each having an orientation other than the (001) orientation easily lose stability because they are regions where extraction of lithium ions starts as well as important regions for maintaining a diffusion path of lithium ions. Thus, for maintaining the crystal structure of the entire positive electrode active material particle 20, it is very important to reinforce the surface and the surface portion 20a each having an orientation other than the (001) orientation. Thus, in the positive electrode active material particle 20, the distributions of the additive elements in the surface and the surface portion 20a each having an orientation other than the (001) orientation are preferably the distributions illustrated in any of FIGS. 10B to 10E, for example.

In a formation method in which high-purity LiCoO₂ with a low impurity concentration is formed, an additive element is mixed afterwards, and heating is performed, the additive element spreads mainly through a diffusion path of lithium ions. Thus, distribution of the additive element in the surface and the surface portion 20a each having an orientation other than the (001) orientation can easily fall within a preferred range.

Note that it may be unnecessary to contain one selected from magnesium, fluorine, nickel, aluminum, titanium, zirconium, vanadium, iron, manganese, chromium, niobium, arsenic, zinc, silicon, sulfur, phosphorus, and boron.

The positive electrode active material particle 20 that is substantially free from manganese offers advantages such as relatively easy synthesis, easy handling, and excellent cycle performance, for example. For this reason, the weight of manganese contained in the positive electrode active material particle 20 is preferably less than or equal to 600 ppm, further preferably less than or equal to 100 ppm, for example.

### <<Crystal Grain Boundary>>

It is further preferable that the additive elements contained in the positive electrode active material particle 20 have the above-described distributions and at least one of the additive elements be unevenly distributed at the crystal grain boundary and the vicinity thereof. Note that in this specification and the like, uneven distribution means that the concentration of an element in a certain region differs from that in another region. This may be rephrased as segregation, precipitation, unevenness, deviation, or a mixture of a high-concentration portion and a low-concentration portion.

For example, the magnesium concentration at the crystal grain boundary and the vicinity thereof in the positive electrode active material particle 20 is preferably higher than that in the inner portion 20b. In addition, the fluorine concentration at the crystal grain boundary and the vicinity thereof is preferably higher than that in the inner portion 20b. In addition, the nickel concentration at the crystal grain boundary and the vicinity thereof is preferably higher than that in the inner portion 20b. In addition, the aluminum concentration at the crystal grain boundary and the vicinity thereof is preferably higher than that in the inner portion 20b. In addition, the titanium concentration at the crystal grain boundary and the vicinity thereof is preferably higher than that in the inner portion 20b.

The crystal grain boundary is a plane defect, and thus tends to be unstable and suffer a change in the crystal structure like the surface of the particle. Thus, the higher the concentration of the additive element at the crystal grain boundary and the vicinity thereof is, the more effectively the change in the crystal structure can be reduced.

When the magnesium concentration and the fluorine concentration are high at the crystal grain boundary and the vicinity thereof, the magnesium concentration and the fluorine concentration in the vicinity of a surface generated by a crack are increased by later heating or the like, even when the crack is generated along the crystal grain boundary of the positive electrode active material particle 20. Thus, the positive electrode active material including a generated crack can also have an increased corrosion resistance to hydrofluoric acid. In addition, the positive electrode active material including a generated crack can suppress a side reaction between the electrolyte solution and the positive electrode active material.

### <Particle Diameter>

Too large a particle diameter of the positive electrode active material particle 20 causes problems such as difficulty in lithium diffusion and surface roughness of an active material layer in coating to a current collector. By contrast, too small a particle diameter causes problems such as an overreaction with the electrolyte solution.

The particle diameter of the positive electrode active material particle 20 can be measured with a laser diffraction particle size distribution analyzer, for example. The particle diameter of the positive electrode active material measured with a laser diffraction particle size distribution analyzer is preferably greater than or equal to 1 μm and less than or equal to 100 μm, and further preferably, a particle with a particle diameter less than 10 μm and a particle with a particle diameter greater than or equal to 10 μm and less than or equal to 50 μm are mixed.

As in Embodiment 1, a positive electrode is preferably formed using a mixture of particles having different particle diameters or median diameters (D50) to have an increased electrode density, which enables a high energy density of a secondary battery. The positive electrode active material particle 20 with a relatively small particle diameter or median diameter (D50) is expected to enable high charge and discharge rate characteristics. The positive electrode active material particle 20 having a relatively large particle diameter or a median diameter (D50) is expected to enable high charge-discharge cycle performance and maintaining of high discharge capacity.

In the inner portion 20b, the density of defects including dislocation is preferably low. Dislocation in the inner portion 20b can be observed with a TEM, for example. Defects such as dislocation are sometimes not observed in a specific 1-μm-square region of an observation sample in the case where the density of defects including dislocation is sufficiently low. Note that dislocation is a kind of crystal defect and is different from a vacancy defect.

In the positive electrode active material, the crystallite size measured by XRD is preferably large. In other words, the inner portion 20b preferably has high crystallinity. The larger the crystallite size is, the more easily the O3′ type structure is maintained and contraction of the c-axis length is inhibited in the state where x in LiₓCoO₂ is small as described later. It is presumed that the crystallite size measured by XRD is larger when fewer defects including dislocation are observed with a TEM.

The crystallite size can be calculated using ICSD coll. code. 172909 as literature data of lithium cobalt oxide and a diffraction pattern that is obtained with Bruker D8 ADVANCE, for example, under the following conditions: CuKα₁ line is used as an X-ray source, the 20 range is from 15° to 90°, an increment is 0.005, and a detector is LYNXEYE XE-T. Analysis can be conducted using DIFFRAC.TOPAS ver. 6 as crystal structure analysis software, and a value of LVol-IB is preferably used as the crystallite size. Note that in a sample whose preferred orientation is calculated to be less than 0.8, too many particles are oriented in the same direction; thus, this sample is not suitable for calculation of a crystallite size in some cases.

In an XRD measurement for calculation of a crystallite size, a positive electrode that includes a positive electrode active material, a current collector, a binder, a conductive material, and the like may be subjected to XRD, although it is preferable that only the positive electrode active material be subjected to XRD. Note that a plurality of positive electrode active material particles included in the positive electrode are likely to oriented owing to, for example, pressing in a formation process. When many of the positive electrode active material particles are oriented in the above manner, the crystallite size might fail to be calculated accurately; thus, it is preferable that to obtain an XRD pattern, a positive electrode active material layer be taken out from the positive electrode, the binder and the like in the positive electrode active material layer be eliminated to some extent using a solvent or the like, and a sample holder be filled with the resultant positive electrode active material, for example. Alternatively, a powder sample may be attached onto a reflection-free silicon plate to which grease is applied, for example.

### <Crystal Structure>

It is preferable that the crystal structure continuously change from the inner portion 20b toward the surface owing to the above-described distributions of such additive elements. Alternatively, it is preferable that the crystal orientations in the surface portion 20a and in the inner portion 20b be substantially aligned with each other.

For example, a crystal structure preferably changes continuously from the inner portion 20b that has a layered rock-salt crystal structure toward the surface and the surface portion 20a that have a feature of a rock-salt crystal structure or features of both a rock-salt crystal structure and a layered rock-salt crystal structure. Alternatively, the crystal orientation in the surface portion 20a that has the feature of a rock-salt crystal structure or the features of both a rock-salt crystal structure and a layered rock-salt crystal structure and the crystal orientation in the layered rock-salt inner portion 20b are preferably substantially aligned with each other.

Note that in this specification and the like, a layered rock-salt crystal structure, which belongs to the space group R-3m, refers to a crystal structure in which a rock-salt ion arrangement where cations and anions are alternately arranged is included, lithium and cobalt are regularly arranged to form a two-dimensional plane, and thus lithium can diffuse two-dimensionally. Note that a defect such as a cation or anion vacancy may be included. Moreover, in the layered rock-salt crystal structure, strictly, a lattice of the rock-salt crystal structure is distorted and the symmetry of the layered rock-salt crystal structure is inferior to that of the rock-salt crystal structure in some cases.

A rock-salt crystal structure refers to a structure in which a cubic crystal structure such as a space group Fm-3m is included and cations and anions are alternately arranged. Note that a cation or anion vacancy may be included.

It can be judged by electron diffraction, a TEM image, a cross-sectional STEM image, or the like whether both a layered rock-salt crystal structure and a rock-salt crystal structure are included.

There is no distinction among cation sites in a rock-salt crystal structure. Meanwhile, a layered rock-salt crystal structure has two types of cation sites: one type is mostly occupied by lithium, and the other is occupied by cobalt. A stacked-layer structure where two-dimensional planes of cations and two-dimensional planes of anions are alternately arranged is the same in a rock-salt crystal structure and a layered rock-salt crystal structure. Given that the center spot (transmission spot) among bright spots in an electron diffraction pattern corresponding to crystal planes that form the two-dimensional planes is at the origin point 000, the bright spot nearest to the center spot is on the (111) plane in an ideal rock-salt crystal structure, for instance, and on the (003) plane in a layered rock-salt crystal structure, for instance. For example, when electron diffraction patterns of rock-salt MgO and layered rock-salt LiCoO₂ are compared to each other, the distance between the bright spots on the (003) plane of LiCoO₂ is observed at a distance approximately half the distance between the bright spots on the (111) plane of MgO. Thus, when two phases of rock-salt MgO and layered rock-salt LiCoO₂ are included in a region to be analyzed, a plane orientation in which bright spots with high luminance and bright spots with low luminance are alternately arranged is seen in an electron diffraction pattern. A bright spot common between the rock-salt and layered rock-salt crystal structures has high luminance, whereas a bright spot caused only in the layered rock-salt crystal structure has low luminance.

When a layered rock-salt crystal structure is observed from a direction perpendicular to the c-axis in a cross-sectional STEM image and the like, layers observed with high luminance and layers observed with low luminance are alternately observed. Such a feature is not observed in a rock-salt crystal structure because there is no distinction among cation sites therein. When a crystal structure having both a rock-salt crystal structure and a layered rock-salt crystal structure is observed from a given crystal orientation, layers observed with high luminance and layers observed with low luminance are alternately observed in a cross-sectional STEM image and the like, and a metal that has a larger atomic number than lithium is present in part of the layers with low luminance, i.e., the lithium layers.

Anions of a layered rock-salt crystal structure and anions of a rock-salt crystal structure form a cubic close-packed structure (face-centered cubic lattice structure). Anions of an O3′ type crystal structure and a monoclinic O1(15) crystal structure, which are described later, are presumed to form a cubic close-packed structure. Thus, when a layered rock-salt crystal structure and a rock-salt crystal structure are in contact with each other, a crystal plane at which orientations of cubic close-packed structures formed of anions are aligned with each other is formed.

The description can also be made as follows. An anion on the {111} plane of a cubic crystal structure has a triangle lattice. A layered rock-salt crystal structure, which belongs to the space group R-3m and is a rhombohedral structure, is generally represented by a composite hexagonal lattice for easy understanding of the structure, and the (0001) plane of the layered rock-salt crystal structure has a hexagonal lattice. The triangle lattice on the {111} plane of the cubic crystal has atomic arrangement similar to that of the hexagonal lattice on the (0001) plane of the layered rock-salt crystal structure. These lattices being consistent with each other can be expressed as “orientations of the cubic close-packed structures are aligned with each other”.

Note that space groups of the layered rock-salt crystal structure and the O3′ type crystal structure are R-3m, which is different from the space group Fm-3m of a rock-salt crystal structure (the space group of a general rock-salt crystal structure); thus, the Miller indices of the crystal plane satisfying the above conditions in the layered rock-salt crystal structure and the O3′ type crystal structure are different from that in the rock-salt crystal structure. In this specification, in the layered rock-salt crystal structure, the O3′ crystal structure, and the rock-salt crystal structure, a state where the orientations of the cubic close-packed structures formed of anions are aligned with each other may be referred to as a state where crystal orientations are substantially aligned with each other. In addition, a state where three-dimensional structures have similarity, e.g., crystal orientations are substantially aligned with each other, or orientations are crystallographically the same is referred to as topotaxy.

The crystal orientations in two regions being substantially aligned with each other can be judged, for example, from a TEM image, a STEM image, a high-angle annular dark field scanning TEM (HAADF-STEM) image, an annular bright-field scanning transmission electron microscope (ABF-STEM) image, an electron diffraction pattern, or the like. It can be judged also from a fast Fourier transform (FFT) pattern of a TEM image or an FFT pattern of a STEM image or the like. Moreover, XRD, neutron diffraction, and the like can also be used for judging.

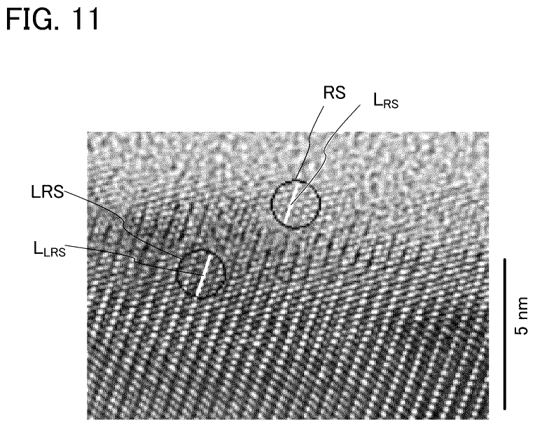

FIG. 11 shows an example of a TEM image in which orientations of a layered rock-salt crystal structure LRS and a rock-salt crystal structure RS are substantially aligned with each other. In a TEM image, a STEM image, a HAADF-STEM image, an ABF-STEM image, or the like, an image reflecting a crystal structure is obtained.

For example, in a high-resolution TEM image, a contrast derived from a crystal plane is obtained. When an electron beam is incident perpendicularly to the c-axis of a composite hexagonal lattice of a layered rock-salt crystal structure, for example, a contrast derived from the (0003) plane is obtained as repetition of bright bands (bright strips) and dark bands (dark strips) because of diffraction and interference of the electron beam. Thus, when repetition of bright lines and dark lines is observed and the angle between the bright lines (e.g., L_{RS} and L_{LRS} in FIG. 11) is 5° or less or 2.5° or less in the TEM image, it can be judged that the crystal planes are substantially aligned with each other, that is, crystal orientations are substantially aligned with each other. Similarly, when the angle between the dark lines is 5° or less or 2.5° or less, it can be judged that crystal orientations are substantially aligned with each other.

In a HAADF-STEM image, a contrast corresponding to the atomic number is obtained, and an element having a larger atomic number is observed to be brighter. For example, in the case of lithium cobalt oxide that has a layered rock-salt crystal structure belonging to the space group R-3m, cobalt (atomic number: 27) has the largest atomic number; hence, an electron beam is strongly scattered at the position of a cobalt atom, and arrangement of the cobalt atoms is observed as bright lines or arrangement of high-luminance dots. Thus, when the lithium cobalt oxide having a layered rock-salt crystal structure is observed in the direction perpendicular to the c-axis, arrangement of the cobalt atoms is observed as bright lines or arrangement of high-luminance dots, and arrangement of lithium atoms and oxygen atoms is observed as dark lines or a low-luminance region in the direction perpendicular to the c-axis. The same applies to the case where fluorine (atomic number: 9) and magnesium (atomic number: 12) are included as the additive elements of the lithium cobalt oxide.

Consequently, in the case where repetition of bright lines and dark lines is observed in two regions having different crystal structures and the angle between the bright lines is 5° or less or 2.5° or less in a HAADF-STEM image, it can be judged that arrangements of the atoms are substantially aligned with each other, that is, crystal orientations are substantially aligned with each other. Similarly, when the angle between the dark lines is 5° or less or 2.5° or less, it can be judged that crystals orientations are substantially aligned with each other.

In an ABF-STEM image, an element having a smaller atomic number is observed to be brighter, but a contrast corresponding to the atomic number is obtained as in a HAADF-STEM image; hence, in an ABF-STEM image, crystal orientations can be judged as in a HAADF-STEM image.

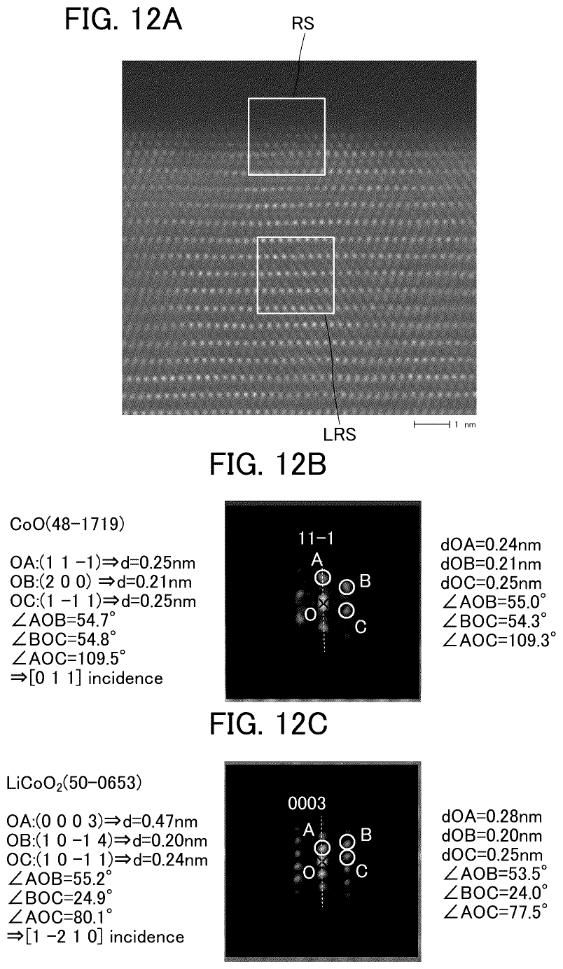

FIG. 12A shows an example of a STEM image in which orientations of the layered rock-salt crystal structure LRS and the rock-salt crystal structure RS are substantially aligned with each other. FIG. 12B shows an FFT pattern of a region of the rock-salt crystal structure RS, and FIG. 12C shows an FFT pattern of a region of the layered rock-salt crystal structure LRS. In FIGS. 12B and 12C, the composition, the JCPDS card number and d values and angles that are calculated from the JCPDS card number are shown on the left. The measured values are shown on the right. A spot denoted by O is zero-order diffraction.

A spot denoted by A in FIG. 12B is derived from 11-1 reflection of a cubic structure. A spot denoted by A in FIG. 12C is derived from 0003 reflection of a layered rock-salt crystal structure.

FIGS. 12B and 12C show that the direction of the 11-1 reflection of the cubic structure and the direction of the 0003 reflection of the layered rock-salt crystal structure are substantially aligned with each other. That is, a straight line that passes through AO in FIG. 12B is substantially parallel to a straight line that passes through AO in FIG. 12C. Here, the terms “substantially aligned” and “substantially parallel” mean that the angle between the two lines is 5° or less or 2.5° or less.

When the orientations of the layered rock-salt crystal and the rock-salt crystal are substantially aligned with each other in the above manner in an FFT pattern and an electron diffraction pattern, the <0003> orientation of the layered rock-salt crystal and the <11-1> orientation of the rock-salt crystal are substantially aligned with each other in some cases. In that case, it is preferable that these reciprocal lattice points be spot-shaped, that is, they not be connected to other reciprocal lattice points. The state where reciprocal lattice points are spot-shaped and not connected to other reciprocal lattice points means high crystallinity.

When the direction of the 11-1 reflection of the cubic structure and the direction of the 0003 reflection of the layered rock-salt crystal structure are substantially aligned with each other as described above, a spot that is not derived from the 0003 reflection of the layered rock-salt crystal structure may be observed, depending on the incident direction of the electron beam, on a reciprocal lattice space different from the direction of the 0003 reflection of the layered rock-salt crystal structure. For example, a spot denoted by B in FIG. 12C is derived from 10-14 reflection of the layered rock-salt crystal structure. This is sometimes observed at a position where the difference in orientation from the reciprocal lattice point derived from the 0003 reflection of the layered rock-salt crystal structure (A in FIG. 12C) is greater than or equal to 52° and less than or equal to 56° (i.e., ∠AOB is greater than or equal to 52° and less than or equal to) 56° and d value is greater than or equal to 0.19 nm and less than or equal to 0.21 nm. Note that these indices are just an example, and the spot does not necessarily correspond with them.

Similarly, a spot that is not derived from the 11-1 reflection of the cubic structure is observed on a reciprocal lattice space different from the direction where the 11-1 reflection of the cubic structure is observed in some cases. For example, a spot denoted by B in FIG. 12B is derived from 200 reflection of the cubic structure. This diffraction spot is sometimes observed at a position where the difference in orientation of reflection derived from the 11-1 reflection of the cubic structure (A in FIG. 12B) is greater than or equal to 54° and less than or equal to 56° (i.e., ∠AOB (angle AOB) is greater than or equal to 54° and less than or equal to) 56°. Note that these indices are just an example, and the spot does not necessarily correspond with them.

It is known that in a layered rock-salt positive electrode active material, such as lithium cobalt oxide, the (0003) plane and a plane equivalent thereto and the (10-14) plane and a plane equivalent thereto are likely to be crystal planes. Thus, to observe the (0003) plane with a TEM or the like, for example, a positive electrode active material particle in which a crystal plane to be presumed the (0003) plane is observed with a SEM or the like is preferably selected first; then, the positive electrode active material particle is preferably processed to be thin using a focused ion beam (FIB) or the like so that the (0003) plane can be observed using an electron beam entering in [12-10] with the TEM or the like. To judge alignment of crystal orientations, a sample is preferably processed to be thin so that the (0003) plane of the layered rock-salt crystal structure can be easily observed.

### <XPS>

In an inorganic oxide, a region ranging from the surface to a depth in the range from approximately 2 nm to 8 nm (normally, 5 nm or less) can be analyzed by XPS analysis using monochromatic aluminum Kα radiation as an X-ray source; thus, the concentrations of elements in a region extending to approximately half the depth of the surface portion 20a can be quantitatively analyzed by XPS. The bonding states of the elements can be analyzed by narrow scanning. The quantitative accuracy of XPS is about ±1 atomic % in many cases. The lower detection limit is approximately ±1 atomic % but depends on the element.

In the positive electrode active material of one embodiment of the present invention, the concentrations of one or more selected from the additive elements are preferably higher in the surface portion 20a than in the inner portion 20b. This means that the concentrations of one or more selected from the additive elements in the surface portion 20a are preferably higher than the average concentration of the selected element(s) in the entire positive electrode active material. For this reason, for example, it is preferable that the concentrations of one or more additive elements selected from the surface portion 20a, which is measured by XPS or the like, be higher than the average concentration of the additive element(s) in the entire positive electrode active material, which is measured by ICP-MS, GD-MS, or the like. For example, the concentration of magnesium of at least part of the surface portion 20a, which is measured by XPS or the like, is preferably higher than the average concentration of magnesium of the entire positive electrode active material. The concentration of nickel of at least part of the surface portion 20a is preferably higher than the average concentration of nickel of the entire positive electrode active material. The concentration of aluminum of at least part of the surface portion 20a is preferably higher than the average concentration of aluminum of the entire positive electrode active material. The concentration of fluorine of at least part of the surface portion 20a is preferably higher than the average concentration of fluorine of the entire positive electrode active material.

At least part of the surface portion 20a measured by XPS preferably includes a bond of magnesium and fluorine, and further preferably has a bond of magnesium, fluorine, and oxygen (an O—Mg—F bond) instead of a bond of magnesium and fluorine (an Mg—F bond). The bond between magnesium and fluorine in the surface portion 20a is an aspect indicating that the fusing effect by fluoride is sufficiently exerted to melt a magnesium source and the surface of lithium cobalt oxide and thereby magnesium is sufficiently segregated.

The excited X-ray used for the XPS measurement can be monochromatic Al and the detection region can be 100 μmo. The extraction angle (an angle between the inclination of the sample stage and the detection direction of the detector) can be 45° or 15°. The detection depth at the extraction angle of 45° is approximately 4 nm to 5 nm, and the detection depth at the extraction angle of 15° is approximately 2 nm. The relative positions of the X-ray source and the sample are changed so as to satisfy the above value of the extraction angle. Typically, the extraction angle is changed by tilting the sample stage with respect to the X-ray source irradiation direction with the X-ray source fixed.

The following explains the O—Mg—F bond indicated in the XPS spectrum of Mg1s, which is a magnesium bonding state. Peak deconvolution is performed on the XPS spectrum, and the peak component derived from an O—Mg—O bond as Fit Peak 1, that from the O—Mg—F bond as Fit Peak 2, that from an F—Mg—F bond as Fit Peak 3, and a cumulative peak of these three peaks are prepared. Peak fitting is performed on the cumulative peak so that the cumulative peak can have the minimum difference from the Mg₁s peak in the XPS spectrum. From the cumulative peak after the fitting, the proportions of Fit Peak 1, Fit Peak 2, and Fit Peak 3 are calculated. Specifically, the areas of Fit Peak 1, Fit Peak 2, and Fit Peak 3 are calculated from the cumulative peak. The analysis results can be output on the assumption that the areas of Fit peak 1, Fit peak 2, and Fit peak 3 are the proportions of the O—Mg—O bond, the O—Mg—F bond, and the F—Mg—F bond. The output of the proportion of the O—Mg—F bond means the presence of the O—Mg—F bond.

An O—Mg—F bond is preferably observed each at the extraction angles of 45° and 15°. In addition, a difference in peak value of the O—Mg—F bond between 45° and 15° indicates that the proportions of the O—Mg—F bonds are different between the XPS detection regions. For example, when the peak value of the O—Mg—F bond at 15° is higher than that at 45°, the O—Mg—F bond is mainly located in a very shallow region ranging from the surface to 2 nm.

The positive electrode active material in this embodiment can withstand high-voltage charging and thus enables a secondary battery with favorable cycle performance.

This embodiment can be implemented in combination with any of the other embodiments.

### Embodiment 4

In this embodiment, an electrolyte solution that is needed to achieve a secondary battery having excellent discharge characteristics even in a low-temperature environment is described.

The low temperature refers to a temperature below freezing. In charge at a low temperature, an energy barrier at the time of extracting lithium ions from a positive electrode active material tends to high. That is, it can be said that overvoltage required for extracting lithium ions from the positive electrode active material becomes higher as the temperature of charging environment becomes lower. That is, the positive electrode active material may be exposed to high voltage (a higher potential than a lithium potential) in charge at a low temperature. In other words, in charge at a low temperature, charge capacity may be decreased when the positive electrode active material is not exposed to high voltage.

Thus, a positive electrode active material that can withstand a high voltage and obtain high charge capacity in charge at a low temperature is preferably used for a positive electrode active material included in a secondary battery having excellent charge characteristics and discharge characteristics even in a low-temperature environment.

For an electrolyte solution included in a secondary battery having excellent charge characteristics and discharge characteristics even in a low-temperature environment, a material having excellent lithium ion conductivity even when charging and/or discharging (charging and discharging) are/is performed in a low-temperature environment is preferably used.

An electrolyte solution which is preferable for a lithium-ion secondary battery having an excellent charge characteristic and an excellent discharge characteristic even in a low-temperature environment will be described in detail below.

### <Electrolyte Solution 1 Suitable for Low-Temperature Environment>

For a mixed organic solvent used for the electrolyte solution, it is possible to use a material having excellent lithium ion conductivity even when charging and/or discharging (charging and discharging) are/is performed in a low-temperature environment (e.g., 0° C., −20° C., preferably −30° C., further preferably −40° C.).

The mixed organic solvent preferably contains two or more selected from a fluorinated cyclic carbonate and a fluorinated linear carbonate.

As the fluorinated cyclic carbonate, fluoroethylene carbonate (FEC or F1EC), difluoroethylene carbonate (DFEC or F2EC), trifluoroethylene carbonate (F3EC), or tetrafluoroethylene carbonate (F4EC) can be used, for example. Note that DFEC has isomers such as a cis-4,5 isomer and a trans-4,5 isomer. Each of these fluorinated cyclic carbonates includes a substituent with an electron-withdrawing property and is thus presumed to allow the solvation energy of a lithium ion to be low.

Structural Formula (H10) below represents FEC. The substituent with an electron-withdrawing property in FEC is an F group.

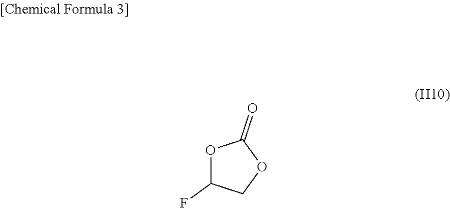

An example of the fluorinated linear carbonate is methyl 3,3,3-trifluoropropionate. Structural Formula (H22) below represents methyl 3,3,3-trifluoropropionate. An abbreviation of methyl 3,3,3-trifluoropropionate is MTFP. The substituent with an electron-withdrawing property in MTFP is a CF₃ group.

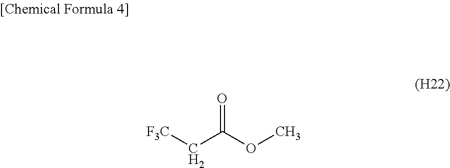

An example of the fluorinated linear carbonate is trifluoromethyl 3,3,3-trifluoropropionate. Structural Formula (H23) below represents trifluoromethyl 3,3,3-trifluoropropionate. The substituent with an electron-withdrawing property is a CF₃ group.

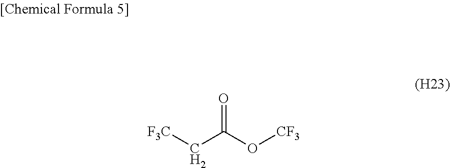 [SMILES: O=C(CC(F)(F)F)OC(F)(F)F]

An example of the fluorinated linear carbonate is trifluoromethyl propionate. Structural Formula (H24) below represents trifluoromethyl propionate. The substituent with an electron-withdrawing property is a CF₃ group.

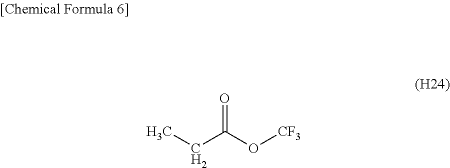

An example of the fluorinated linear carbonate is methyl 2,2-difluoropropionate. Structural Formula (H25) below represents methyl 2,2-difluoropropionate. The substituent with an electron-withdrawing property is a CF₂ group.

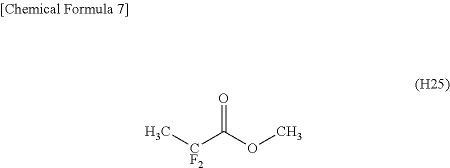

### <FEC and MTFP>

The mixed organic solvent described in this embodiment preferably contains FEC and MTFP. The reason for that is as follows.

FEC, which is one of cyclic carbonates, has a high dielectric constant and thus has an effect of promoting dissociation of a lithium salt when used in an organic solvent. In addition, because FEC includes a substituent with an electron-withdrawing property, a lithium ion is desolvated with FEC more easily than with ethylene carbonate (EC). Specifically, the solvation energy of a lithium ion is lower in FEC than in EC which does not include a substituent with an electron-withdrawing property. Thus, lithium ions are likely to be extracted from surfaces of a positive electrode active material and a negative electrode active material, which can reduce an internal resistance of a secondary battery. In addition, FEC has a deep highest occupied molecular orbital (HOMO) level and is thus not easily oxidized, meaning high oxidation resistance. On the other hand, FEC disadvantageously has high viscosity. In view of this, a mixed organic solvent containing not only FEC but also MTFP is preferably used for the electrolyte solution. MTFP, which is a linear carbonate, can have an effect of reducing the viscosity of an electrolyte solution or maintaining the viscosity at room temperature (typically, 25° C.) even at low temperatures (typically, 0° C.). Furthermore, while the solvation energy is lower in MTFP than in methyl propionate (abbreviation: MP) which does not include a substituent with an electron-withdrawing property, MTFP may solvate a lithium ion when used for the electrolyte solution.

The HOMO levels, the solvation energy, the measured melting points, and the like are collectively shown in the table below.

TABLE 1

| Name of organic | | | | |
|---|---|---|---|---|
| compound (abbreviation) | FEC | MTFP | EC | MP |
| Structural Formula | 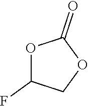 | 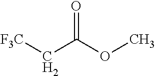 | 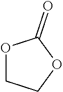 | 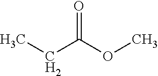 |
| HOMO level [eV] | −8.71 | −8.15 | −8.23 | −7.56 |
| Solvation energy [eV] | 5.39 | 4.33 to 5.38 | 5.79 | 4.45 to 5.22 |
| Measured melting | 17 | Unknown | 38 | −87.5 |
| point [° C.] | | | | |

FEC and MTFP having such physical properties are preferably mixed in the volume ratio of x:100−x (where 5≤x≤30, preferably 10≤x≤20) with the total content of these two organic solvents being 100 vol %. In other words, MTFP and FEC are preferably mixed such that the amount of MTFP is larger than that of FEC in the mixed organic solvent. Note that the above volume ratio may be the volume ratio of the mixed organic solvents measured before mixing the organic solvents, and the mixed organic solvents may be mixed at room temperature (typically 25° C.). The mixed organic solvent in which FEC and MTFP are mixed is preferable because the viscosity that enables a secondary battery to operate is exhibited and appropriate viscosity is maintained even in a low-temperature environment.

A general solvent used for a secondary battery is solidified at approximately −20° C.; thus, it is difficult to fabricate a secondary battery that can be charged and discharged at −30° C., preferably at −40° C. However, the mixed organic solvent described as an example in this embodiment can have a freezing point lower than or equal to −30° C., preferably lower than or equal to −40° C., so that a secondary battery that can be charged and discharged even in a low-temperature environment can be achieved. As a result, a secondary battery capable of being charged and discharged in a wide temperature range including at least a low-temperature environment can be achieved.

Although FEC is described above as a typical example, the following also apply to any of the organic compounds described above as the fluorinated cyclic carbonate: having an effect of promoting dissociation of a lithium salt; having low solvation energy that brings easy disconnection of a bond between a lithium ion and a solvent; and having high viscosity and being difficult to use alone at a temperature below freezing.

Although MTFP is described above as a typical example, any of the organic compounds described as the fluorinated linear carbonate can have an effect of lowering or maintaining the viscosity of the electrolyte solution of one embodiment of the present invention. Therefore, a lithium-ion secondary battery that can be charged and discharged in a low-temperature environment can be provided as long as the mixed organic solvent of one embodiment of the present invention contains a fluorinated cyclic carbonate and a fluorinated linear carbonate.

### <Electrolyte Solution 2 Suitable for Low-Temperature Environment>

As a mixed organic solvent used for an electrolyte solution, ethylene carbonate (EC), ethyl methyl carbonate (EMC), and dimethyl carbonate (DMC) are preferably mixed in the volume ratio of x:y:100-x-y (where 5≤x≤35 and 0<y<65) with the total content of EC, EMC, and DMC being 100 vol %. More specifically, a mixed organic solvent containing EC, EMC, and DMC in the volume ratio of 30:35:35 can be used. Note that the above volume ratio may be the volume ratio of the organic solvents measured before mixing the organic solvents, and the mixed organic solvents may be mixed at room temperature (typically 25° C.).

EC, which is a cyclic carbonate, has a high dielectric constant and thus has an effect of promoting dissociation of a lithium salt. Meanwhile, because EC has high viscosity and has a high freezing point (melting point) of 38° C., it is difficult to use only EC as a solvent in a low-temperature environment. Then, the solvent specifically described in one embodiment of the present invention includes not only EC but also EMC and DMC. EMC is a linear carbonate and has an effect of decreasing the viscosity of the electrolyte solution, and the freezing point of EMC is −54° C. In addition, DMC is also a linear carbonate and has an effect of decreasing the viscosity of the electrolyte solution, the freezing point of DMC is −43° C. An electrolyte solution formed using a mixed organic solvent where EC, EMC, and DMC having such physical properties are mixed in the volume ratio of x:y:100-x-y (where 5≤x≤35 and 0<y<65) with the total content of these three solvents being 100 vol % has a freezing point of −40° C. or lower.

A general electrolyte solution used for a secondary battery can be solidified even at approximately −20° C.; thus, it is difficult to fabricate a secondary battery that can be charged and discharged at −40° C. Since the electrolyte solution described as an example in this embodiment has a freezing point of −40° C. or lower, a secondary battery can be charged and discharged even in an extremely low-temperature environment of −40° C.

As a lithium salt dissolved in the above solvent, any of lithium salts described below can be used. For example, at least one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂)(CF₃SO₂). LiN(C₂F₅SO₂)₂, and lithium bis(oxalate)borate (LiBOB) can be used, or two or more of these lithium salts can be used in an appropriate combination with an appropriate ratio. The molarity of the lithium salt dissolved in the above solvent is preferably more than or equal to 0.5 mol/L and less than or equal to 1.5 mol/L, further preferably more than or equal to 0.7 mol/L and less than or equal to 1.3 mol/L, still further preferably more than or equal to 0.8 mol/L and less than or equal to 1.2 mol/L with respect to the volume of the above solvent. In a specific usage example, the molarity of LiPF₆ is preferably more than or equal to 0.5 mol/L and less than or equal to 1.5 mol/L, further preferably more than or equal to 0.7 mol/L and less than or equal to 1.3 mol/L, still further preferably more than or equal to 0.8 mol/L and less than or equal to 1.2 mol/L with respect to the volume of the above solvent.

The mixed organic solvent is preferably highly purified and contains a small amount of dust particles and elements other than the constituent elements of the electrolyte solution (hereinafter also simply referred to as impurities). Specifically, the weight ratio of impurities to the electrolyte solution is preferably less than or equal to 1%, further preferably less than or equal to 0.1%, still further preferably less than or equal to 0.01%.

In order to form a coating film (solid electrolyte interphase film) at the interface between the electrode (active material layer) and the electrolyte solution for the purpose of improvement of the safety or the like, an additive agent such as vinylene carbonate (VC), propane sultone (PS), tert-butylbenzene (TBB), fluoroethylene carbonate (FEC), lithium bis(oxalate)borate (LiBOB), or a dinitrile compound such as succinonitrile or adiponitrile may be added to the electrolyte solution. The concentration of such an additive agent in the solvent is preferably, for example, higher than or equal to 0.1 wt % and lower than or equal to 5 wt %.

In the example of Electrolyte solution 2, the material described in the example of Electrolyte solution 1 can be used for the lithium salt. Also for the additive agent, the material described in the example of Electrolyte solution 1 can be used.

Although an example of an electrolyte solution that can be used for the secondary battery of one embodiment of the present invention is described above, the electrolyte solution that can be used for the secondary battery of one embodiment of the present invention should not be construed as being limited to the example. It is possible to use any other materials having high lithium ion conductivity even when a lithium ion battery is charged and discharged in a low-temperature environment.

The contents in this embodiment can be combined with any of the contents in the other embodiments as appropriate.

### Embodiment 5

In this embodiment, examples of forms of secondary batteries will be described.

### [Coin-Type Secondary Battery]

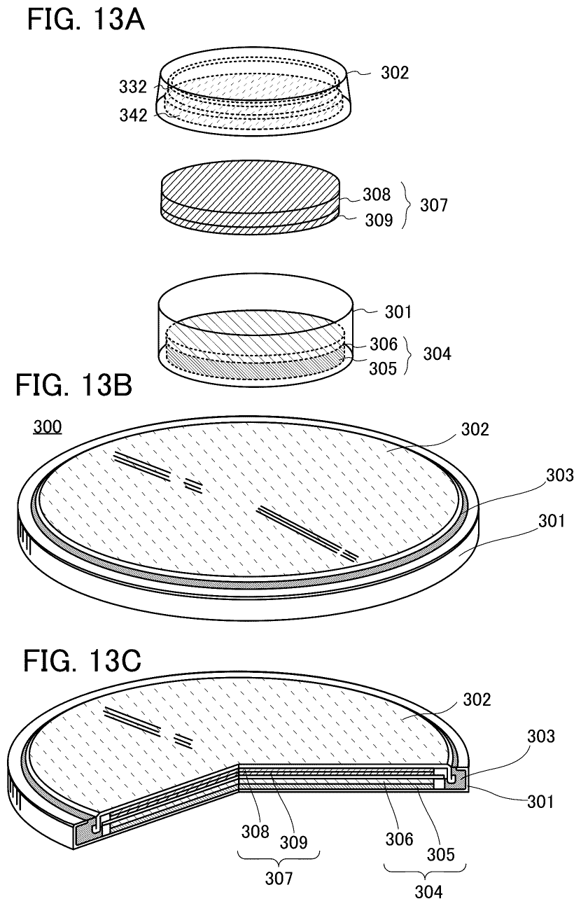

An example of a coin-type secondary battery is described. FIGS. 13A, 13B, and 13C are an exploded perspective view, an external view, and a cross-sectional view of a coin-type (single-layer flat type) secondary battery, respectively. Coin-type secondary batteries are mainly used in small electronic devices. In this specification and the like, examples of the coin-type secondary batteries include a button-type secondary battery.

FIG. 13A is a schematic view showing overlap (a vertical relation and a positional relation) between components. Thus, FIG. 13A and FIG. 13B do not completely correspond with each other.

FIG. 13A illustrates a state where a positive electrode 304, a negative electrode 307, a spacer 342, and a washer 332 are stacked and are sealed with a negative electrode can 302 and a positive electrode can 301. Note that FIG. 13A does not illustrate the electrolyte and the separator described in the above embodiments. The spacer 342 and the washer 332 are used to protect the inside or fix the position of the components inside the cans at the time when the positive electrode can 301 and the negative electrode can 302 are bonded with pressure. For the spacer 342 and the washer 332, stainless steel or an insulating material is used.

The positive electrode 304 is a stack in which a positive electrode active material layer 306 is formed over a positive electrode current collector 305.

FIG. 13B is a perspective view of a completed coin-type secondary battery 300.

In the coin-type secondary battery 300, the positive electrode can 301 doubling as a positive electrode terminal and the negative electrode can 302 doubling as a negative electrode terminal may be insulated from each other and sealed by a gasket 303 made of polypropylene or the like. The positive electrode 304 includes the positive electrode current collector 305 and the positive electrode active material layer 306 provided in contact with the positive electrode current collector 305. The negative electrode 307 includes a negative electrode current collector 308 and a negative electrode active material layer 309 provided in contact with the negative electrode current collector 308. The positive electrode can 301 and the negative electrode can 302 are electrically connected to the positive electrode 304 and the negative electrode 307, respectively.

Moreover, only one surface of the current collector of each of the positive electrode 304 and the negative electrode 307 used for the coin-type secondary battery 300 is provided with an active material layer.

The coin-type secondary battery 300 is manufactured in the following manner: the positive electrode 304, the negative electrode 307, and the negative electrode can 302 are stacked in this order with the positive electrode can 301 at the bottom as illustrated in FIG. 13C; the positive electrode can 301 and the negative electrode can 302 are bonded with pressure with the gasket 303 therebetween.

When the secondary battery of the present invention is used as the coin-type secondary battery 300, the coin-type secondary battery 300 can have high reliability. Furthermore, when the secondary battery of the present invention is used as the coin-type secondary battery 300, the coin-type secondary battery 300 can have favorable low-temperature characteristics.

### [Cylindrical Secondary Battery]

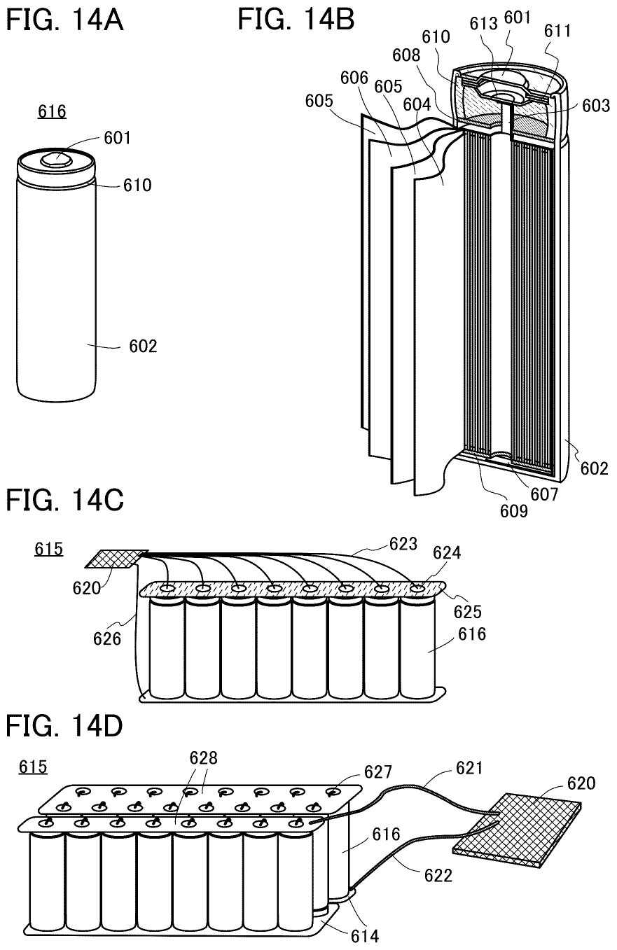

An example of a cylindrical secondary battery is described with reference to FIG. 14A. As illustrated in FIG. 14A, a cylindrical secondary battery 616 includes a positive electrode cap (battery cap) 601 on the top surface and a battery can (outer can) 602 on the side surface and bottom surface. The positive electrode cap 601 and the battery can (outer can) 602 are insulated from each other by a gasket (insulating gasket) 610.

FIG. 14B schematically illustrates a cross section of the cylindrical secondary battery. The cylindrical secondary battery illustrated in FIG. 14B includes the positive electrode cap (battery cap) 601 on the top surface and the battery can (outer can) 602 on the side and bottom surfaces. The positive electrode cap 601 and the battery can (outer can) 602 are insulated from each other by the gasket (insulating gasket) 610.

Inside the battery can 602 having a hollow cylindrical shape, a battery element in which a strip-like positive electrode 604 and a strip-like negative electrode 606 are wound with a strip-like electrolyte layer 605 located therebetween is provided. Although not illustrated, the battery element is wound around the central axis. One end of the battery can 602 is closed and the other end thereof is open. Inside the battery can 602, the battery element in which the positive electrode, the negative electrode, and the separator are wound is provided between a pair of insulating plates 608 and 609 that face each other. The inside of the battery can 602 provided with the battery element is filled with an electrolyte of one embodiment of the present invention (not illustrated).

Since the positive electrode and the negative electrode of the cylindrical storage battery are wound, active materials are preferably formed on both sides of the current collectors. FIGS. 14A to 14D each illustrate the secondary battery 616 in which the height of the cylinder is larger than the diameter of the cylinder as a non-limiting example. The diameter of the cylinder may be larger than the height of the cylinder In a secondary battery. Such a structure can reduce the size of a secondary battery, for example.

A positive electrode terminal (positive electrode current collecting lead) 603 is electrically connected to the positive electrode 604, and a negative electrode terminal (negative electrode current collecting lead) 607 is electrically connected to the negative electrode 606. The positive electrode terminal 603 can be formed using a metal material such as aluminum. The negative electrode terminal 607 can be formed using a metal material such as copper. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a positive temperature coefficient (PTC) element 611. The safety valve mechanism 613 cuts off electrical connection between the positive electrode cap 601 and the positive electrode 604 when the internal pressure of the battery exceeds a predetermined threshold. The PTC element 611, which is a thermally sensitive resistor whose resistance increases as temperature rises, limits the amount of current by increasing the resistance, in order to prevent abnormal heat generation. Barium titanate (BaTiO₃)-based ceramic material or the like can be used for the PTC element.

FIG. 14C illustrates an example of a power storage system 615. The power storage system 615 includes a plurality of secondary batteries 616 and is also referred to as a battery pack in some cases. The positive electrodes of the secondary batteries are in contact with and electrically connected to conductors 624 isolated by an insulator 625. The conductor 624 is electrically connected to a control circuit 620 through a wiring 623. The negative electrodes of the secondary batteries are electrically connected to the control circuit 620 through a wiring 626. As the control circuit 620, a protection circuit for preventing overcharge or overdischarge can be used, for example.

FIG. 14D illustrates an example of the power storage system 615. The power storage system 615 includes the plurality of secondary batteries 616, and the plurality of secondary batteries 616 are provided between a conductive plate 628 and a conductive plate 614. The plurality of secondary batteries 616 are electrically connected to the conductive plate 628 and the conductive plate 614 through a wiring 627. The plurality of secondary batteries 616 may be connected in parallel, connected in series, or connected in series after being connected in parallel. With the power storage system 615 including the plurality of secondary batteries 616, large electric power can be extracted.

The plurality of secondary batteries 616 may be connected in series after being connected in parallel.

A temperature control device may be provided between the plurality of secondary batteries 616. The secondary batteries 616 can be cooled with the temperature control device when overheated, whereas the secondary batteries 616 can be heated with the temperature control device when cooled too much. Thus, the performance of the power storage system 615 is less likely to be influenced by the outside temperature.

In FIG. 14D, the power storage system 615 is electrically connected to the control circuit 620 through a wiring 621 and a wiring 622. The wiring 621 is electrically connected to the positive electrodes of the plurality of secondary batteries 616 through the conductive plate 628. The wiring 622 is electrically connected to the negative electrodes of the plurality of secondary batteries 616 through the conductive plate 614.

When the secondary battery of the present invention is used as the cylindrical secondary battery 616, the cylindrical secondary battery 616 can have high reliability. Furthermore, when the secondary battery of the present invention is used as the cylindrical secondary battery 616, the cylindrical secondary battery 616 can have favorable low-temperature characteristics.

### Other Structure Examples of Secondary Battery

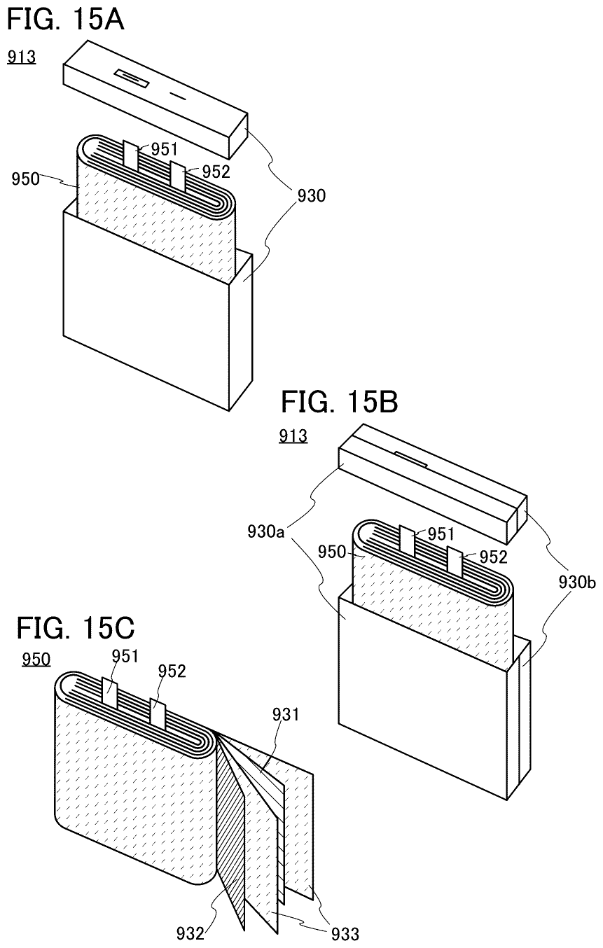

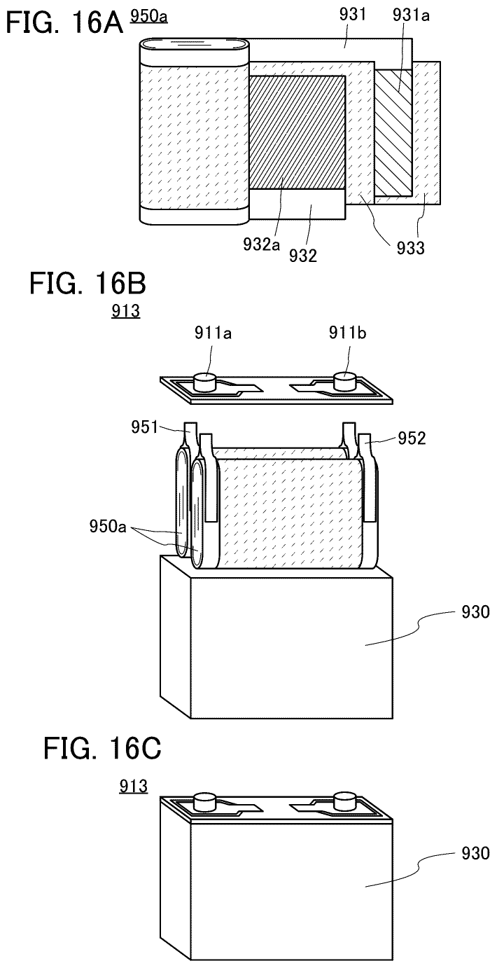

Structure examples of secondary batteries are described with reference to FIGS. 15A to 15C and FIGS. 16A to 16C.

A secondary battery 913 illustrated in FIG. 15A includes a wound body 950 provided with a terminal 951 and a terminal 952 inside a housing 930. The wound body 950 is immersed in the electrolyte of one embodiment of the present invention inside the housing 930. The terminal 952 is in contact with the housing 930. The use of an insulator or the like prevents contact between the terminal 951 and the housing 930. Note that in FIG. 15A, the housing 930 divided into two pieces is illustrated for convenience; however, in the actual structure, the wound body 950 is covered with the housing 930, and the terminal 951 and the terminal 952 extend to the outside of the housing 930. For the housing 930, a metal material (e.g., aluminum) or a stack of a metal material and a resin material can be used.

Note that as illustrated in FIG. 15B, the housing 930 in FIG. 15A may be formed using a plurality of materials. For example, in the secondary battery 913 in FIG. 15B, a housing 930a and a housing 930b are attached to each other, and the wound body 950 is provided in a region surrounded by the housing 930a and the housing 930b.

For the housing 930a, a stack of a metal material and a resin material can be used, for example. In particular, when an organic resin, which is a resin material, is formed for the side on which an antenna is formed, an electric field by the secondary battery 913 can be reduced. When an electric field is not significantly blocked by the housing 930a, an antenna may be provided inside the housing 930a. For the housing 930b, a metal material or a stack of a metal material and a resin material can be used, for example.

FIG. 15C illustrates the structure of the wound body 950. The wound body 950 includes a negative electrode 931, a positive electrode 932, and an electrolyte layer 933. The wound body 950 is obtained by winding a sheet of a stack in which the negative electrode 931 and the positive electrode 932 overlap with the electrolyte layer 933 therebetween. Note that a plurality of stacks each including the negative electrode 931, the positive electrode 932, and the electrolyte layer 933 may be overlaid.

As illustrated in FIGS. 16A to 16C, the secondary battery 913 may include a wound body 950a. The wound body 950a illustrated in FIG. 16A includes the negative electrode 931, the positive electrode 932, and the electrolyte layers 933. The negative electrode 931 includes a negative electrode active material layer 931a. The positive electrode 932 includes a positive electrode active material layer 932a.

The electrolyte layer 933 has a larger width than the negative electrode active material layer 931a and the positive electrode active material layer 932a, and is wound to overlap the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high degree of safety and high productivity.

As illustrated in FIG. 16B, the negative electrode 931 is electrically connected to the terminal 951. The terminal 951 is electrically connected to a terminal 911a. The positive electrode 932 is electrically connected to the terminal 952. The terminal 952 is electrically connected to a terminal 911b.

As illustrated in FIG. 16C, the wound body 950a is covered with the housing 930, whereby the secondary battery 913 is completed. The housing 930 is preferably provided with a safety valve, an overcurrent protection element, and the like. A safety valve is a valve to be released when the internal pressure of the housing 930 reaches a predetermined pressure, and thereby the secondary battery can be prevented from bursting.

As illustrated in FIG. 16B, the secondary battery 913 may include a plurality of wound bodies 950a. The use of the plurality of wound bodies 950a enables the secondary battery 913 to have higher charge and discharge capacity. The description of the secondary battery 913 in FIGS. 15A to 15C can be referred to for the other components of the secondary battery 913 in FIGS. 16A and 16B.

When the secondary battery of the present invention is used as the secondary battery 913 including a wound body, the secondary battery 913 can have high reliability. Furthermore, when the secondary battery of the present invention is used as the secondary battery 913 including a wound body, the secondary battery 913 can have favorable low-temperature characteristics.

The contents in this embodiment can be combined with any of the contents in the other embodiments as appropriate.

### Embodiment 6

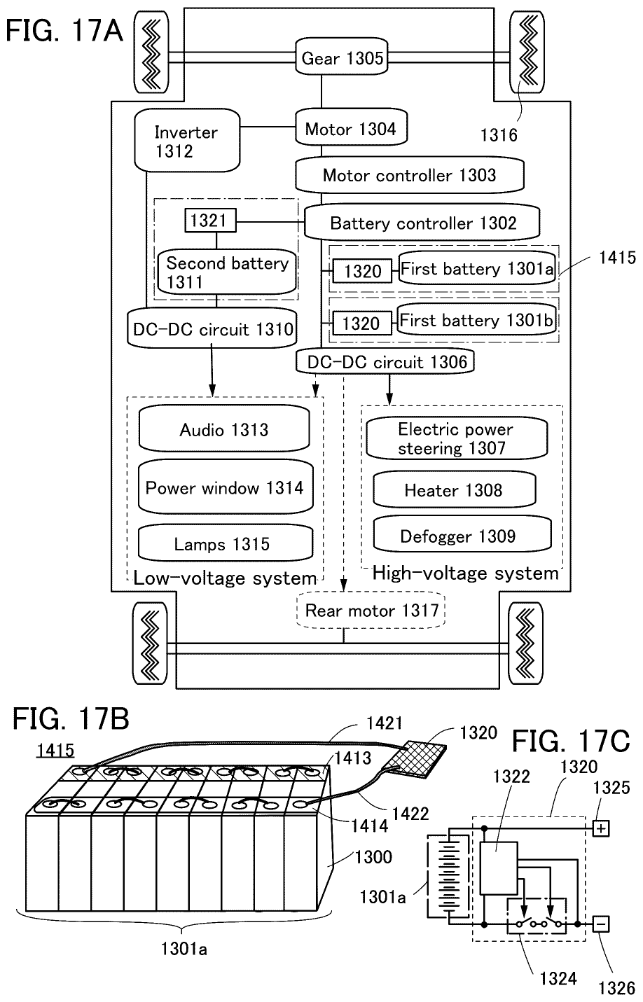

In this embodiment, an example of application to an electric vehicle (EV) will be described with reference to FIGS. 17A to 17C.

As illustrated in FIG. 17A, an electric vehicle is provided with first batteries 1301a and 1301b as main secondary batteries for driving and a second battery 1311 that supplies electric power to an inverter 1312 for starting a motor 1304. When the secondary battery of the present invention is used as the first batteries 1301a and 1301b, the first batteries 1301a and 1301b can have high reliability. Furthermore, when the secondary battery of the present invention is used as the above-described first batteries 1301a and 1301b, the first batteries 1301a and 1301b can have favorable low-temperature characteristics.

The second battery 1311 is also referred to as a cranking battery (also referred to as a starter battery). The second battery 1311 specifically needs high output and does not necessarily have high capacity, and the capacity of the second battery 1311 is lower than those of the first batteries 1301a and 1301b.

The internal structure of the first battery 1301a may be a wound structure or a stacked-layer structure. Alternatively, the first battery 1301a may be an all-solid-state battery. Using the all-solid-state battery as the first battery 1301a achieves high capacity, a high degree of safety, and reduction in size and weight.

Although this embodiment shows an example where the two first batteries 1301a and 1301b are connected in parallel, three or more batteries may be connected in parallel. In the case where the first battery 1301a can store sufficient electric power, the first battery 1301b may be omitted. By constituting a battery pack including a plurality of secondary batteries, large electric power can be extracted. The plurality of secondary batteries may be connected in parallel, connected in series, or connected in series after being connected in parallel. A plurality of secondary batteries can be collectively referred to as an assembled battery.

An in-vehicle secondary battery includes a service plug or a circuit breaker that can cut off high voltage without the use of equipment in order to cut off electric power from a plurality of secondary batteries. The first battery 1301a is provided with such a service plug or a circuit breaker.

Electric power from the first batteries 1301a and 1301b is mainly used to rotate the motor 1304 and is also supplied to in-vehicle parts for 42 V (such as an electric power steering 1307, a heater 1308, and a defogger 1309) through a DC-DC circuit 1306. In the case where a rear motor 1317 is provided for the rear wheels, the first battery 1301a is used to rotate the rear motor 1317.

The second battery 1311 supplies electric power to in-vehicle parts for 14 V (such as an audio 1313, power windows 1314, and lamps 1315) through a DC-DC circuit 1310.

The first battery 1301a is described with reference to FIG. 17B.

FIG. 17B illustrates an example in which nine rectangular secondary batteries 1300 form one battery pack 1415. The nine rectangular secondary batteries 1300 are connected in series; one electrode of each battery is fixed by a fixing portion 1413 made of an insulator, and the other electrode of each battery is fixed by a fixing portion 1414 made of an insulator. Although this embodiment shows an example in which the secondary batteries are fixed by the fixing portions 1413 and 1414, they may be stored in a battery container box (also referred to as a housing). Since a vibration or a jolt is assumed to be given to the vehicle from the outside (e.g., a road surface), the plurality of secondary batteries are preferably fixed by the fixing portions 1413 and 1414, a battery container box, or the like. Furthermore, the one electrode of each battery is electrically connected to a control circuit portion 1320 through a wiring 1421. The other electrode of each battery is electrically connected to the control circuit portion 1320 through a wiring 1422.

The control circuit portion 1320 may include a memory circuit including a transistor using an oxide semiconductor. A charge control circuit or a battery control system that includes a memory circuit including a transistor using an oxide semiconductor may be referred to as a battery operating system or a battery oxide semiconductor (BTOS).

A metal oxide functioning as an oxide semiconductor is preferably used. For example, as the oxide, a metal oxide such as an In—M—Zn oxide (the element M is one or more of aluminum, gallium, yttrium, copper, vanadium, beryllium, boron, titanium, iron, nickel, germanium, zirconium, molybdenum, lanthanum, cerium, neodymium, hafnium, tantalum, tungsten, magnesium, and the like) is used. In particular, the In—M—Zn oxide that can be used as the oxide is preferably a c-axis aligned crystal oxide semiconductor (CAAC-OS) or a cloud-aligned composite oxide semiconductor (CAC-OS). Alternatively, an In—Ga oxide or an In—Zn oxide may be used as the oxide. The CAAC-OS is an oxide semiconductor that has a plurality of crystal regions each of which has c-axis alignment in a particular direction. Note that the particular direction refers to the thickness direction of a CAAC-OS film, the normal direction of the surface where the CAAC-OS film is formed, or the normal direction of the surface of the CAAC-OS film. The crystal region refers to a region having a periodic atomic arrangement. When an atomic arrangement is regarded as a lattice arrangement, the crystal region also refers to a region with a uniform lattice arrangement. The CAAC-OS has a region where a plurality of crystal regions are connected in the a-b plane direction, and the region has distortion in some cases. Note that distortion refers to a portion where the direction of a lattice arrangement changes between a region with a uniform lattice arrangement and another region with a uniform lattice arrangement in a region where a plurality of crystal regions are connected. That is, the CAAC-OS is an oxide semiconductor having c-axis alignment and having no clear alignment in the a-b plane direction.

The control circuit portion 1320 preferably uses a transistor using an oxide semiconductor because the transistor using an oxide semiconductor can be used in a low-temperature environment. For the process simplicity, the control circuit portion 1320 may be formed using transistors of the same conductivity type. A transistor using an oxide semiconductor in its semiconductor layer has an operating ambient temperature range of −40° C. to 150° C., both inclusive, which is wider than that of a single crystal Si transistor, and thus shows a smaller change in characteristics than the single crystal Si transistor when the secondary battery is heated. The off-state current of the transistor using an oxide semiconductor is extremely low even at 150° C. independently of the temperature; meanwhile, the off-state current of the single crystal Si transistor largely depends on the temperature. For example, the off-state current of the single crystal Si transistor increases at 150° C., and a sufficiently high current on/off ratio cannot be obtained. The control circuit portion 1320 can improve the degree of safety.

The control circuit portion 1320 that includes a memory circuit including a transistor using an oxide semiconductor can also function as an automatic control device for the secondary battery to eliminate ten causes of instability, such as a micro short circuit. Examples of functions of eliminating the ten causes of instability include prevention of overcharge, prevention of overcurrent, control of overheating during charge, maintenance of cell balance of an assembled battery, prevention of overdischarge, a battery indicator, automatic control of charging voltage and current amount according to temperature, control of the amount of charge current according to the degree of deterioration, detection of abnormal behavior due to a micro short circuit, and anomaly prediction regarding a micro short circuit; the control circuit portion 1320 has at least one of these functions. Furthermore, the automatic control device for the secondary battery can be highly downsized.

A micro short circuit is one of internal short circuits and refers to a minute short circuit inside a secondary battery. One of the supposed causes of a micro short circuit is as follows. Uneven distribution of a positive electrode active material due to charging and discharging performed multiple times causes local current concentration at part of the positive electrode and part of the negative electrode. Another supposed cause is generation of a by-product due to a side reaction.

The control circuit portion 1320 can not only detect a micro short circuit but also detect a terminal voltage of the secondary battery and control the charging and discharging state of the secondary battery. For example, to prevent overcharge, the control circuit portion 1320 can turn off both an output transistor of a charge circuit and an interruption switch substantially at the same time. FIG. 17C illustrates an example of a block diagram of the battery pack 1415 illustrated in FIG. 17B.

The control circuit portion 1320 includes a switch portion 1324 that includes at least a switch for preventing overcharging and a switch for preventing overdischarging, a control circuit 1322 for controlling the switch portion 1324, and a portion for measuring the voltage of the first battery 1301a. The control circuit portion 1320 is set to have the upper limit voltage and the lower limit voltage of the secondary battery used, and imposes the upper limit of current from the outside, the upper limit of output current to the outside, and the like. The range from the lower limit voltage to the upper limit voltage of the secondary battery falls within a recommended voltage range for use. When a voltage falls outside the range, the switch portion 1324 operates and functions as a protection circuit. The control circuit portion 1320 can also be referred to as a protection circuit because it controls the switch portion 1324 to prevent overdischarging and overcharging. For example, when the control circuit 1322 detects a voltage that is likely to cause overcharging, current is interrupted by turning off the switch in the switch portion 1324. Furthermore, a function of interrupting current in accordance with a temperature rise may be set by providing a PTC element in the charge and discharge path. The control circuit portion 1320 includes an external terminal 1325 (+IN) and an external terminal 1326 (−IN).

The switch portion 1324 can be formed with a combination of an n-channel transistor and a p-channel transistor. The switch portion 1324 is not limited to including a switch having a Si transistor using single crystal silicon; the switch portion 1324 may be formed using a power transistor containing germanium (Ge), silicon germanium (SiGe), gallium arsenide (GaAs), gallium aluminum arsenide (GaAlAs), indium phosphide (InP), silicon carbide (SiC), zinc selenide (ZnSe), gallium nitride (GaN), gallium oxide (GaOₓ, where x is a real number greater than 0), or the like. A memory element using an OS transistor can be freely placed by being stacked over a circuit using a Si transistor, for example; hence, integration can be easy. The control circuit portion 1320 using an OS transistor can be stacked and integrated over the switch portion 1324 so as to form one chip, which enables reduction in size.

The first batteries 1301a and 1301b mainly supply electric power to in-vehicle parts for 42 V (for a high-voltage system), and the second battery 1311 supplies electric power to in-vehicle parts for 14 V (for a low-voltage system). A lead battery is usually used for the second battery 1311 due to cost advantage. There is an advantage that the second battery 1311 can be maintenance-free when a secondary battery is used; however, in the case of long-term use, for example, the use over three years or more, anomaly that cannot be found at the time of manufacturing may occur. In particular, when the second battery 1311 that starts the inverter becomes inoperative, the motor cannot be started even when the first batteries 1301a and 1301b have remaining capacity. In the case where the second battery 1311 is a lead storage battery, the second battery is supplied with electric power from the first battery to constantly maintain a fully-charged state. Thus, the phenomenon in which the motor cannot be started as described above does not occur.

Although this embodiment describes an example in which secondary batteries are used as both the first battery 1301a and the second battery 1311, a lead storage battery, an all-solid-state battery, or an electric double layer capacitor may be used as the second battery 1311. When the secondary battery of the present invention is used as the above-described secondary batteries, the secondary batteries can have high reliability. Furthermore, when the secondary battery of the present invention is used as the above-described secondary batteries, the secondary batteries can have favorable low-temperature characteristics.

Regenerative energy generated by rolling of tires 1316 is transmitted to the motor 1304 through a gear 1305, and is stored in the second battery 1311 through a motor controller 1303, a battery controller 1302, and a control circuit portion 1321. Alternatively, the regenerative energy is stored in the first battery 1301a from the battery controller 1302 through the control circuit portion 1320. Alternatively, the regenerative energy is stored in the first battery 1301b from the battery controller 1302 through the control circuit portion 1320. For efficient charging with regenerative energy, the first batteries 1301a and 1301b are preferably capable of fast charging.

The battery controller 1302 can set the charge voltage, charge current, and the like of the first batteries 1301a and 1301b. The battery controller 1302 can set charge conditions in accordance with charge characteristics of a secondary battery used, so that fast charging can be performed.

Although not illustrated, in the case of connection to an external charger, a plug of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used; to prevent overcharging, the first batteries 1301a and 1301b are preferably charged through the control circuit portion 1320. In addition, a connection cable or the connection cable of the charger is sometimes provided with a control circuit. The control circuit portion 1320 is also referred to as an electronic control unit (ECU). The ECU is connected to a controller area network (CAN) provided in the electric motor vehicle. The CAN is a type of a serial communication standard used as an in-vehicle LAN. The ECU includes a microcomputer. Moreover, the ECU uses a CPU or a GPU.

External chargers installed at charging stations and the like have a 100 V outlet, a 200 V outlet, or a three-phase 200V outlet (50 KW), for example. Furthermore, charging can be performed by electric power supplied from external charge equipment with a contactless power feeding method or the like.

Next, examples in which the secondary battery of one embodiment of the present invention is mounted on a vehicle, typically a transport vehicle, will be described.

The use of secondary batteries in vehicles enables production of next-generation clean energy vehicles such as hybrid vehicles (HV), electric vehicles (EV), and plug-in hybrid vehicles (PHV). The secondary battery can also be mounted in transport vehicles such as agricultural machines, motorized bicycles including motor-assisted bicycles, motorcycles, electric wheelchairs, electric carts, boats and ships, submarines, aircraft such as fixed-wing aircraft and rotary-wing aircraft, rockets, artificial satellites, space probes, planetary probes, and spacecraft.

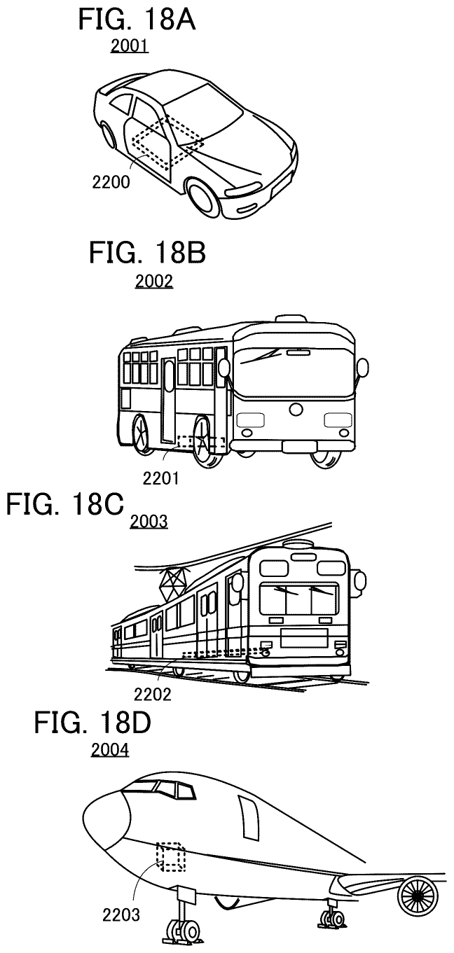

FIGS. 18A to 18D illustrate examples of transport vehicles using one embodiment of the present invention. An automobile 2001 illustrated in FIG. 18A is an electric vehicle that runs on the power of an electric motor. Alternatively, the automobile 2001 is a hybrid vehicle capable of driving using either an electric motor or an engine as appropriate. In the case where the secondary battery is mounted in the vehicle, the secondary battery described as examples in the above embodiments is provided at one position or several positions. When the secondary battery of the present invention is used as the secondary battery mounted in the vehicle, the secondary battery mounted in the vehicle can have high reliability. Furthermore, when the secondary battery of the present invention is used as the above-described secondary battery, the above-described secondary battery can have favorable low-temperature characteristics.

The automobile 2001 illustrated in FIG. 18A includes a battery pack 2200, and the battery pack includes a battery module in which a plurality of secondary batteries are connected to each other. The battery pack 2200 preferably further includes a charge control device that is electrically connected to the battery module.

The automobile 2001 can be charged when the secondary battery included in the automobile 2001 is supplied with electric power through external charging equipment with a plug-in system, a contactless power feeding system, or the like. In charging, a given method such as CHAdeMO (registered trademark) or Combined Charging System can be employed as a charge method, the standard of a connector, or the like as appropriate. A charge equipment may be a charging station provided in a commerce facility or a power source in a house. For example, with the use of the plug-in technique, the power storage device mounted in the automobile 2001 can be charged by being supplied with electric power from outside. The charge can be performed by converting AC electric power into DC electric power through a converter such as an AC-DC converter.

Although not illustrated, the vehicle may include a power receiving device so that it can be charged by being supplied with electric power from an above-ground power transmitting device in a contactless manner. In the case of the contactless power feeding system, by fitting a power transmitting device in a road or an exterior wall, charging can be performed not only when the electric vehicle is stopped but also when driven. In addition, the contactless power feeding system may be utilized to perform transmission and reception of electric power between two vehicles. Furthermore, a solar cell may be provided in the exterior of the vehicle to charge the secondary battery when the vehicle is stopped and/or driven. To supply electric power in such a contactless manner, an electromagnetic induction method or a magnetic resonance method can be used.

FIG. 18B illustrates a large transporter 2002 having a motor controlled by electricity as an example of a transport vehicle. A battery module of the transporter 2002 includes, for example, a cell unit of four secondary batteries with a nominal voltage of 3.0 V or higher and 5.0 V or lower, and 48 cells are connected in series to have a maximum voltage of 170 V. A battery pack 2201 has the same function as that in FIG. 17B except, for example, the number of secondary batteries; thus, the description is omitted. When the secondary battery of the present invention is used as the secondary battery of the battery pack 2201, the secondary battery of the battery pack 2201 can have high reliability. Furthermore, when the secondary battery of the present invention is used as the secondary battery of the above-described battery pack 2201, the secondary battery of the battery pack 2201 can have favorable low-temperature characteristics.

FIG. 18C illustrates a large transport vehicle 2003 having a motor controlled by electricity as an example. A battery module of the transport vehicle 2003 has 100 or more secondary batteries with a nominal voltage of 3.0 V or higher and 5.0 V or lower connected in series to have a maximum voltage of 600 V. A battery pack 2202 has the same function as that in FIG. 17B except, for example, the number of secondary batteries configuring the battery module; thus, the description is omitted. When the secondary battery of the present invention is used as the secondary battery included in the module, the secondary battery included in the module can have high reliability. Furthermore, when the secondary battery of the present invention is used as the above-described secondary battery included in the module, the secondary battery included in the module can have favorable low-temperature characteristics.

FIG. 18D illustrates an aircraft 2004 having a combustion engine as an example. The aircraft 2004 illustrated in FIG. 18D is regarded as a kind of transport vehicle because it has wheels for takeoff and landing, and includes a battery pack 2203 that includes a charge control device and a battery module configured by connecting a plurality of secondary batteries.

The battery module of the aircraft 2004 has eight 4 V secondary batteries connected in series, which has the maximum voltage of 32 V, for example. The battery pack 2203 has the same function as that in FIG. 17B except, for example, the number of secondary batteries configuring the battery module; thus, the description is omitted.

The contents in this embodiment can be combined with any of the contents in the other embodiments as appropriate.

### Embodiment 7

This embodiment will describe examples in which the secondary battery of one embodiment of the present invention is mounted in a vehicle such as a motorcycle and a bicycle.

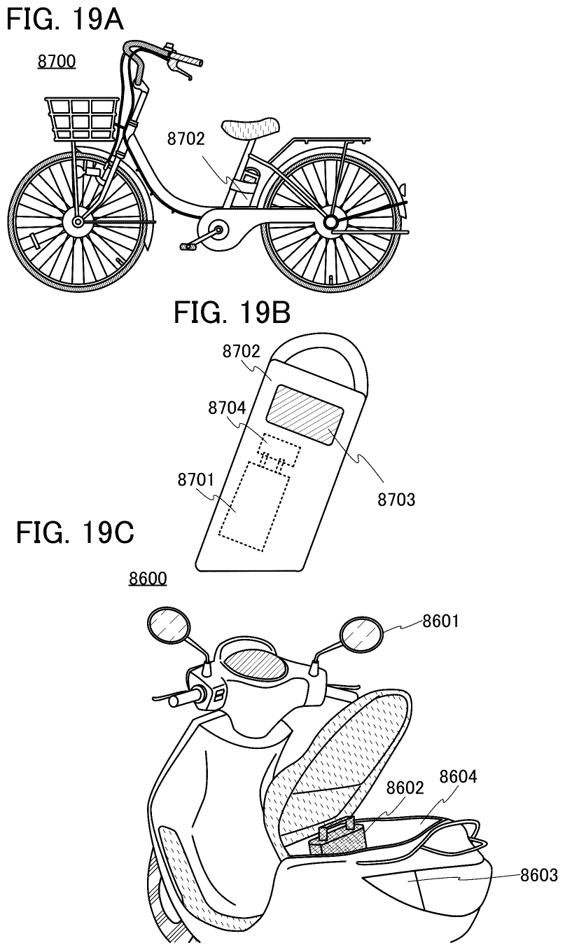

FIG. 19A illustrates an example of an electric bicycle using the secondary battery of one embodiment of the present invention. The secondary battery of one embodiment of the present invention can be used for an electric bicycle 8700 in FIG. 19A. The secondary battery of one embodiment of the present invention may include a protection circuit.

The electric bicycle 8700 is provided with a power storage device 8702. The power storage device 8702 can supply electric power to a motor that assists a rider. The power storage device 8702 is portable, and FIG. 19B illustrates the state where the power storage device 8702 is removed from the electric bicycle. A plurality of secondary batteries 8701 of one embodiment of the present invention are included in the power storage device 8702, and can display the remaining battery level and the like on a display portion 8703. When the secondary battery of the present invention is used as the secondary battery 8701, the secondary battery 8701 can have high reliability. Furthermore, when the secondary battery of the present invention is used as the secondary battery 8701, the secondary battery 8701 can have favorable low-temperature characteristics.

The power storage device 8702 includes a control circuit 8704 capable of charge control or anomaly detection for secondary batteries. The control circuit 8704 is electrically connected to a positive electrode and a negative electrode of the secondary battery 8701. The control circuit 8704 can contribute greatly to elimination of accidents due to secondary batteries, such as fires.

FIG. 19C illustrates an example of a motorcycle including the secondary battery of one embodiment of the present invention. A motor scooter 8600 illustrated in FIG. 19C includes a power storage device 8602, side mirrors 8601, and indicators 8603. The power storage device 8602 can supply electric power to the indicators 8603. When the secondary battery of the present invention is used as the secondary battery in the power storage device 8602, the secondary battery in the power storage device 8602 can have high reliability. Furthermore, when the secondary battery of the present invention is used as the secondary battery in the power storage device 8602, the secondary battery in the power storage device 8602 can have favorable low-temperature characteristics.

In the motor scooter 8600 illustrated in FIG. 19C, the power storage device 8602 can be held in an under-seat storage unit 8604. The power storage device 8602 can be held in the under-seat storage unit 8604 even with a small size.

The contents in this embodiment can be combined with any of the contents in the other embodiments as appropriate.

### Embodiment 8

In this embodiment, examples of electronic devices each including the secondary battery of one embodiment of the present invention are described. Examples of the electronic devices each including the secondary battery include a television device (also referred to as a television or a television receiver), a monitor of a computer and the like, a digital camera, a digital video camera, a digital photo frame, a mobile phone (also referred to as a cellular phone or a mobile phone device), a portable game console, a portable information terminal, an audio reproducing device, and a large-sized game machine such as a pachinko machine. Examples of the portable information terminal include a laptop personal computer, a tablet terminal, an e-book reader, and a mobile phone.

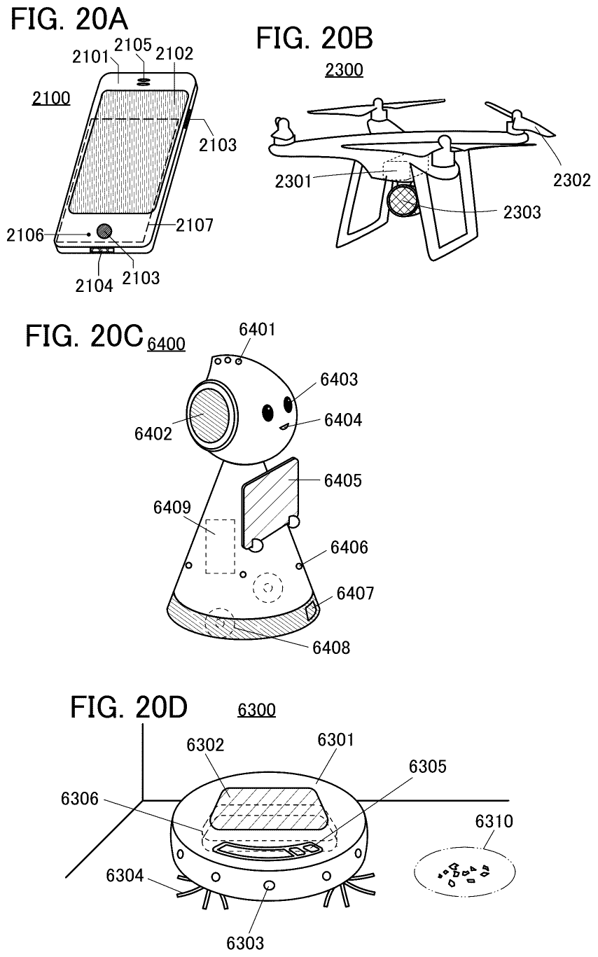

FIG. 20A illustrates an example of a mobile phone. A mobile phone 2100 includes a housing 2101 in which a display portion 2102 is incorporated, an operation button 2103, an external connection port 2104, a speaker 2105, a microphone 2106, and the like. The mobile phone 2100 includes a secondary battery 2107. When the secondary battery of the present invention is used as the secondary battery 2107, the secondary battery 2107 can have high reliability. Furthermore, when the secondary battery of the present invention is used as the secondary battery 2107, the secondary battery 2107 can have favorable low-temperature characteristics.

The mobile phone 2100 is capable of executing a variety of applications such as mobile phone calls, e-mailing, viewing and editing texts, music reproduction, Internet communication, and a computer game.

With the operation button 2103, a variety of functions such as time setting, power on/off, on/off of wireless communication, setting and cancellation of a silent mode, and setting and cancellation of a power saving mode can be performed. For example, the functions of the operation button 2103 can be set freely by the operating system incorporated in the mobile phone 2100.

The mobile phone 2100 can employ near field communication conformable to a communication standard. For example, mutual communication between the mobile phone 2100 and a headset capable of wireless communication enables hands-free calling.

Moreover, the mobile phone 2100 includes the external connection port 2104, and data can be directly transmitted to and received from another information terminal via a connector. In addition, charge can be performed via the external connection port 2104. Note that the charge operation may be performed by wireless power feeding without using the external connection port 2104.

The mobile phone 2100 preferably includes a sensor. As the sensor, a human body sensor such as a fingerprint sensor, a pulse sensor, or a temperature sensor; a touch sensor; a press sensor; or an acceleration sensor is preferably mounted, for example.

FIG. 20B illustrates an unmanned aircraft 2300 including a plurality of rotors 2302. The unmanned aircraft 2300 is also referred to as a drone. The unmanned aircraft 2300 includes a secondary battery 2301 of one embodiment of the present invention, a camera 2303, and an antenna (not illustrated). The unmanned aircraft 2300 can be remotely controlled through the antenna. When the secondary battery of the present invention is used as the secondary battery 2301, the secondary battery 2301 can have high reliability. Furthermore, when the secondary battery of the present invention is used as the secondary battery 2301, the secondary battery 2301 can have favorable low-temperature characteristics.

FIG. 20C illustrates an example of a robot. A robot 6400 illustrated in FIG. 20C includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with a user using the microphone 6402 and the speaker 6404.

The display portion 6405 has a function of displaying various kinds of information. The robot 6400 can display information desired by a user on the display portion 6405. The display portion 6405 may be provided with a touch panel. Moreover, the display portion 6405 may be a detachable information terminal, in which case charging and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes, in its inner region, the secondary battery 6409 of one embodiment of the present invention and a semiconductor device or an electronic component. When the secondary battery of the present invention is used as the secondary battery 6409, the secondary battery 6409 can have high reliability. Furthermore, when the secondary battery of the present invention is used as the secondary battery 6409, the secondary battery 6409 can have favorable low-temperature characteristics.

FIG. 20D illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 can be self-propelled, detect dust 6310, and suck up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object (e.g., a wire) that is likely to be caught in the brush 6304 by image analysis, the rotation of the brush 6304 can be stopped. The cleaning robot 6300 further includes, in its inner region, the secondary battery 6306 of one embodiment of the present invention and a semiconductor device or an electronic component. When the secondary battery of the present invention is used as the secondary battery 6306, the secondary battery 6306 can have high reliability. Furthermore, when the secondary battery of the present invention is used as the secondary battery 6306, the secondary battery 6306 can have favorable low-temperature characteristics.

This embodiment can be implemented in appropriate combination with any of the other embodiments.

### Embodiment 9

In this embodiment, examples of space equipment including the secondary battery of one embodiment of the present invention are described.

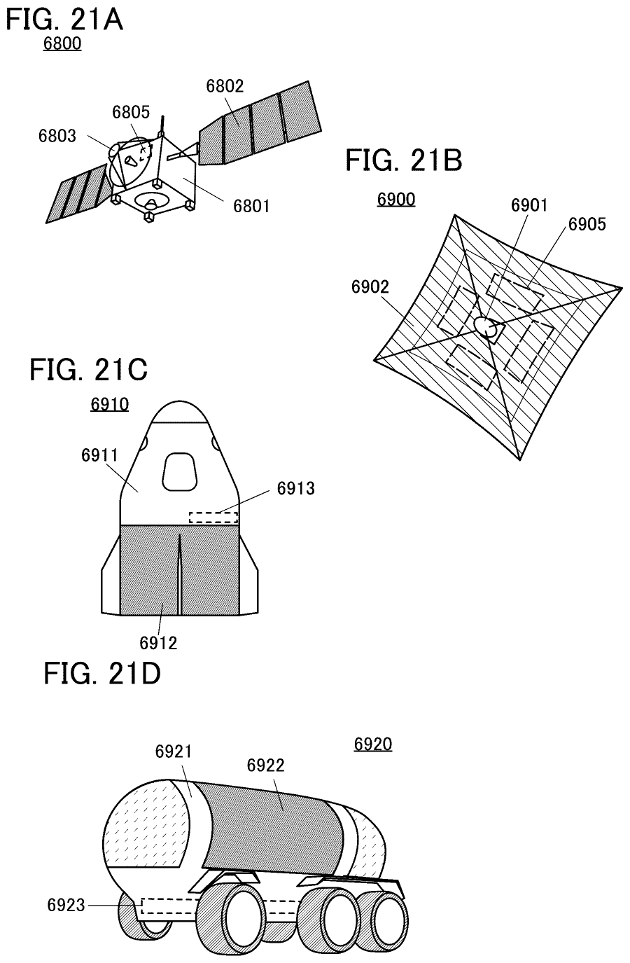

FIG. 21A illustrates an artificial satellite 6800 as an example of space equipment. The artificial satellite 6800 includes a body 6801, a solar panel 6802, an antenna 6803, and a secondary battery 6805. Such a solar panel is referred to as a solar cell module in some cases.

When the solar panel 6802 is illuminated by sunlight, electric power required for operation of the artificial satellite 6800 is generated. However, for example, in the situation where the solar panel is not illuminated by sunlight or the situation where the amount of sunlight by which the solar panel is illuminated is small, the amount of generated electric power is small. Accordingly, a sufficient amount of electric power required for operation of the artificial satellite 6800 might not be generated. In order to operate the artificial satellite 6800 even with a small amount of generated electric power, the artificial satellite 6800 is preferably provided with the secondary battery 6805. When the secondary battery of the present invention is used as the secondary battery 6805, the secondary battery 6805 can have high reliability. Furthermore, when the secondary battery of the present invention is used as the secondary battery 6805, the secondary battery 6805 can have favorable low-temperature characteristics.

The artificial satellite 6800 can generate a signal. The signal is transmitted through the antenna 6803, and can be received by a ground-based receiver or another artificial satellite, for example. When the signal transmitted from the artificial satellite 6800 is received, the position of a receiver that receives the signal can be measured. Thus, the artificial satellite 6800 can make up part of a satellite positioning system.

The artificial satellite 6800 can include a sensor. For example, with a structure including a visible light sensor, the artificial satellite 6800 can have a function of sensing sunlight reflected by a ground-based object. Alternatively, with a structure including a thermal infrared sensor, the artificial satellite 6800 can have a function of sensing thermal infrared rays emitted from the surface of the earth. Thus, the artificial satellite 6800 can function as an earth observing satellite, for example.

FIG. 21B illustrates a probe 6900 including a solar sail as an example of space equipment. The probe 6900 includes a body 6901, a solar sail 6902, and a secondary battery 6905. When the secondary battery of the present invention is used as the secondary battery 6905, the secondary battery 6905 can have high reliability. Furthermore, when the secondary battery of the present invention is used as the secondary battery 6905, the secondary battery 6905 can have favorable low-temperature characteristics. When photons from the sun are incident on the surface of the solar sail 6902, the momentum is transmitted to the solar sail 6902. Hence, the surface of the solar sail 6902 preferably includes a thin film with high reflectance and further preferably faces in the direction of the sun.

The solar sail 6902 may be designed such that the solar sail 6902 is furled in a small size until it goes beyond the earth's atmosphere, and is unfurled to have a large sheet-like shape as illustrated in FIG. 21B in the space beyond the earth's atmosphere (outer space).

FIG. 21C illustrates a spacecraft 6910 as an example of space equipment. The spacecraft 6910 includes a body 6911, a solar panel 6912, and a secondary battery 6913. When the secondary battery of the present invention is used as the secondary battery 6913, the secondary battery 6913 can have high reliability. Furthermore, when the secondary battery of the present invention is used as the secondary battery 6913, the secondary battery 6913 can have favorable low-temperature characteristics. The spacecraft body 6911 can include a pressurized cabin and an unpressurized cabin, for example. The pressurized cabin may be designed so that the crew can get into the cabin. Electric power that is generated by illumination of sunlight on the solar panel 6912 can be stored in the secondary battery 6913.

FIG. 21D illustrates a rover 6920 as an example of space equipment. The rover 6920 includes a body 6921 and a secondary battery 6923. When the secondary battery of the present invention is used as the secondary battery 6923, the secondary battery 6923 can have high reliability. Furthermore, when the secondary battery of the present invention is used as the secondary battery 6923, the secondary battery 6923 can have favorable low-temperature characteristics. The rover 6920 may include a solar panel 6922.

The rover 6920 may be designed so that the crew can get into the rover. Electric power that is generated by illumination of sunlight on the solar panel 6912 may be stored in the secondary battery 6923, or electric power generated by another power source such as a fuel cell or a radioisotope thermoelectric generator, for example, may be stored in the secondary battery 6923.

The contents of this embodiment can be combined with any of the contents in the other embodiments as appropriate.

This application is based on Japanese Patent Application Serial No. 2023-211857 filed with Japan Patent Office on Dec. 15, 2023, the entire contents of which are hereby incorporated by reference.

What is claimed is:

1. A method for manufacturing a secondary battery, the method comprising:
coating a separator with slurry comprising carbon and a solvent;
forming a carbon layer by drying the slurry to remove the solvent; and
performing pressing on the carbon layer and a negative electrode that face each other.

2. The method for manufacturing a secondary battery according to claim 1,
wherein the slurry further comprises a binder, and
wherein the carbon layer includes the binder.

3. The method for manufacturing a secondary battery according to claim 1,
wherein the slurry further comprises polyglutamic acid, and
wherein the carbon layer includes the polyglutamic acid.

4. The method for manufacturing a secondary battery according to claim 1, wherein the solvent comprises water.

5. The method for manufacturing a secondary battery according to claim 1, wherein heating is performed in the pressing.

6. The method for manufacturing a secondary battery according to claim 1, wherein linear pressure application is performed in the pressing.

7. A method for manufacturing a secondary battery, the method comprising:
coating a separator with slurry comprising carbon and a solvent;
forming a carbon layer by drying the slurry to remove the solvent;
performing first pressing on the carbon layer and a negative electrode that face each other; and
performing second pressing on the separator and a positive electrode that face each other.

8. The method for manufacturing a secondary battery according to claim 7,
wherein the slurry further comprises a binder, and
wherein the carbon layer includes the binder.

9. The method for manufacturing a secondary battery according to claim 7,
wherein the slurry further comprises polyglutamic acid, and
wherein the carbon layer includes the polyglutamic acid.

10. The method for manufacturing a secondary battery according to claim 7, wherein the solvent comprises water.

11. The method for manufacturing a secondary battery according to claim 7, wherein heating is performed in the first pressing or the second pressing.

12. The method for manufacturing a secondary battery according to claim 7, wherein linear pressure application is performed in the first pressing and area pressure application is performed in the second pressing.

13. The method for manufacturing a secondary battery according to claim 7, wherein the second pressing is performed after the positive electrode is cut.
